(19) United States
(12) Patent Application Publication
(10) Pub. No.: US 2004/0019681 A1
(43) Pub. Date: Jan. 29, 2004

(54) Data management apparatus and data management system

(76) Inventors: Tadashi Nakamura, Nara-shi (JP); Yasumori Hino, Ikoma-shi (JP); Masanori Itoh, Moriguchi-shi (JP); Yasuyuki Kurosawa, Katano-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/620,343

(22) Filed: Jul. 17, 2003

(30) Foreign Application Priority Data
Jul. 22, 2002 (JP) 2002-212948

(51) Int. Cl. G06F 15/173

(52) U.S. Cl. 709/226

(57) ABSTRACT

A server 10 includes (i) an I/O unit 12 for obtaining terminal characteristic information I100 indicating data processing on client terminals A, B and C from the client terminals A, B and C respectively; (ii) a terminal characteristic information processing unit 15 for determining a manner of allocating server resources based on the terminal characteristic information I100 obtained by the I/O unit 12; (iii) a control unit 11 for sending and receiving data to and from the client terminals A, B and C and processing the data based on a manner of handling the data determined by the terminal characteristic information processing unit 15; and (iv) a recording unit 14.

### BACKGROUND OF THE INVENTION

(1) Field of the Invention

The present invention relates to a data management apparatus and a data management system for managing transmission and reception of digital data.

(2) Description of the Related Art

With recent developments in fine patterning techniques for semiconductors, electronic devices have been more miniaturized and sophisticated, and as a result, it has been popular that a user carries and uses more than one electronic devices at the same time.

For example, as shown in FIG. 1, it is common to carry around with a portable audio device (terminal A), a PDA such as an electronic personal organizer (terminal B), a laptop PC (terminal C) and others as well as a mobile phone. In a specific case such as a business trip and travel, a user carries a digital still camera (hereinafter referred to a “DSC”) and a camcorder (a DVC or a DVD camcorder, for example) in addition to the electronic devices which he carries on a daily basis, so as to shoot products, landscapes and others and convert the contents thereof into data for storing it for record or memory.

FIG. 2 is a diagram showing a typical structure common to the above electronic devices. As shown in FIG. 2, an electronic device 90 generally includes a control unit 91, an I/O unit 92, a UI unit 93, a data processing unit 94 and a recording unit 95.

The control unit 91 controls the operation of the entire device.

The I/O unit 92 receives input of data from outside and outputs data outside the electronic device 90. This input and output of data is carried out via ATAPI, SCSI, USB, IEEE1394, a bus-type cable LAN, or a wireless LAN such as IEEE802.11.

The UI unit 93 is an interface mainly between the electronic device 90 and a user, and plays a role in communicating information with the user by conveying the user's operation inputted using a button or a stick to the electronic device 90 and displaying the output from the electronic device 90 on a screen via a user interface (GUI) or the like using images displayed on a liquid crystal screen.

The data processing unit 94 creates and reproduces (plays back) data in the electronic device 90, for example, receives digital images via a CCD device for image compression processing such as JPEG. The data processing unit 94 also reproduces data read out from the recording unit 95 which will be described later and displays the reproduced data on a screen for a user via the UI unit 93.

The recording unit 95 permanently stores data which is created by the control unit 91 or the data processing unit 94 based on data generated by the electronic device 90 or inputted from outside via the I/O unit 92, or an instruction which a user inputs via the UI unit 93. The recording unit 95 also outputs the stored data outside via the I/O unit 92 or sends it to the data processing unit 94, and thus allows reproduction of the data. It further stores data temporarily when the control unit 91 performs various processes.

It is selected how each unit as shown in FIG. 2 works and is structured according to the need for purpose of use or intended use of an actual electronic device. For example, if an electronic device is a DSC, the I/O unit is comprised of a USB, the UI unit is comprised of a liquid crystal monitor and switches, the data processing unit is comprised of a CCD and an image compression/decompression processing unit, and the recording unit is comprised of a semiconductor memory card and the like. If a component specific to DSC is required, the entire electronic device is structured by combining such a component.

As described above, each of a plurality of electronic devices which one user carries has a recording device and a recording medium, each of which stores data. Therefore, as shown in FIG. 1, a user carries a plurality of devices which overlap each other in their function of data recording, and thus the following problems occur.

Once shootings by electronic devices respectively generate various data, these data are separately stored in respective recording devices or recording mediums in these electronic devices, and thus the number of recording devices and recording mediums which a user has to manage increases. As a result, time and trouble required for data management increase, in other words, the user has to manage what kind of data exists, where the data is located, whether the data is backed up or not, and so on.

For example, when an object is shot and recorded around the same time using a DSC and DVD camcorder, data associated with different contents are inputted and recorded in different devices in different formats, and thus time and trouble required for data management substantially increase.

In addition, this case also causes a problem in reproduction. Both a DSC and a DVD camcorder have a function of receiving input of AV data and recording it, and are used for recording of a user's events such as an exhibition, a trip and an athletic meet, his daily life and others. If these devices are used for shooting, two types of data of one object are separately recorded in the DSC and DVD camcorder, and as a result, information is stored in a plurality of recording mediums separately. As for data shot while traveling, recording order of the data itself is important information, and it is desirable that the shot images are reproduced in the shooting order for viewing, independent of a type of a shooting device and a data recording format.

However, it is very troublesome for a user to reorder in time sequence and reproduce the image data which are shot by a plurality of devices and stored in their recording mediums respectively. For example, the user needs to make preparations, such as copying the data from the DSC to the DVD camcorder, for continuous reproduction of the data in some way.

As mentioned above, if the data of the same object is stored in separate recording mediums, the following organization of the data requires much time and trouble. Although there exist DSCs and DVD camcorders capable of shooting moving and still pictures at the same time, an image input apparatus which satisfies the requirements for both moving and still pictures has not yet been realized because the functions and characteristics required for a camera unit and the like are different.

Accordingly, a user who wants to obtain more beautiful image data has no other choice but to use both a DSC and a DVD camcorder. In addition, as mentioned above, many of recent electronic devices have a network connection function. When a user uses such a device, not only the data shot by the user but also the data obtained via the network are stored in each electronic device. As a result, not only the increasing number of electronic devices but also the network connection make data management more difficult. That is a problem.

### SUMMARY OF THE INVENTION

That is why the present invention has been conceived in view of the above problem, and the object thereof is to provide a data management apparatus and a data management system capable of easily managing data stored in a plurality of electronic devices separately.

In order to achieve the above object, the data management apparatus according to the present invention is a data management apparatus that manages data which is handled by each of a plurality of terminals, comprising: an obtainment unit operable to obtain terminal characteristic information from said each of the terminals, the terminal characteristic information indicating data processing on said each of the terminals; a determination unit operable to determine a manner of handling the data based on the terminal characteristic information obtained by the obtainment unit; and a data processing unit operable to send and receive the data to and from said each of the terminals and process said data, based on the handling manner determined by the determination unit.

As a result, the manner of handling data is determined based on what the terminal characteristic information of each terminal indicates, and the data is sent and received and processed based on the handling manner. Therefore, even if each terminal performs various data processing depending on its intended purpose, the data handled by each terminal can be managed easily and appropriately.

Here, the determination unit may determine a manner of allocating server resources of the data management apparatus to said each of the terminals, the server resources being used for handling of the data, and the data processing unit may allocate the server resources to said each of the terminals based on the allocation manner determined by the determination unit. For example, the determination unit specifies a priority order for said each of the terminals, and determines the allocation manner depending on the priority order.

As a result, the manner of allocating server resources is determined based on what the terminal characteristic information indicates, and the data is sent and received and processed based on the allocation manner. Therefore, the server resources can be used more effectively.

Also, the obtainment unit may obtain the terminal characteristic information indicating a creation date and time of the data sent from said each of the terminals to the data processing unit, the determination unit may determine output order of the data sent from said each of the terminals to the data processing unit, based on the creation date and time indicated in the terminal characteristic information, and the data processing unit may output the data in synchronization with each other, based on the determined output order.

As a result, the output order of the data is determined based on what the terminal characteristic information indicates, and the data is outputted in synchronization with each other based on the output order. Therefore, the data handled by each terminal can be easily managed according to its creation date and time.

The data management apparatus according to the present invention may be a data management apparatus that manages data which is handled by each of a plurality of terminals, comprising: a storage unit operable to store allocation pattern information indicating a pattern of allocating server resources of the data management apparatus to said each of the terminals; a sending unit operable to send the allocation pattern information stored in the storage unit to said each of the terminals; an obtainment unit operable to obtain instruction information from said each of the terminals, the instruction information designating a predetermined pattern based on the allocation pattern information; and a data processing unit operable to allocate the server resources based on the pattern designated in the instruction information obtained by the obtainment unit, send and receive the data to and from said each of the terminals, and process said data. For example, the allocation pattern information indicates a plurality of patterns, and the obtainment unit obtains the instruction information selecting and designating any of the plurality of patterns indicated in said allocation pattern information.

As a result, the server resources are allocated based on the pattern instructed by the terminal and the data is sent and received and processed. Therefore, the data handled by each terminal can be managed easily and appropriately.

Here, the data management apparatus may further comprises a user interface unit operable to display the plurality of patterns indicated in the allocation pattern information stored in the storage unit, and specify a predetermined pattern according to an operation by a user, wherein the data processing unit sends and receives the data to and from said each of the terminals and processes said data, based on the predetermined pattern specified by the user interface unit.

Accordingly, the server resources are allocated based on the predetermined pattern according to the user's operation, and thus the data can be managed according to the user's intention.

The data management system according to the present invention is a data management system comprising: a plurality of terminals; and a data management apparatus that manages data which is handled by each of the plurality of terminals, wherein the data management apparatus includes: an obtainment unit operable to obtain terminal characteristic information from said each of the terminals, the terminal characteristic information indicating data processing on each of the terminals; a determination unit operable to determine a manner of allocating server resources of the data management apparatus to said each of the terminals based on the terminal characteristic information obtained by the obtainment unit; and a data processing unit operable to send and receive the data to and from said each of the terminals and process said data, based on the allocation manner determined by the determination unit, and said each of the terminals includes: a terminal sending unit operable to send the terminal characteristic information; and a terminal data processing unit operable to send and receive the data to and from said each of the terminals and process said data, based on the allocation manner of the server resources determined by the determination unit.

As a result, the manner of allocating the server resources is determined based on what the terminal characteristic information of each terminal indicates, and the data is sent and received and processed based on the allocation manner. Therefore, even if each terminal performs various data processing depending on its intended purpose, the data handled by each terminal can be managed easily and appropriately. Also, even in an environment where a configuration including a plurality of terminals is changed with a high frequency, for example, a case where the number of terminals is changed from 2 to 3 or 4, the manner of allocating the server resources is determined depending on the terminal characteristic information of each terminal, and thus the server resources can be used effectively.

In addition, the present invention can be realized as a terminal, as a data management method including steps executed by characteristic constituent elements of a data management apparatus, a terminal or a data management system, or as a program for causing a computer to executing these steps. Needless to say, the program can be stored in a recording medium such as a CD-ROM, or distributed via a transmission medium such as the Internet.

As further information about technical background to this application, Japanese Patent Application No. 2002-212948, filed Jul. 22, 2002, is incorporated herein by reference.

### BRIEF DESCRIPTION OF THE DRAWINGS

These and other subjects, advantages and features of the invention will become apparent from the following description thereof taken in conjunction with the accompanying drawings that illustrate a specific embodiment of the invention. In the Drawings:

FIG. 1 is a diagram showing how a user carries a plurality of electronic devices (terminals).

FIG. 2 is a diagram showing a typical structure common to traditional electronic devices.

FIG. 3 is a diagram showing an appearance of a DVD recorder and explaining an example of interfaces between the DVD recorder and related devices.

FIG. 4 is a block diagram showing a function of a DVD recorder.

FIG. 5 is an illustration for explaining an address space on a DVD-RAM 100 and what happens when supplying data stored in a track buffer to decoders enables continuous reproduction of AV data.

FIG. 6 is a block diagram of a DVD recorder which is equipped with a semiconductor memory card and a hard disk drive.

FIG. 7A is a diagram showing a recording area of a DVD-RAM that is a recordable optical disc.

FIG. 7B is a horizontal view of a read-in area, a read-out area, and zone areas 0˜23 which are arranged concentrically on the disc as shown in FIG. 7A.

FIG. 8A and FIG. 8B are diagrams showing a logical data space of a DVD-RAM which is comprised of logical sectors.

FIG. 9 is a diagram showing a directory of moving picture data files which are recorded on a DVD-RAM and a structure of each file.

FIG. 10 is a diagram showing a structure of MPEG data which is recorded on a DVD disc as one of various AV objects.

FIG. 11 is a diagram for explaining an overview of data structures of a program stream and a transport stream.

FIG. 12 is a diagram showing a data structure of a transport stream.

FIG. 13 is a diagram showing a data structure of a program stream.

FIG. 14 is a diagram showing a detailed structure of a TS packet.

FIG. 15 is a diagram showing a structure of packs which constitute a program stream.

FIG. 16A˜FIG. 16D are diagrams showing a PAT table and a PMAP tables for transmitting structure information of an audio stream and a video stream which constitute a program.

FIG. 17 is a diagram for explaining arrangements on a disc of packs in a program stream and TS packets in a transport stream.

FIG. 18A and FIG. 18B are diagrams showing a data structure of video management information.

FIG. 19A and FIG. 19B are diagrams showing another data structure of video management information.

FIG. 20 is a diagram for explaining specifically a relation between an object, a cell, a PGC and an access map.

FIG. 21 is a diagram for explaining a reproduction operation of a DVD recorder/player.

FIG. 22 is a diagram for explaining a recording operation of a DVD recorder/player.

FIG. 23 is a diagram showing an appearance of a DSC and explaining an example of interfaces between the DSC and related devices.

FIG. 24A and FIG. 24B are diagrams showing a directory of still picture data files which are recorded on a memory card and a structure of one of the files.

FIG. 25 is a diagram showing a structure of JPEG data which is recorded on a recording medium by a DSC as a DCF basic file.

FIG. 26 is a diagram for explaining a reproduction operation of a DSC for reproducing a recording medium.

FIG. 27 is a diagram for explaining a structure and an operation of a DSC for recording onto and reproducing a recording medium.

FIG. 28 is a diagram showing a structure of a data management system in a first embodiment.

FIG. 29 is a structural diagram showing an example of a specific structure of the above data management system.

FIG. 30 is a diagram showing a structure of a server in the data management system as shown in FIG. 28.

FIG. 31 is a diagram showing a structure common to client terminals in the data management system as shown in FIG. 28.

FIG. 32 is a diagram showing how to connect client terminals and a server via a network.

FIG. 33 is a diagram showing a data structure of terminal characteristic information.

FIG. 34A and FIG. 34B are diagrams showing a data structure of recording attribute information in FIG. 33.

FIG. 35A and FIG. 35B are diagrams showing examples of individual data attribute information included in data attribute information.

FIG. 36A and FIG. 36B are diagrams showing a data structure of the reproduction attribute information in FIG. 33.

FIG. 37 is a flowchart showing an operation for allocating server resources.

FIG. 38 is a diagram showing an operation for allocating a buffer memory included in a server.

FIG. 39 is a diagram showing an operation for allocating areas in a recording unit of a server.

FIG. 40 is a diagram showing an operation for making a loop recording in each virtual partition space allocated in FIG. 39.

FIG. 41A and FIG. 41B are diagrams showing the contents of allocation pattern information in a second embodiment.

FIG. 42 is a diagram showing the contents of allocation pattern information including a plurality of patterns depending upon client terminals connected to a server.

FIG. 43A and FIG. 43B are diagrams for explaining an operation for changing allocation of server resources depending on status change of a client terminal in a third embodiment.

FIG. 44 is a diagram showing a data structure of terminal characteristic information in a fourth embodiment.

FIG. 45A and FIG. 45B are diagrams showing a data structure of message registration information in FIG. 44.

FIG. 46 is a diagram showing an example of message information registration.

FIG. 47 is a diagram showing an example of a message information sending operation.

FIG. 48 is a diagram showing a structure of a server in a fifth embodiment.

FIG. 49 is a diagram for explaining an operation between a server and client terminals.

FIG. 50 is a diagram for explaining an operation when a client terminal C is further connected to the server in addition to the situation in FIG. 49.

FIG. 51 is a diagram for explaining an operation in another data storage method than that in FIG. 49.

FIG. 52 is a diagram for explaining an operation in still another data storage method than that in FIG. 49.

FIG. 53 is a diagram showing a display example when a user reproduces data with reference to a script file.

FIG. 54 is a file contents display diagram showing an example of a script file which is structured in accordance with the SMIL standard in the fifth embodiment.

FIG. 55 is a diagram for explaining a basic operation of a management data processing unit.

FIG. 56 is a diagram for explaining a reproduction operation of a management data processing unit.

FIG. 57 is an illustration for explaining an operation of a server when a script file of the fifth embodiment is read in by the management data processing unit.

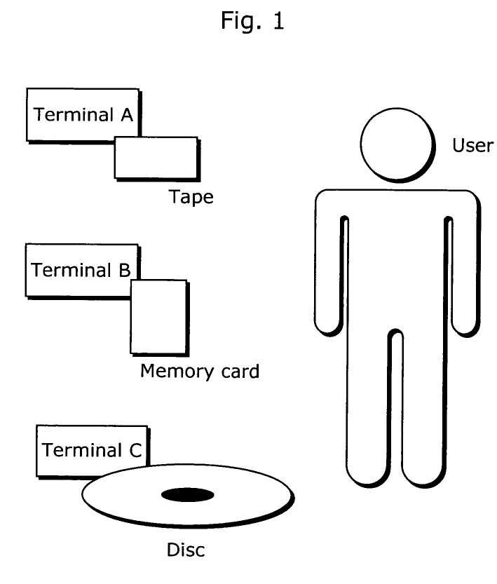

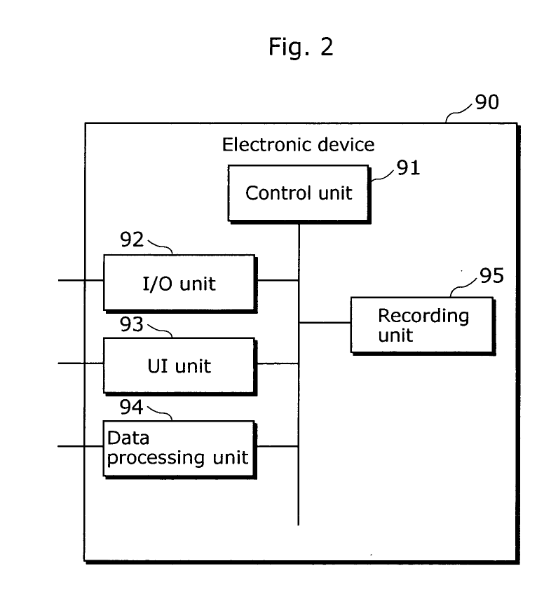

### DESCRIPTION OF THE PREFERRED EMBODIMENT(S)

The preferred embodiments of the data management apparatus and the data management system according to the present invention will be explained with reference to the drawings.

(First Embodiment)

First, operations of a few electronic devices relating to the present embodiment will be explained. These electronic devices include, for example, a DVD recorder which records AV information encoded under MPEG (MPEG2) that is an encoding standard for digital AV data onto a DVD-RAM that is a rewritable optical disc having a capacity of several GB, and a DVD camcorder that is a combination of such a DVD recorder and a camera.

As for a DVD recorder, a DVD disc and a DVD player, the following will be explained in this order:

1. Overview of a system including a DVD recorder

2. Overview of a function of a DVD recorder

3. Overview of a DVD disc

4. Overview of AV information to be reproduced

5. Overview of management information of AV information and reproduction control thereof

6. Basic operation of a reproduction function

7. Basic operation of a recording function

(1. Overview of a System Including a DVD Recorder)

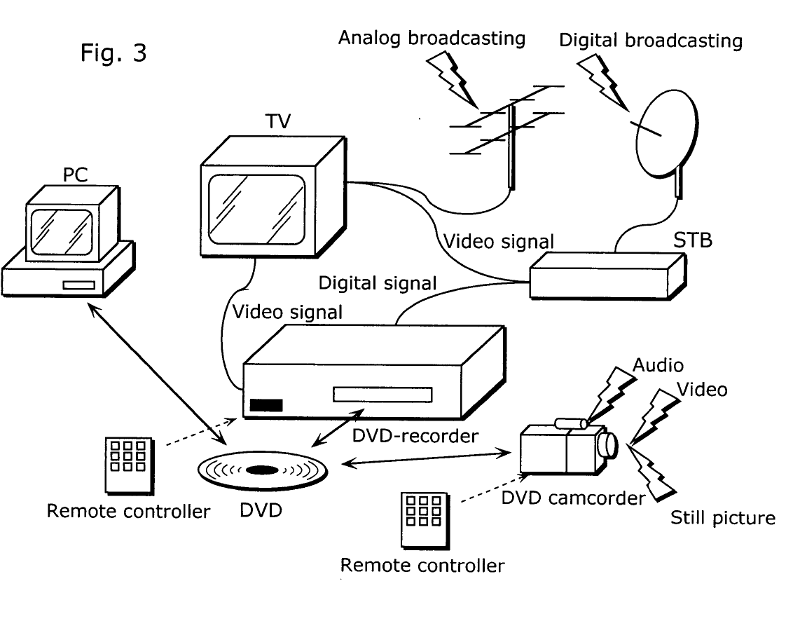

FIG. 3 is a diagram showing an appearance of a DVD recorder and explaining an example of interfaces between the DVD recorder and related devices. As shown in FIG. 3, the DVD recorder is equipped with a DVD disc that is an optical disc, and records and reproduces video information. The DVD recorder is generally operated using a remote controller or switches on the DVD recorder itself.

Video information which is inputted into the DVD recorder includes an analog signal and a digital signal, and an analog broadcasting is provided by the analog signal and a digital broadcasting is provided by the digital signal. Generally speaking, an analog broadcasting is received and demodulated by a receiver built in a television and inputted into a DVD recorder as an analog video signal in accordance with an NTSC system. A digital broadcasting is demodulated into a digital signal by an STB (Set Top Box) that is a receiver and inputted into a DVD recorder for recording.

On the other hand, video information recorded on a DVD disc is reproduced and outputted outside by a DVD recorder. There are also two types of signals to be outputted, as is the case with signals to be inputted, namely, an analog signal and a digital signal. An analog signal is inputted directly into a television, while a digital signal is converted into an analog signal via an STB and then inputted into a television for display as video.

There is a DVD camcorder as an apparatus which uses a DVD disc. A DVD camcorder is an apparatus structured by combining a camera including a lens and a CCD to a DVD recorder, and encodes moving picture information shot by the camera and records the encoded information.

Not only a DVD recorder and a DVD camcorder but also a personal computer and the like sometimes record video information on a DVD disc for reproduction. Even if a personal computer records video information on a DVD disc, a DVD recorder reproduces the information if the DVD disc is integrated in the DVD recorder.

Note that the video information of the above-mentioned analog broadcasting and the digital broadcasting is usually accompanied with audio information. The audio information is also recorded and reproduced in a DVD recorder in the same manner as the video information. Video information is usually a moving picture, but it may be a still picture. For example, a still picture is recorded using a photo-function of a DVD camcorder.

Note that as a digital I/F between a DVD recorder and an external device such as an STB, IEEE1394, ATAPI, SCSI and USB, a bus-type cable LAN, or a wireless LAN such as IEEE802.11 is used.

An analog (composite) video signal of an NTSC system has been explained as a signal between a DVD recorder and a television, but a component signal which transmits a luminance signal and a chroma signal separately may be applied. Furthermore, as an video transmission I/F between an AV device and a television, research and development for replacing an analog I/F into a digital I/F such as a DVI (Digital Visual Interface) has been pursued, so it is expected as a matter of course that a DVD recorder and a television are connected via a digital I/F.

(2. Overview of a Function of a DVD Recorder)

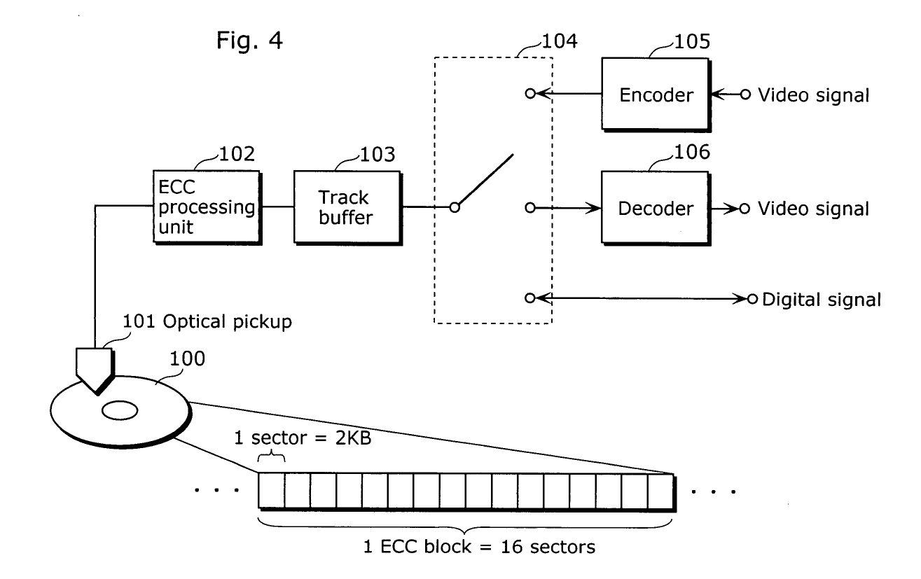

FIG. 4 is a block diagram showing a function of a DVD recorder. This DVD recorder includes an optical pickup 101 for reading out data recorded on a DVD-RAM disc, an ECC (Error Correcting Code) processing unit 102, a track buffer 103, a switch 104 for switching input into and output from the track buffer 103, an encoder 105 and a decoder 106. As shown in FIG. 4, on the DVD-RAM disc 100, data is recorded per 2 KB for each sector as a minimum unit. And the ECC processing unit 102 performs error correction processing on each ECC block consisting of 16 sectors as one unit.

The track buffer 103 is a buffer for recording AV data at a variable bit rate (VBR) in order to record AV data on the DVD-RAM disc 100 more efficiently. A reading and writing rate (Va) out of and in the DVD-RAM disc 100 is fixed, while a bit rate (Vb) of AV data varies depending on complexity of its contents (images if the AV data is video data), so the track buffer smoothes out a discrepancy between bit rates.

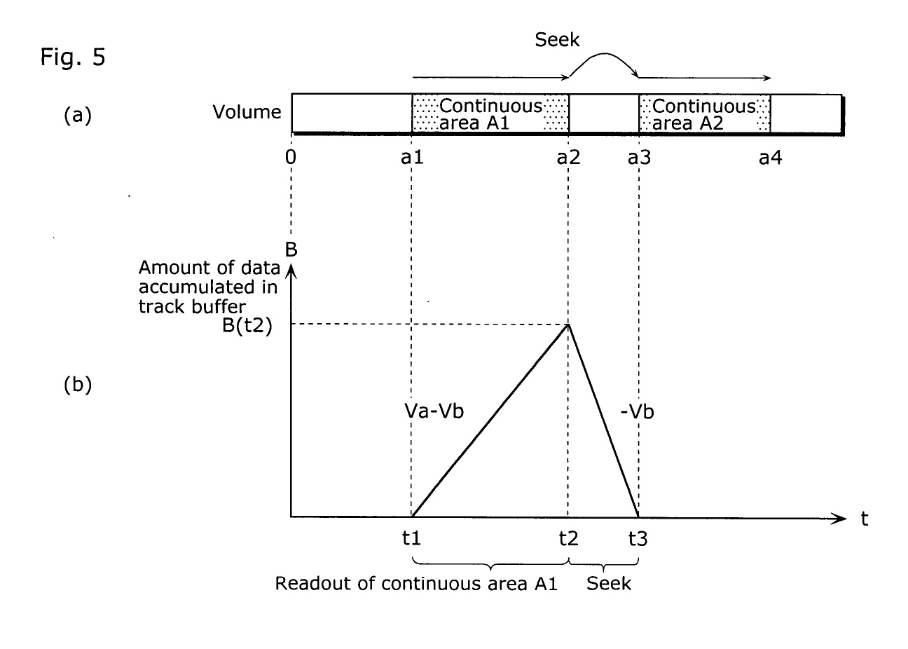

More effective use of this track buffer 103 makes it possible to place AV data discretely on the DVD-RAM disc 100. This will be explained with reference to FIG. 5.

FIG. 5 is an illustration for explaining an address space on the DVD-RAM disc 100 and what happens when supplying data stored in the track buffer to a decoder enables continuous reproduction of AV data.

As shown in (a) of FIG. 5, when AV data is recorded in a continuous area between a1 and a2 and a continuous area between a3 and a4 separately, the AV data can be continuously reproduced by supplying data stored in the track buffer to the decoder 106 during the period of seeking from a2 to a3. (b) of FIG. 5 shows what happens in this case. The AV data whose reading starts at the position al is inputted into the track buffer 103 and outputted from the track buffer 103 at the time t1. Therefore, the data is accumulated in the track buffer 103 by the amount of data corresponding to the difference (Va−Vb) between the input rate (Va) into the track buffer 103 and the output rate (Vb) from the track buffer 103. This continues until the continuous area reaches a2, namely, until it reaches the time t2. When the amount of data accumulated in the track buffer 103 during that time is B (t2), the data can be supplied continuously to the decoder 106 by consuming the amount of data B (t2) accumulated in the track buffer 103 during the time period from the time t2 up to the time t3 (or the position a3) when reading of the data starts. In other words, if a certain amount of data or more is read out securely before seek, AV data can be supplied continuously even if the seek occurs. A size of a continuous area for allowing continuous supply of AV data is represented by the following equation on the basis of the number of ECC blocks (N_ecc), where N_sec is the number of sectors included in one ECC block, S_size is a sector size, and Tj is seek performance (maximum seek time).

N_{—}ecc=Vb·Tj/((N_sec·8·S_size)·(1−Vb/Va))

A defective sector may be included in a continuous area. In view of such a case, a continuous area is represented by the following equation, where dN_ecc is an acceptable size of a defective sector, and Ts is time required for skipping the defective sector in the continuous area. This size is also represented by the number of ECC blocks.

N_{—}ecc=dN_{—}ecc+Vb·(Tj+Ts)/((N_sec·8·S_size)·(1−Vb/Va))

Note that the case where data is read out from a DVD-RAM disc, namely, the case where data is reproduced, has been explained, but the case where data is written, namely, recorded into a DVD-RAM disc can also be applied. As mentioned above, even if AV data is recorded separately in parts on a DVD-RAM disc, it can be reproduced continuously if a certain amount of data or more of the AV data is recorded continuously. Conversely, a certain amount of data or more of the AV data can be recorded separately. This continuous area is referred to as a CDA in a DVD disc.

Note that a DVD recorder may include a semiconductor memory card or a hard disk drive in addition to a DVD-RAM disc.

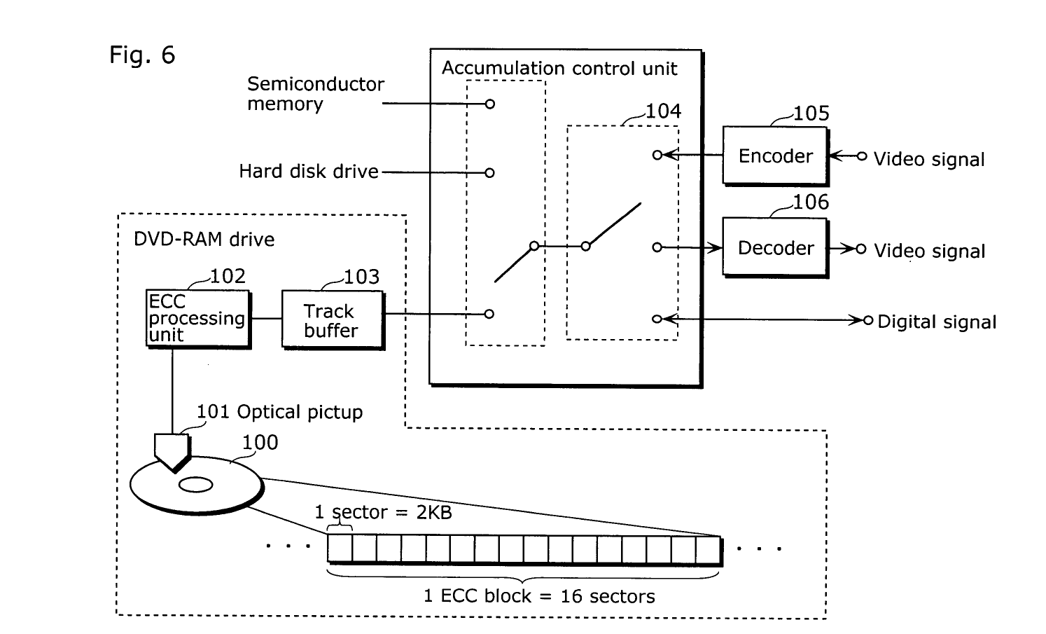

FIG. 6 is a block diagram of a DVD recorder which is equipped with a semiconductor memory card and a hard disk drive. Note that 1 sector may be 512B (Bytes), 8 KBs or others, and 1 ECC block may be 1 sector, 16 sectors, 32 sectors and others. It is expected that the sector size and the number of sectors included in an ECC block increase with increase of capacity for recording information.

(3. Overview of a DVD Disc)

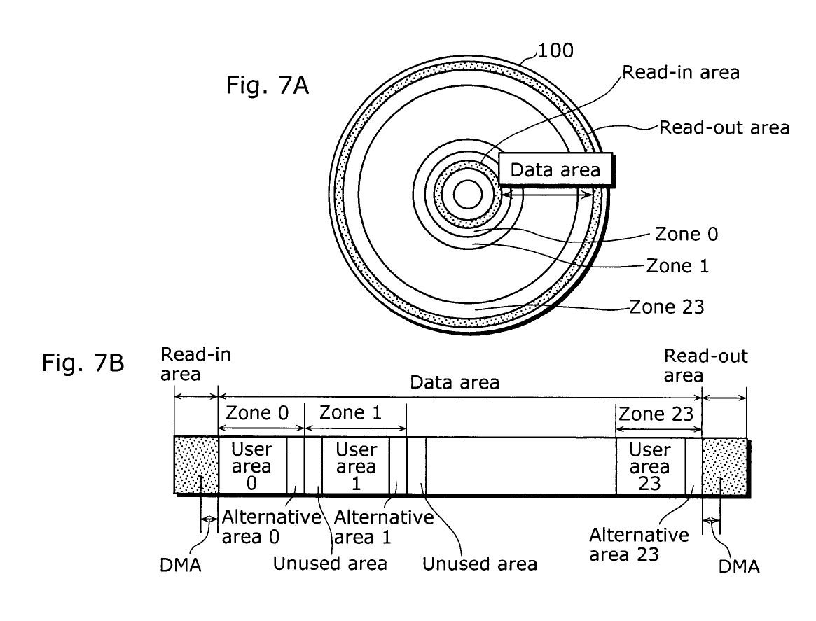

FIG. 7A and FIG. 7B are diagrams showing an appearance and a physical structure of a DVD-RAM disc that is a recordable optical disc. Note that a DVD-RAM disc is usually housed in a cartridge and integrated into a DVD recorder in order to protect a recording surface. However, a recording surface may be protected by another means, or a DVD-RAM disc may be directly integrated in a DVD recorder without being housed in a cartridge if acceptable.

Data is recorded on a DVD-RAM disc by a phase change system. The data recorded on the disc is managed on a sector-by-sector basis, and accompanied with an address for access. A group of 16 sectors is a unit for error correction, and accompanied with an error correction code and referred to as an ECC block.

FIG. 7A is a diagram showing a recording area of a DVD-RAM disc that is a recordable optical disc. As shown in FIG. 7A, on a DVD-RAM disc, a read-in area, a read-out area and a data area are arranged on the most inside perimeter of the disc, the most outer perimeter and between them, respectively. In the read-in area, a reference signal required for stable servo control at the time of access by an optical pickup, an identification signal for distinguishing from other mediums and others are recorded. In the read-out area, a reference signal and others are recorded, just like the read-in area. The data area is divided into sectors (2048 bytes), each of which is the minimum access unit. The DVD-RAM disc is also divided into a plurality of zone areas in order to realize rotation control called Z-CLV (Zone Constant Linear Velocity) at the time of recording and reproduction. Also, as shown in FIG. 7A, the DVD-RAM disc is divided into 24 zone areas of zones 0˜23. The rotation angle speed of the DVD-RAM disc is set for each zone area so that the speed becomes higher as the zone area is located inside, and is maintained constant While an optical pickup accesses one zone area. Therefore, higher density of a DVD-RAM disc and easy rotation control for recording and reproduction are realized.

FIG. 7B is a horizontal view of a read-in area, a read-out area, and a zone area 0˜23 which are arranged concentrically as shown in FIG. 7A. The read-in area and the read-out area have defect management areas (DMA) in themselves. A defect management area is an area in which location information indicating a location of a defective sector and alternative location information indicating where a sector alternative to the defective sector is located in the alternative area are recorded. Each zone area has a user area in itself and an alternative area and an unused area on the boundaries with the adjacent zone areas. The user area is an area which a file system can use as a recording area. The alternative area is an area which is alternatively used when there exists a defective sector. The unused area is an area which is not used for data recording. The unused areas are provided for 2 tracks. Sector addresses are recorded in the same position of respective adjacent tracks in a zone, but in the case of Z-CLV, sector addresses are recorded in different positions of adjacent tracks on the boundary between zones, and thus the unused areas are provided in order to prevent the resulting wrong determination of sector addresses.

As mentioned above, there exist sectors unused for data recording on the boundaries between zones. Therefore, in a DVD-RAM disc, logical sector numbers (LSN) are assigned to physical sectors in user areas in the order from the inside to the outer perimeter so that only sectors used for data recording are shown consecutively.

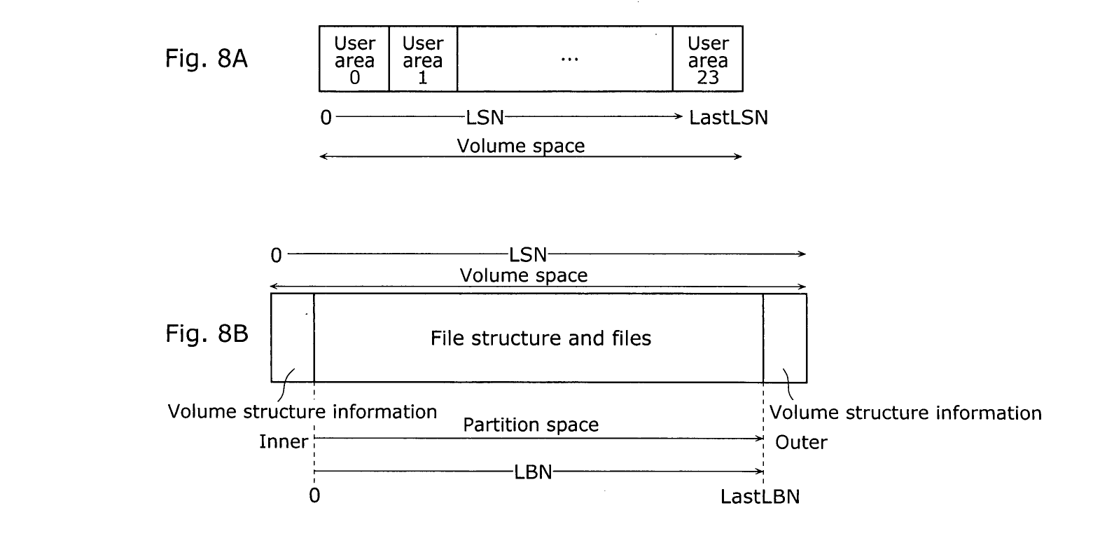

FIG. 8A and FIG. 8B are diagrams showing a logical data space of a DVD-RAM disc which is comprised of logical sectors. A logical data space called a volume space records user data. A volume space manages recorded data in a file system. To be more specific, information for managing a group of sectors storing data as a file and further managing a group of files as a directory is recorded in a partition space in the volume space, and volume structure information for managing the partition space and others are recorded at the header and trailer of the volume space. A file system used in a DVD recorder is called a UDF and conforms to ISO13346 standard.

Note that the above groups of sectors are not always located in sequence in the volume space but a part of them is discretely located. Therefore, the file system manages the group of sectors located in sequence in the volume space, out of the groups of sectors constituting a file, as an extent, and manages the file as a set of relevant extents.

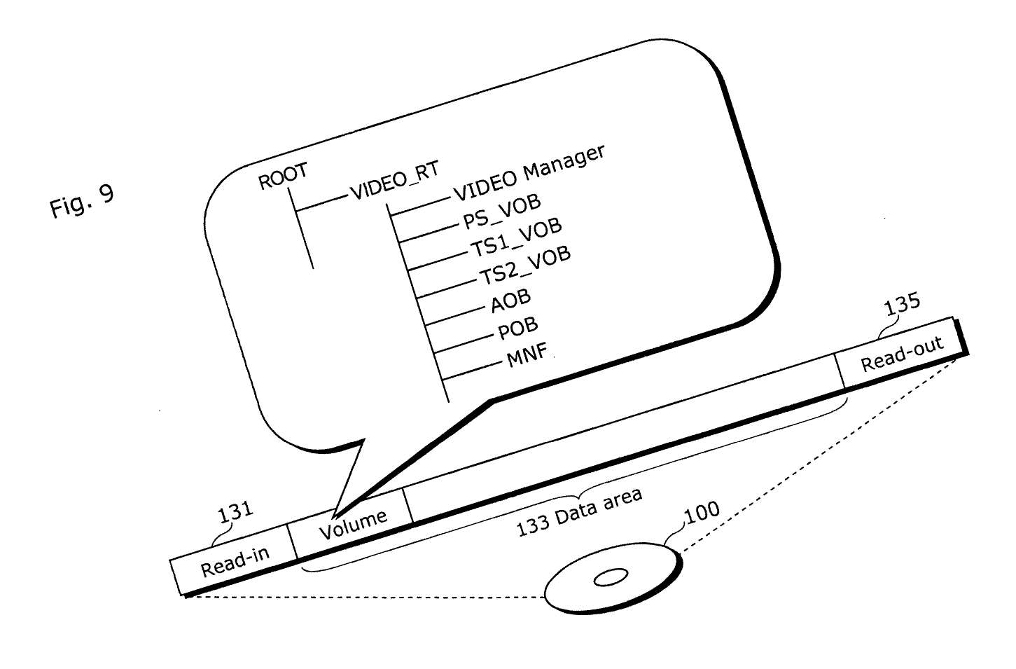

FIG. 9 is a diagram showing a directory of files of moving picture data which is recorded on a DVD-RAM disc and a structure of each file. Under a ROOT directory, there is a VIDEO_RT directory, and under the VIDEO_RT directory, there are files of various objects that are data for reproduction and a VIDEO Manager file as management information indicating the reproduction order and various attributes are stored. The objects are data in conformity with the MPEG standards, such as PS_VOB, TS1_VOB, TS2_VOB, AOB, POB and MNF.

PS_VOB, AOB and POB out of them are MPEG program streams (PS), and TS1_VOB and TS2_VOB are transport streams (TS). A program stream has a data structure assuming that AV information is stored in a package media, while a transport stream has a data structure assuming a communication media.

Generally speaking, PS_VOB, TS1_VOB and TS2_VOB are all objects which mainly include video information although they have both video information and audio information. TS1_VOB is an object which is basically encoded by a DVD recorder, and the picture structure in this object is managed in detail. TS2_VOB is an object which is encoded outside the DVD recorder, and a part of the data structure, such as a picture structure, of this object is unknown. Typically, TS1_VOB is an object in a form of a transport stream which is obtained as a result that a DVD recorder encodes an analog video signal inputted from outside, while TS2_VOB is an object which is recorded directly on a disc without encoding a digital video signal inputted from outside. AOB and POB are MPEG program streams. AOB is an object which mainly includes audio information, while POB is an object which mainly includes video information. MNF is a file specific to a manufacturer, and stores additional information for supporting operation of a recording/reproduction apparatus.

Note that all of PS_VOB, POB, AOB, TS1_VOB and TS2_VOB do not need to be recorded. Also, “mainly including audio or video information” means that higher bit rate is allocated to audio or video information. VOB is used for applications such as movies, and AOB is used for music applications.

(4. Overview of AV Information to be Reproduced)

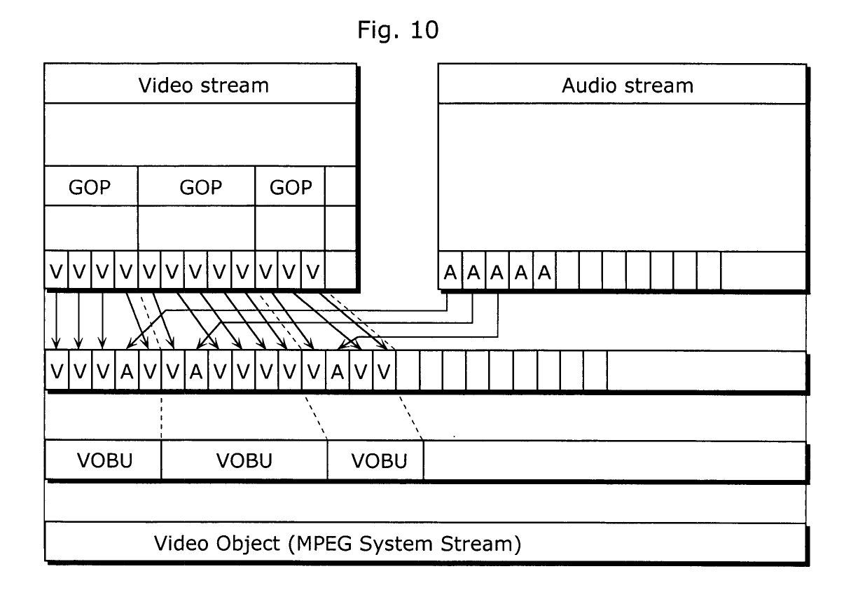

FIG. 10 is a diagram showing a structure of MPEG data which is recorded on a DVD disc as one of various AV objects. As shown in FIG. 10, a video stream and an audio stream are respectively divided and multiplexed. A multiplexed stream is referred to as a system stream under the MPEG standards. In a case of DVD, a system stream for which DVD specific information is set is referred to as a VOB (Video Object). A unit of division is referred to as a pack packet which has the data amount of about 2 KBytes.

A video stream is encoded in accordance with the MPEG standards, and it is compressed at the higher bit rate if it is complicated video which is compressed at a variable bit rate such as video with active motions. Under the MPEG standards, pictures of video are encoded with respect to each type of pictures; I-pictures, P-pictures and B-pictures. Spatial compression and encoding without reference to other frames are performed on I-pictures, and temporal compression and encoding using correlation between frames are performed on P-pictures and B-pictures. Under the MPEG standards, a section including at least one picture is managed as a GOP (Group of Picture(s)). GOP is an access point for a special reproduction such as fast-forwarding because the frame includes a compressed I-picture. On the other hand, encoding according to AC3 and LPCM as well as AAC and MP3 which are the MPEG audio standards are used in a DVD for encoding audio streams. As shown in FIG. 10, the unit of multiplexed data including video information which constitutes a GOP and the accompanying audio information is referred to as VOBU (Video Object Unit).

VOBU sometimes includes information for managing a current moving picture section as header information. There are two types of system streams as mentioned in FIG. 10; a program stream (PS) and a transport stream (TS). PS has a data structure assuming package media, and TS has a data structure assuming communication media.

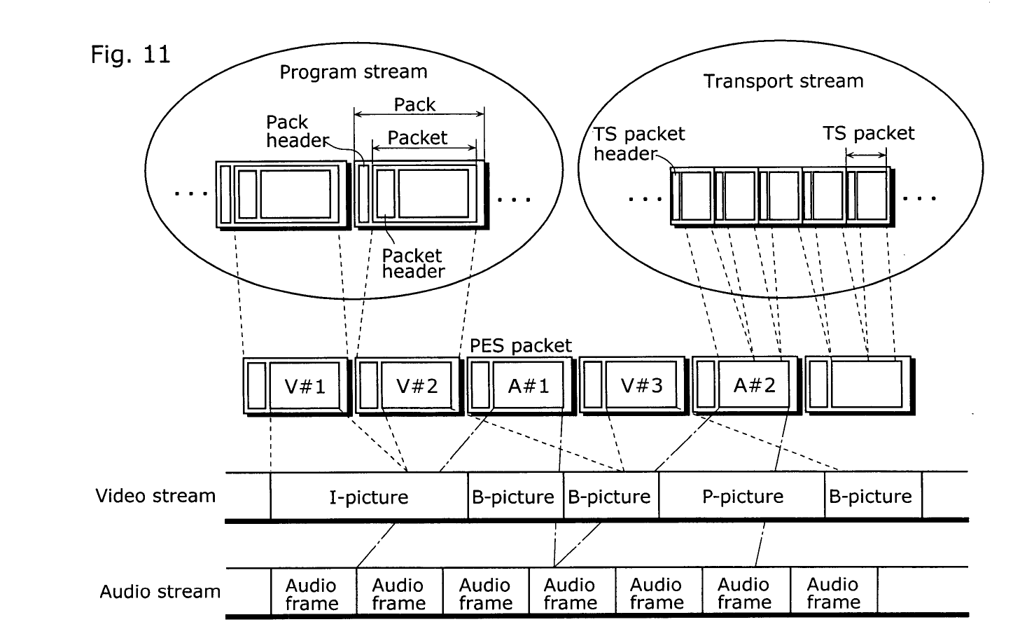

FIG. 11 is a diagram for explaining an overview of data structures of a program stream and a transport stream. A program stream consists of fixed-length packs which are the minimum units for transmission and multiplexing, and a pack has one or more packets. Both a pack and a packet have headers and data portions respectively. A data portion is referred to as a payload according to MPEG. In a case of a DVD, a fixed length of a pack matches a sector size, namely, 2 KB. A pack can have a plurality of packets, but a pack for storing DVD video and audio has only one packet, so one pack includes one packet except in special cases.

On the other hand, a transport stream consists of fixed-length packets which are the units for transmission and multiplexing. A TS packet has a size of 188B, which matches that of ATM transmission which is a communication protocol. One or more TS packets constitute a PES packet. A PES packet is a concept common to a program stream and a transport stream, and the data structure of the PES packet is common to both streams. A packet stored in a pack in a transport stream directly constitute a PES packet, while one or more TS packets in a transport stream constitutes a PES packet.

A PES packet is the minimum unit for encoding, and stores video information and audio information which are common for encoding respectively. In other words, video information and audio information encoded by different encoding methods are never stored together in one PES packet. However, if audio information and video information are encoded by the same method, boundaries between pictures or audio frames do not need to be assured. As shown in FIG. 11, a plurality of PES packets can store one I-picture, or one PES packet can store a plurality of picture data.

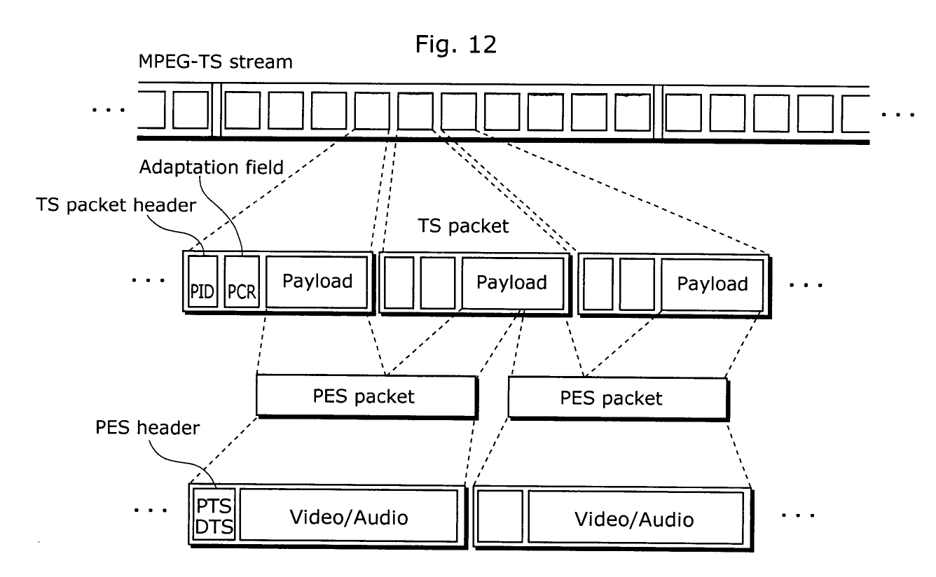

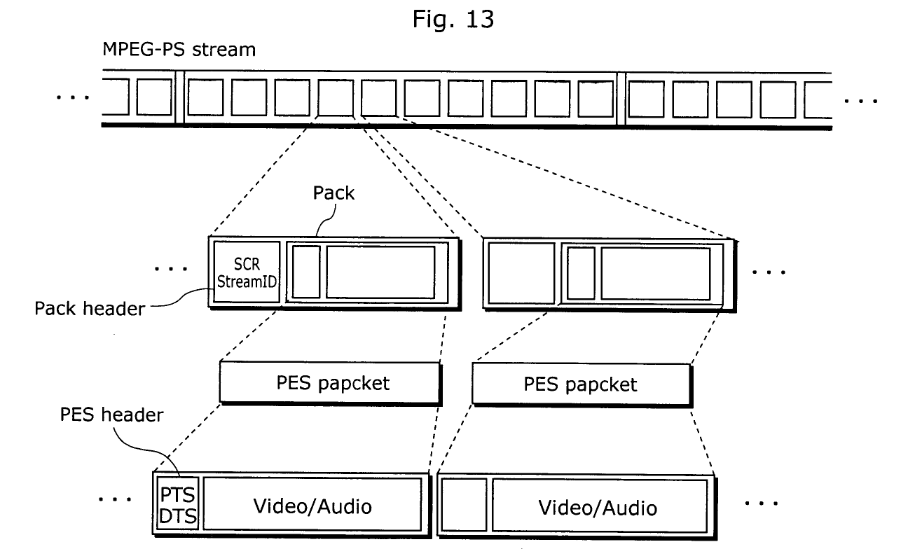

FIG. 12 is a diagram showing a data structure of a transport stream, and FIG. 13 is a diagram showing a data structure of a program stream. As shown in FIG. 12 and FIG. 13, a TS packet consists of a TS packet header, an adaptation field and a payload. A TS packet header stores a PID (Packet Identifier), which identifies a type of a stream including the TS packet, namely, a video stream or an audio stream.

An adaptation field stores a PCR (Program Clock Reference). The PCR is a reference value of a standard clock (STC) of a device for decoding a stream. The device typically demultiplexes a system stream at the timing of the PCR and reconstructs it into a stream such as a video stream.

A PES header stores a DTS (Decoding Time Stamp) and a PTS (Presentation Time Stamp). The DTS indicates the decoding timing of a picture/an audio frame stored in the PES packet, while the PTS indicates the presentation timing of audio/video output. Note that every PES packet header does not need to have a PTS and a DTS. There is no harm in decoding and outputting if a header of a PES packet in which the first data of an I-picture is stored has a PTS and a DTS.

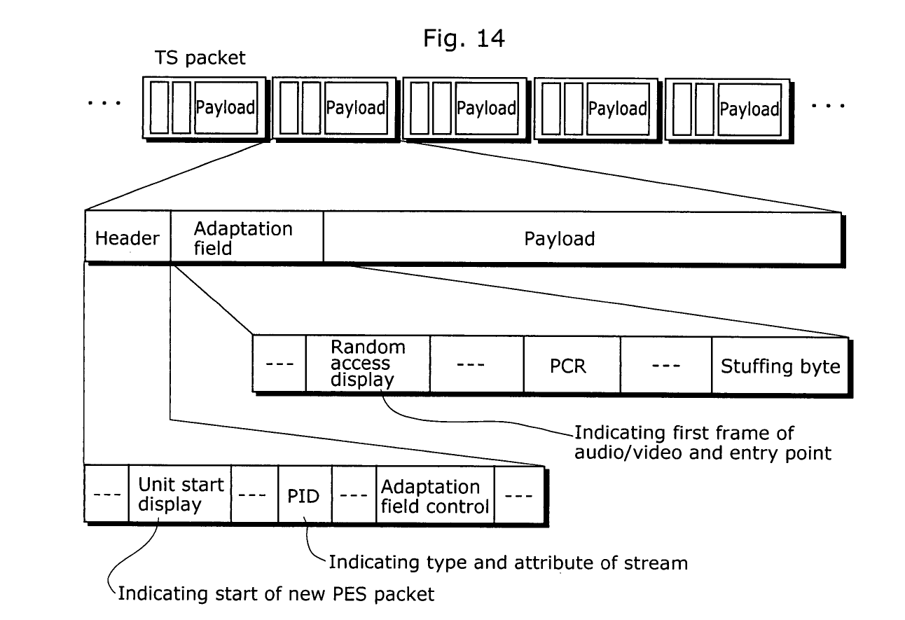

FIG. 14 is a diagram showing a detailed structure of a TS packet. As shown in FIG. 14, an adaptation field stores a random access display flag in addition to a PCR, and the random access display flag indicates whether or not the payload paired with the adaptation field stores data which is the first frame of video and audio and can be the entry point. Also, a header of a TS packet stores a unit start display flag indicating the start of a PES packet and an adaptation field control information indicating whether an adaptation field follows the header or not, in addition to the above-mentioned PID.

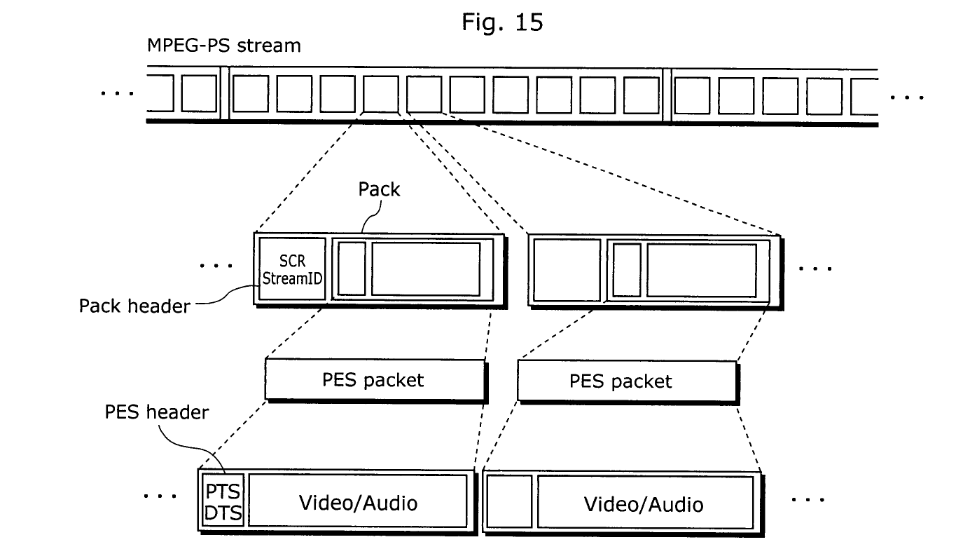

FIG. 15 is a diagram showing a structure of a pack which constitutes a program stream. A pack has a header including an SCR and a stream ID. An SCR and a stream ID are substantially equivalent to a PCR and a PID of a transport stream, respectively. Also, a data structure of a PES packet is common to that in a transport stream, so a PES header stores a PTS and DTS.

One major difference between a program stream and a transport stream is that multiprograms are available in the transport program. In other words, although a program stream can transmit only one program as a unit, a transport stream is structured assuming that a plurality of programs are transmitted simultaneously. Therefore, a reproduction apparatus needs to identify a video stream or an audio stream which constitutes each program in a transport stream.

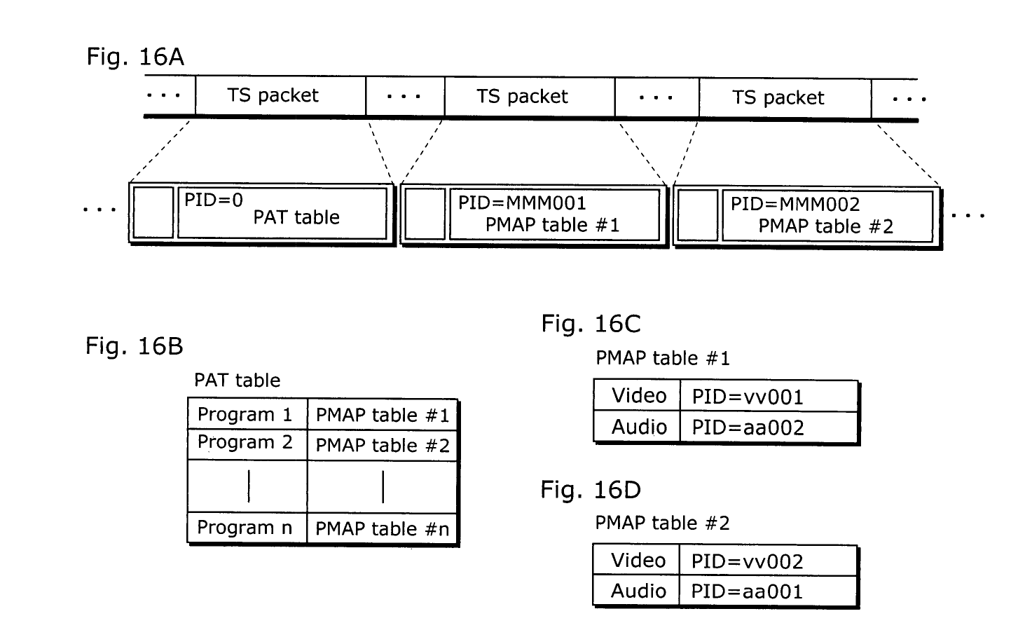

FIG. 16A˜FIG. 16D are diagrams showing a PAT table and PMAP tables for transmitting structure information of an audio stream and a video stream which constitute a program. As shown in FIG. 16A˜FIG. 16D, a PMAP table stores information on a combination of a video stream and an audio stream used for each program, and a PAT table stores information on a combination of a program and a PMAP table. A reproduction apparatus can detect a video stream and an audio stream which constitute a program upon request for outputting them from the PAT table and the PMAP table.

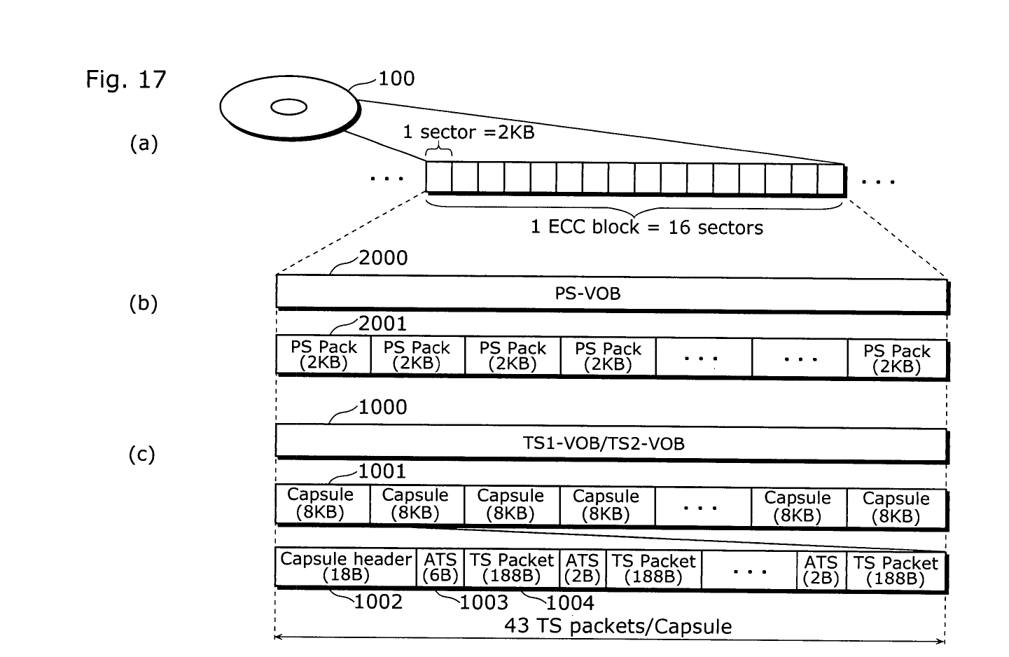

Next, how the above-mentioned packs in a program stream and TS packets in a transport stream are arranged on a disc will be explained with reference to FIG. 17.

As shown in (a) of FIG. 17, 16 sectors constitute an ECC block. As shown in (b) of FIG. 17, each of packs (PS packs) constituting a video object (PS-VOB) in the form of a program stream is arranged within each sector boundary because both a pack size and a sector size are 2 KB.

On the other hand, as shown in (c) in FIG. 17, a video object in the form of a transport stream (TS1-VOB/TS2-VOB) is arranged in an ECC block in the unit of a capsule having a size of 8 KB. This capsule has a header area of 18B and a data area in which 43 TS packets added with ATS information are arranged. The ATS information (Arrival Time Stamp Information) is information generated and added by a DVD recorder, and indicates the timing when the current packet is transmitted to the DVD recorder from outside.

It has been explained that a capsule of 8 KB stores 43 MPEG transport packets, but the present invention is not limited to that. TS1-VOB/TS2-VOB may be formed by a set of pairs of one ATS (with a fixed byte length) and one MPEG transport packet.

(5. Overview of Management Information of AV Information and Reproduction Control Thereof)

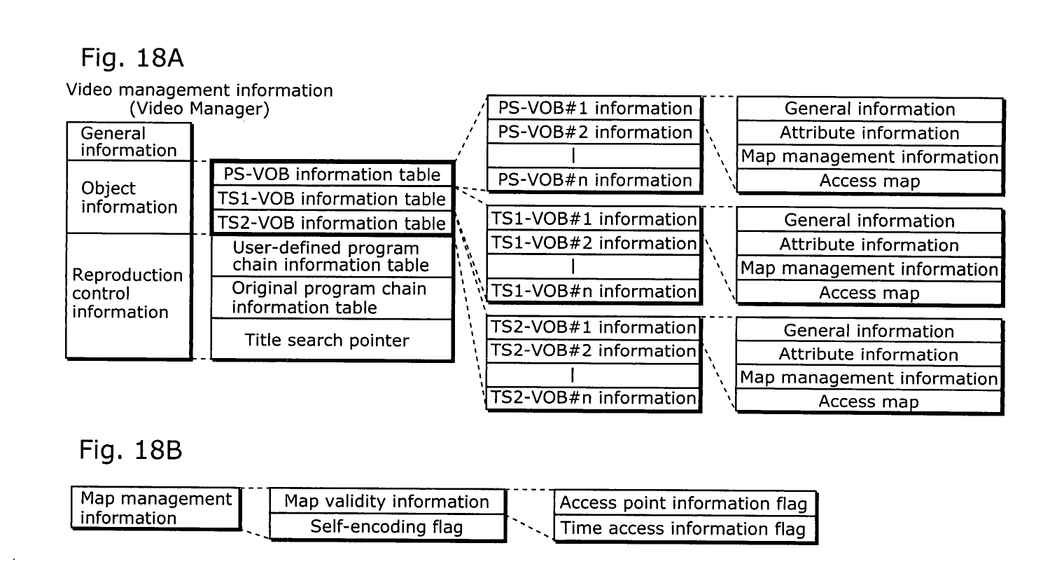

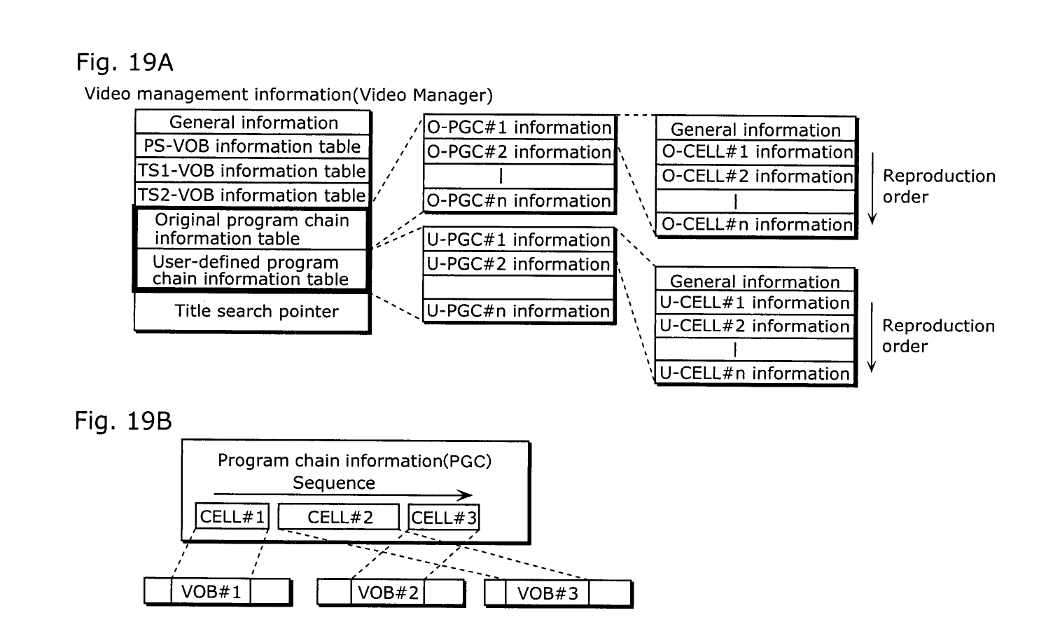

FIG. 18A, FIG. 18B, FIG. 19A and FIG. 19B are diagrams showing data structures called video management information (Video Manager) as shown in FIG. 9. Video management information includes object information indicating management information such as locations of recording various objects on a disc, and reproduction control information indicating a reproduction order of the objects.

FIG. 18A shows the case where objects to be recorded on a disc are PS-VOB#1˜PS-VOB#n, TS1-VOB#1˜TS1-VOB#n, and TS2-VOB#1˜TS2-VOB#n.

As shown in FIG. 18A, there exist information tables for PS-VOB, TS1-VOB and TS2-VOB respectively depending upon object types, and each of the information tables has VOB information of each object. Each VOB information has general information of a corresponding object, attribute information of the object, an access map for converting the reproduction time of the object into an address on a disc and management information of the access map. General information has identification information of the corresponding object, recording time of the object, a manufacturer's ID and the like, and the attribute information includes video stream information (V_ATR) such as an encoding mode of the video stream, the number of audio streams (AST_Ns) and audio stream information (A_ATR) such as an encoding mode of the audio stream.

There are two reasons why an access map is required.

First, an access map is required for preventing program chain information from referring to a recording location on a disc directly using a sector address or the like and for referring using a reproduction time of an object indirectly. A recording location of an object on a RAM medium may be changed due to editing or the like, and if program chain information refers to the recording location of the object directly using a sector address or the like, the program chain information to be updated increases. On the other hand, when it refers indirectly using a reproduction time, the program chain information does not need to be updated but only the access map needs to be updated.

Second, an AV stream generally has two references; a time domain and a data (bit string) domain, and there is no exact correlation between these two references. For example, in MPEG-2 video that is an international standard for a video stream, use of a variable bit rate (a method for changing a bit rate depending on complexity of image quality) has been in the mainstream. However, since there is no proportionality between the amount of data from the beginning and the reproduction time in this case, random access is not available using a time domain as a reference. In order to solve this problem, object information has an access map for converting between a time domain and a data (bit string) domain.

As shown in FIG. 18A, reproduction control information includes a user-defined program chain information table, an original program chain information table and a title search pointer.

As shown in FIG. 19A and FIG. 19B, there are two types of reproduction channels; original program chain information which is automatically generated so that a DVD recorder indicates all the objects recorded at the object recording time, and user-defined program chain information in which a user can freely define a reproduction sequence. A reproduction channel in DVD is called PGC information (Program Chain Information) in a unified way, and user-defined program chain information and original program chain information are respectively called U-PGC information and O-PGC information. These O-PGC information and U-PGC information are information listing cell information indicating a cell that is a reproduction section of an object in a table format. A reproduction section of an object indicated by O-PGC information is called an original cell (O-CELL), and a reproduction section of an object indicated by U-PGC information is called a user cell (U-CELL). A cell indicates a reproduction section of an object with a reproduction start time and a reproduction end time of the object, and the reproduction start time and the reproduction end time are converted into actual recording location information of the object on a disc using the above-mentioned access map.

As shown in FIG. 19B, a group of cells indicated by PGC information constitutes a reproduction sequence which is reproduced in sequence in a table entry order.

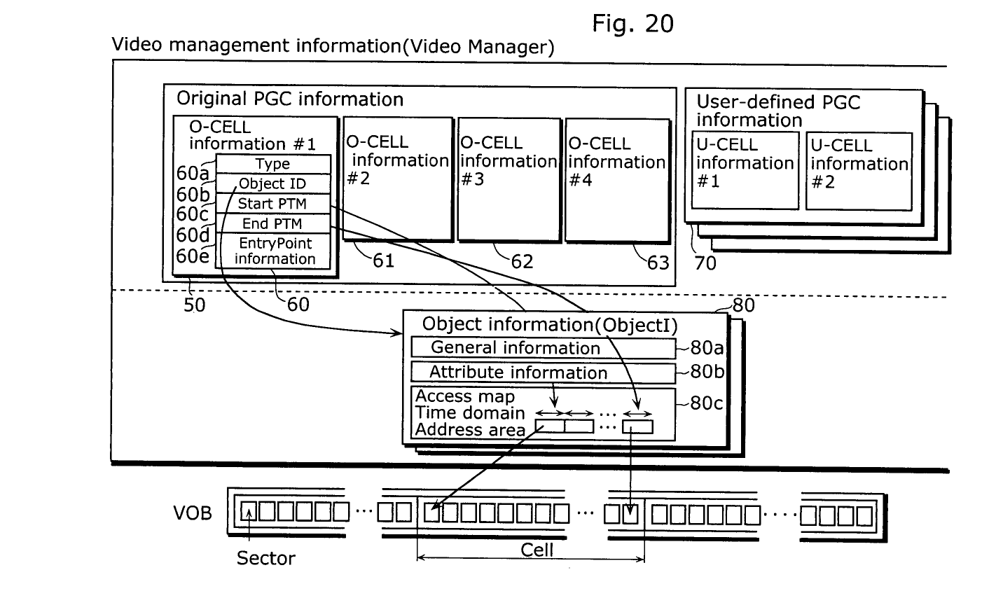

FIG. 20 is a diagram for explaining specifically a relation between an object, a cell, a PGC and an access map. As shown in FIG. 20, original PGC information 50 includes at least one of cell information 60, 61, 62 and 63. Each of the cell information 60˜63 identifies an object to be reproduced and further identifies a type of the object and a reproduction section of the object. Recording order of cell information in the original PGC information 50 indicates reproduction order of the object identified by each cell.

One cell information 60 includes type information (Type) 60a indicating a type of an object identified with the cell information, an object ID (Object ID) 60b that is identification information of the object, start time information (Start_PTM) 60c in the object in the time domain, end time information (End_PTM) 60d in the object in the time domain, and entry point information (EPI) 60e. The EPI 60e is defined with time information, and plays a role like a bookmark. The number of entry points in a cell is recorded in the cell information, although it is not shown in FIG. 20. The EPI is composed of PTM of the entry point, type information of the entry point and others. When data is reproduced, the cell information 60 in the original PGC information 50 is read out in sequence, and thus a section specified by each cell of the object identified by the cell is reproduced. An access map 80c converts start time information and end time information indicated in the cell information into object location information on a disc.

The above-mentioned map information is generated and recorded when an object is recorded. A picture structure in object data needs to be analyzed in order to generate a map. Specifically, it is necessary to detect a location of an I-picture as shown in FIG. 11, and detect time stamp information such as PTS that is the reproduction time of the I-picture as shown in FIG. 12 and FIG. 13.

Problems which occur when generating map information of PS-VOB, TS1-VOB and TS2-VOB will be explained below. As explained in FIG. 3, typically, a DVD recorder encodes received analog broadcasting into a MPEG stream and thus PS-VOB and TS-VOB1 are generated. Since the DVD recorder generates information on an I-picture and various time stamps by itself, the data structure in the stream is clear to the DVD recorder, and thus there occurs no problem in generating map information.

Next, as for TS2-VOB, also as shown in FIG. 3, typically, a DVD recorder records received digital broadcasting directly on a disc without encoding it. Since the DVD recorder does not generate a location of an I-picture and time stamp information by itself, unlike PS-VOB, the data structure in the stream is not clear to the DVD recorder, and thus these information need to be detected from a digital stream to be recorded. Therefore, the DVD recorder detects an I-picture and time stamps in the map information of TS2-VOB on which a stream encoded outside the recorder is recorded, in the following manner.

First, an I-picture is detected by detecting random access display information in an adaptation field of a TS packet as shown in FIG. 14. A time stamp is detected by detecting a PTS in a PES header. A time stamp may be detected by detecting, instead of a PTS, a PCR in an adaptation field or an ATS that is timing when a TS packet arrives at a DVD recorder. Anyway, a DVD recorder detects a location of an I-picture without analyzing a data structure of a video layer of an MPEG stream but based on the information of the higher system layer. This is because analysis of a video layer for generating map information puts an enormous load on a system.

It may be impossible to detect a system layer, but in this case, map information cannot be generated, and thus it is necessary to indicate that there is no valid map information. In a DVD recorder, map management information as shown in FIG. 18A and FIG. 18B indicate these information. As shown in FIG. 18B, map management information includes map validity information and a self-encoding flag. The self-encoding flag indicates that an object is encoded by the DVD recorder itself, the picture structure in the object is clear, and the time stamp information and I-picture location information in the map information are accurate. Also, the map validity information indicates whether there is a valid access map or not.

Note that as an example where detection of a system layer is impossible, a case where an adaptation field is not set or a case where a digital stream is not an MPEG transport stream to begin with can be conceived. It is also conceivable that a DVD recorder records an object of which map cannot be generated by the DVD recorder because various types of digital broadcasting systems can be employed around the world. For example, when a DVD recorder intended for a Japanese digital broadcasting system is used in the U.S. to record U.S. digital broadcasting, an object of which map cannot be generated may be recorded.

However, it is possible for a DVD recorder to reproduce such an object of which map cannot be generated in sequence from the beginning. In this case, the recorded digital stream can be reproduced as video if it is outputted to an STB which supports the stream via a digital I/F.

(6. Basic Operation of a Reproduction Function)

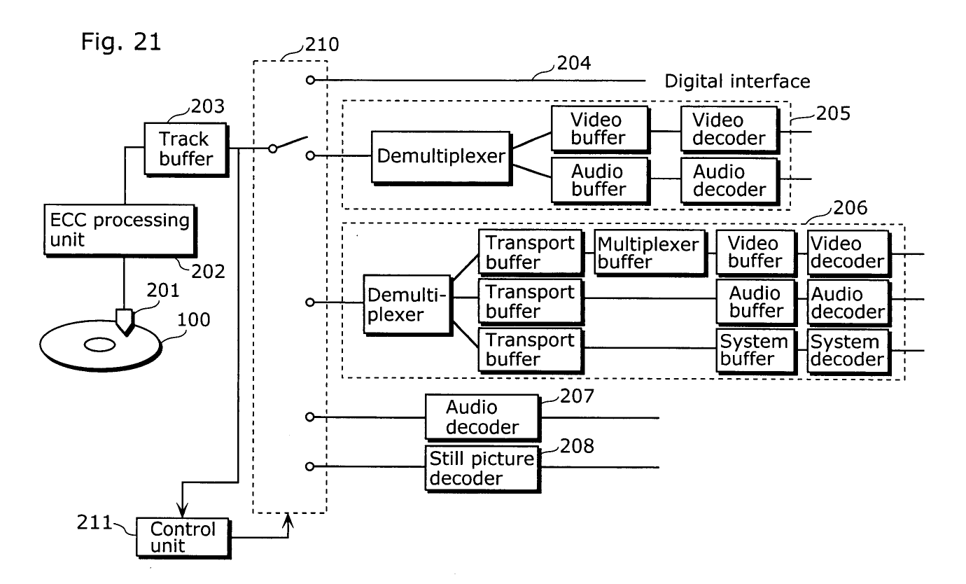

Next, a reproduction operation of a DVD recorder/player which reproduces an optical disc will be explained with reference to FIG. 21.

As shown in FIG. 21, this DVD recorder/player includes an optical pickup 201 for reading out data from a DVD-RAM disc 100, an ECC processing unit 202 for making error correction or the like of the read-out data, a track buffer 203 for storing the error-corrected data temporarily, a PS decoder 205 for reproducing a program stream such as a moving picture object (PS_VOB), a TS decoder 206 for reproducing a transport stream of a digital broadcasting object (TS1_VOB), an audio decoder 207 for reproducing an audio object (AOB), a still picture decoder 208 for decoding a still picture object (POB), a switch 210 for switching data entry into the decoders 205˜208, and a control unit 211 for controlling each unit of the player.

Data recorded on the DVD-RAM disc 100 is read out from the optical pickup 201 and stored in the track buffer 203 via the ECC processing unit 202. The data stored in the track buffer 203 is inputted in any of the PS decoder 205, the TS decoder 206, the audio decoder 207 and the still picture decoder 208, decoded and outputted.

At this time, the control unit 211 determines the data to be read out based on the reproduction sequence indicated by the program chain information (PGC) in FIG. 19B. To be more specific, in the example of FIG. 19B, the control unit 211 controls so that a section (CELL#1) of VOB#1 is reproduced first, then a section (CELL#2) of VOB#3 and finally a section (CELL#3) of VOB#2.

Also, the control unit 211 can obtain a type of a cell to be reproduced, a corresponding object, a reproduction start time and a reproduction end time of the object based on the cell information in the program chain information (PGC) as shown in FIG. 20. The control unit 211 inputs data in the section of the object identified with the cell information into a suitable decoder. At this time, the control unit 211 identifies the object to be reproduced with its ID. The control unit 211 further identifies the cell that is a reproduction section of the identified object by converting StartPTM and EndPTM of the cell information into addresses of disc information using the access map of the relevant VOB information.

The DVD recorder/player further includes a digital interface 204 for supplying an AV stream to the outside. This enables supply of an AV stream to the outside via a communication means such as IEEE1394 and IEC958. Particularly, this enables output of an AV stream directly to an external STB via the digital interface 204 without decoding, and thus reproduction on that STB, because there may be no suitable decoder in the player if the player does not encode TS2-VOB. When outputting digital data to the outside directly, the control unit 211 judges whether random access reproduction is possible or not based on the map management information in FIG. 18B. If the access point information flag is valid, the access map has location information of an I-picture.

Therefore, upon request for fast-forwarding reproduction or the like from an external device, the control unit 211 can output digital data including an I-picture to the external device via a digital I/F. If the time access information flag is valid, time access is possible. Therefore, upon request for time access from an external device, the control unit 211 can output digital data including picture data corresponding to the specified reproduction time to the external device via a digital I/F.

(7. Basic Operation of a Recording Function)

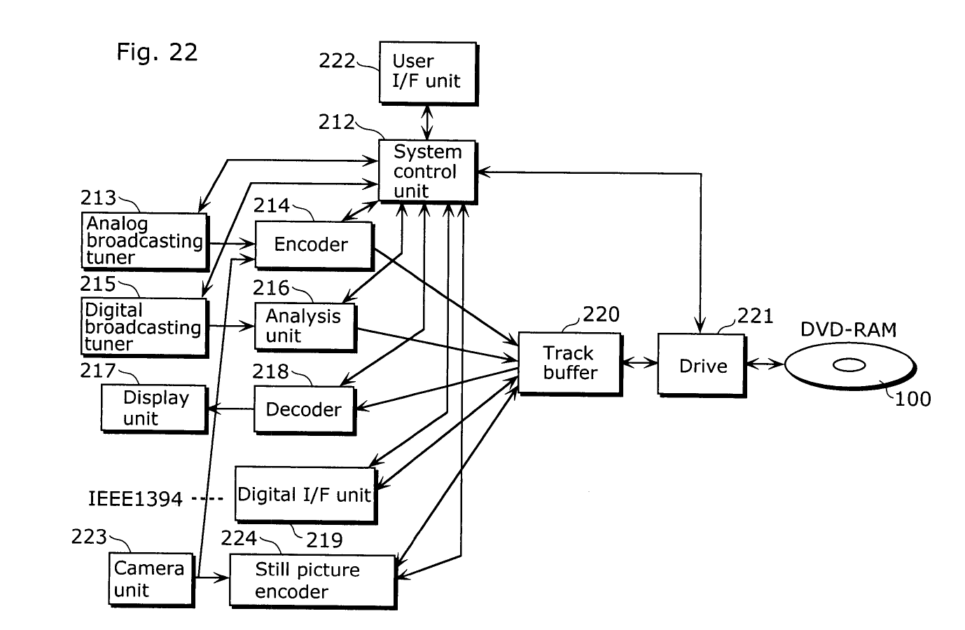

Next, the structure and operation of the DVD recorder according to the present invention which records data on the above-mentioned disc and reproduces the data from the disc will be explained with reference to FIG. 22.

As shown in FIG. 22, a DVD recorder includes a user I/F unit 222 which displays for a user and accepts a request from a user, a system control unit 212 which manages and controls the entire DVD recorder, an analog broadcasting tuner 213 which receives VHF and UHF, an encoder 214 which encodes an analog signal into a, digital signal and then encoding it into an MPEG program stream, a digital broadcasting tuner 215 which receives digital satellite broadcasting, an analysis unit 216 which analyzes an MPEG transport stream sent via digital satellite, a display unit 217 such as a television and a speaker, and a decoder 218 which decodes an AV stream.

If a recording apparatus is a DVD camcorder, it includes a camera unit 223 which receives video and a still picture encoder 224 which encodes an AV signal sent from the camera unit 223 into a JPEG stream.

An AV signal is encoded into an MPEG program stream of moving pictures by sending the AV signal from the camera unit 223 to the encoder 214. The decoder 218 includes the first and second decoders as shown in FIG. 21. The DVD recorder further includes a digital I/F unit 219, a track buffer 220 which stores written data temporarily, and a drive 221 which writes data onto a DVD-RAM disc 100. The digital I/F unit 219 is an interface which outputs data to an external device via a communication means such as IEEE1394 and USB.

In the DVD recorder structured as above, the user I/F unit 222 first receives a request from a user. The user I/F unit 222 delivers the user's request to the system control unit 212, and the system control unit 212 analyzes the user's request and requests each module for processing. There are two types of recording: a self-encoding for self-encoding inputted digital data; and an outside encoding for recording digital data encoded by another device on a disc without self-encoding it.

(7.1 Recording Operation by Self-Encoding)

First, an operation for recording by self-encoding, specifically an operation for encoding analog broadcasting into PS-VOB for recording will be explained in detail. The system control unit 212 requests the analog broadcasting tuner 213 to receive analog broadcasting and the encoder 214 to encode it. The encoder 214 performs video encoding, audio encoding and system encoding on AV data sent from the analog broadcasting tuner 213, and sends the resulting data to the track buffer 220.

The encoder 214 sends the time stamp information included in the first data of the encoded MPEG program stream to the system control unit 212 as a reproduction start time (PS_VOB_V_S_PTM), and then sends information necessary for creating an access map to the system control unit 212 in parallel with encoding. This value is set as Start_PTM of the cell information to be generated later as shown in FIG. 20. The time stamp information is generally PTS, but SCR may be used in place of PTS.

Next, the system control unit 212 requests the drive 221 for recording, and the drive 221 retrieves data stored in the track buffer 220 and records it on the DVD-RAM disc 100. Specifically, the drive 221 searches a recordable area on a disc for a continuous data area (CDA) and records the data in the continuous data area. Recording stop is instructed with a stop request from a user. The user's recording stop request is conveyed to the system control unit 212 via the user I/F unit 222, and the system control unit 212 sends a stop request to the analog broadcasting tuner 213 and the encoder 214.

Upon receipt of the encoding stop request from the system control unit 212, the encoder 214 stops encoding, and sends the time stamp information included in the last data of the MPEG program stream which has been encoded lastly to the system control unit 212 as reproduction end time (PS_VOB_V_E_PTM). This value is set as End_PTM of the cell information as shown in FIG. 20. The time stamp information is generally PTS, but SCR may be used in place of PTS.

After encoding, the system control unit 212 generates VOB information for PS-VOB (PS-VOBI) and reproduction control information as shown in FIG. 18A. Here, the generated VOB information includes an access map and map management information suitable for an object type. The system control unit 212 sets the map validity information of the map management information to be valid, and sets the self-encoding flag to ON.

Then, an original program chain information (O-PGC information) for reproducing an object to be recorded as one of the objects for reproduction, as shown in FIG. 19A, is generated. The generated O-PGC information is appended to the original program chain information table. The original program chain information (O-PGC information) has cell information. “PS-VOB” is set for type information in the cell information.

Finally, the system control unit 212 requests the drive 221 to stop recording of the data stored in the track buffer 220 and to record VOB information for PS-VOB (PS_VOBI) and reproduction control information, and the drive 221 records the remaining data in the track buffer 220 and the VOB information and reproduction control information on the DVD-RAM disc 100 and ends the recording processing.

Note that analog broadcasting may of course be encoded into TS1-VOB. In this case, the encoder 214 needs to be an encoder for encoding an analog signal into a digital signal so as to encode it into an MPEG transport stream, so the type information in the cell information is set to “TS1-VOB”. Start_PTM and End_PTM in this case may be PTSs or PCRs.

Even when an AV signal sent from the camera unit is self-encoded, the same processing as above is basically performed. Only difference is that the camera unit, instead of the analog broadcasting tuner, inputs the AV signal into the encoder 214.

(7.2 Recording Operation by Outside Encoding)

Next, an operation for recording digital broadcasting by outside encoding will be explained in detail. In this case, an object type for recording is TS2-VOB. A user's digital broadcasting recording request is delivered to the system control unit 212 via the user I/F unit 222. The system control unit 212 requests the digital broadcasting tuner 215 to receive data and the analysis unit 216 to analyze the data.

The MPEG transport stream sent from the digital broadcasting tuner 215 is transferred to the track buffer 220 via the analysis unit 216. The analysis unit 216 first extracts time stamp information included in the first data of the transport stream as start time information (TS2_VOB_V_S_PTM), which is required for generating VOB information (TS2_VOBI) for an encoded MPEG transport stream (TS2-VOB) received as digital broadcasting at the beginning, and sends the extracted information to the system control unit 212. The start time information is set for Start_PTM of the cell information to be generated later as shown in FIG. 20. This time stamp information is a PCR or a PTS. An ATS, which is timing when an object is transmitted to a DVD recorder, may be used in place of them.

The analysis unit 216 analyzes a system layer of an MPEG transport stream to detect information necessary for creating an access map. Location of an I-picture in an object is detected based on a random access indicator (random_access_indicator) in an adaptation field in a TS packet header, as described above.

Next, the system control unit 212 outputs a recording request to the drive 221, and the drive 221 retrieves data stored in the track buffer 220 and records it on the DVD-RAM disc 100. At this time, the system control unit 212 instructs the drive 221 regarding where to record the data on the disc based on the allocation information of the file system. The drive 221 searches the recordable area on the disc for a continuous data area (CDA) and records the data in the continuous data area.

Recording stop is instructed with a stop request from a user. The user's recording stop request is delivered to the system control unit 212 via the user I/F unit 222, and the system control unit 212 sends a stop request to the digital broadcasting tuner 215 and the analysis unit 216.

Upon receipt of the analysis stop request, the analysis unit 216 stops the analysis, sends the time stamp information included in the last data of the MPEG transport stream which has been analyzed lastly to the system control unit 212 as a display end time (TS2_VOB_V_E_PTM). This value is set for End_PTM of the cell information as shown in FIG. 20. An ATS, which is timing when an object is transmitted to a DVD recorder, may be used in place of them.

After receiving digital broadcasting, the system control unit 212 generates VOB information for TS2-VOB (TS2_VOBI) and reproduction control information as shown in FIG. 18A. Here, the generated VOB information includes an access map and map management information suitable for an object type. When generating a valid access map for detecting a location of an I-picture in an object or the like, the system control unit 212 sets the map validity information of the map management information to be valid.

Also, a self-encoding flag is set to OFF. When the system control unit 212 cannot generate a valid access map, it sets the map validity information to be invalid. It is conceived that a valid access map cannot be generated when received digital broadcasting is not applicable, there is no random access information in an adaptation field, and so on. When digital broadcasting is inputted directly from the digital I/F, it may not be a MPEG transport stream. In this case, the map validity information is set to be invalid, of course.

Also, an original program chain information (O-PGC information) for reproducing an object to be recorded as one of the objects for reproduction is generated as shown in FIG. 19A. The generated O-PGC information is appended to the original program chain information table. The original program chain information (O-PGC information) has cell information. “TS2-VOB” is set for type information of cell information.

Finally, the system control unit 212 requests the drive 221 to end recording data stored in the track buffer 220 and to record VOB information for TS2-VOB (TS2_VOBI) and reproduction control information, and the drive 221 records the remaining data in the track buffer 220 and the VOB information and reproduction control information on the DVD-RAM disc 100, and ends the recording processing.

The operation has been explained based on the user's recording start and stop requests. However, in a case of timer recording used in a VTR, for example, a system control unit, in place of a user, automatically issues a recording start and stop requests, and thus the operation of the VTR is essentially same as that of a DVD recorder.

Next, a digital still camera (DSC) equipped with a semiconductor memory as a recording medium, on which image information encoded according to JPEG that is a standard for digital image data encoding, will be explained in the following order.

1. Overview of a system for a DSC

2. Overview of a recording medium

3. Overview of AV information to be reproduced

4. Basic operation of a reproduction function

5. Basic operation of a recording function

(1. Overview of a System for a DSC)

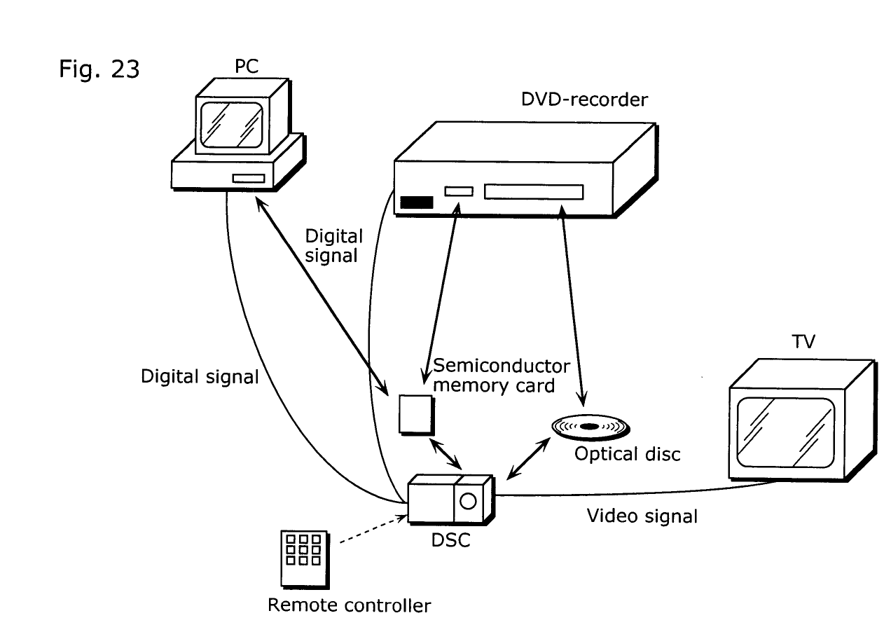

FIG. 23 is a diagram showing an appearance of a DSC and explaining an example of interfaces between the DSC and related devices. As shown in FIG. 23, a recording medium, such as an optical disc like a DVD and a semiconductor memory card for recording and reproducing still picture information mainly, is integrated into a DSC. The DSC is generally operated using switches on the DSC, a touch panel on a liquid crystal monitor, remote controller or the like.

A DSC has a camera unit including a lens, a CCD and others, and an AV signal outputted from the camera unit is encoded in the DSC and recorded on a recording medium. On the other hand, the recording medium on which still picture information is recorded is reproduced by the DSC and outputted to the outside. For example, an analog signal is outputted and inputted into a television, and then displayed as video. Or digital still picture data is sent to a personal computer, a DVD recorder or the like via a digital I/F.

Still picture information is sometimes recorded on and reproduced from a recording medium such as a DVD disc and a semiconductor memory card by a personal computer or a DVD recorder, not by a DSC. A DSC reproduces even still picture information recorded on a recording medium by another apparatus than the DSC if the recording medium is integrated into the DSC.

Note that as a digital I/F between a DSC and an external device such as a personal computer, a DVD recorder or the like, IEEE1394, ATAPI, SCSI, USB, a bus-type cable LAN, or a wireless LAN such as IEEE802.11 can be used.

(2. Overview of a Recording Medium)

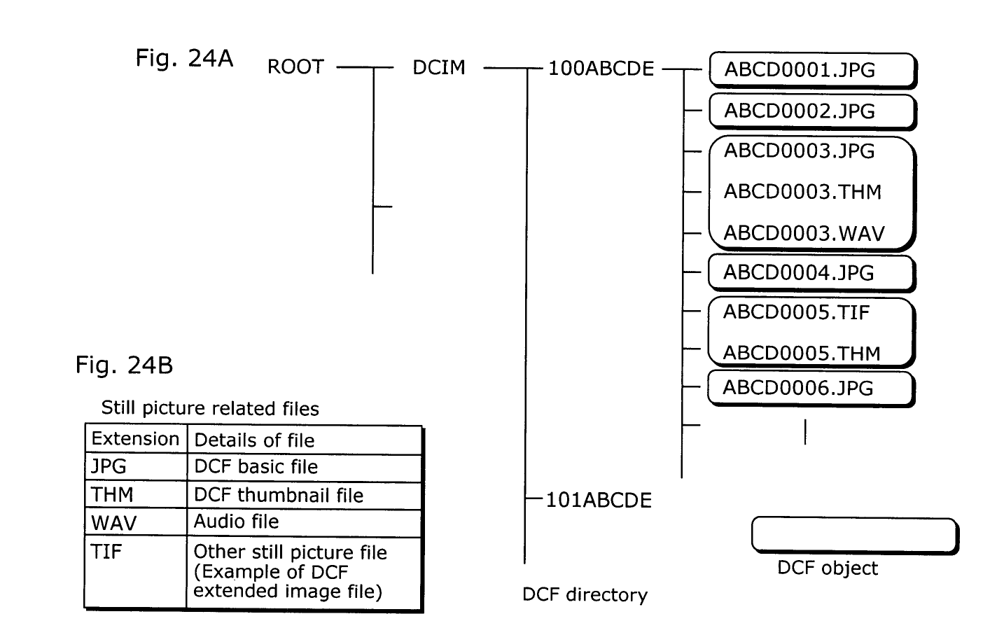

FIG. 24A and FIG. 24B are diagrams showing a directory of files of still picture data which is recorded on a memory card and a structure of the files. Here, a directory and a file structure according to the DCF standard will be explained as an example.

Under a root directory, there is a DCF image root directory (directory name: DCIM), under which there is a DCF directory for image storage. Under the DCF directory, a DCF object that is data for reproduction is stored.

A DCF object is a group of files recorded according to the DCS-defined standard, and includes a DCF basic file, a DCF extended image file, a DCF thumbnail file, and others.

A DCF basic file is a file which is recorded just under a DCF directory, has a DCF file name and an extension “JPG” determined under the DCF standard, complies with the Exif standard, and has a data structure determined under the DCF standard.

A DCF extended image file is an image file which is recorded just under the DCF directory, and has a DCF file name but has an extension and a data structure different from those of the DCF basic file.

A DCF thumbnail file is a compression file for recording a thumbnail image of a DCF extended image file.

Note that all of the DCF basic file, the DCF extended image file and the DCF thumbnail file do not need to be recorded. A motion JPEG file instead of a DCF object may be recorded.

Thanks to recent development of an image input apparatus such as a CCD, above-mentioned DCF basic file and DCF extended image file have been recorded as very high definition still picture data.

(3. Overview of AV Information to be Reproduced)

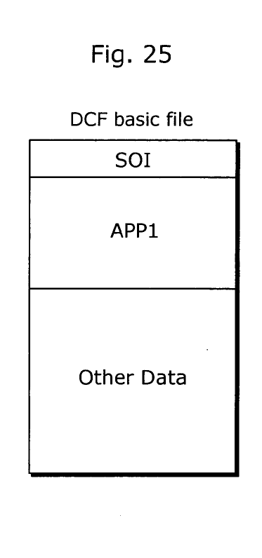

FIG. 25 is a diagram showing a structure of JPEG data which is recorded as a DCF basic file on a recording medium by a DSC. APP1 (Application Data Segment 1) is stored in a DCF basic file. This APP1 includes meta-data such as a shooting time and an aperture value. It always includes a thumbnail image of 160×120 pixels. APP1 is also called Exif supplementary information.

Also, still picture data is coded and compressed according to the JPEG standard, and stored in an area represented as “Other Data”.

(4. Basic Operation of a Reproduction Function)

Next, a reproduction operation of a DSC which reproduces the above-mentioned recording medium will be explained.

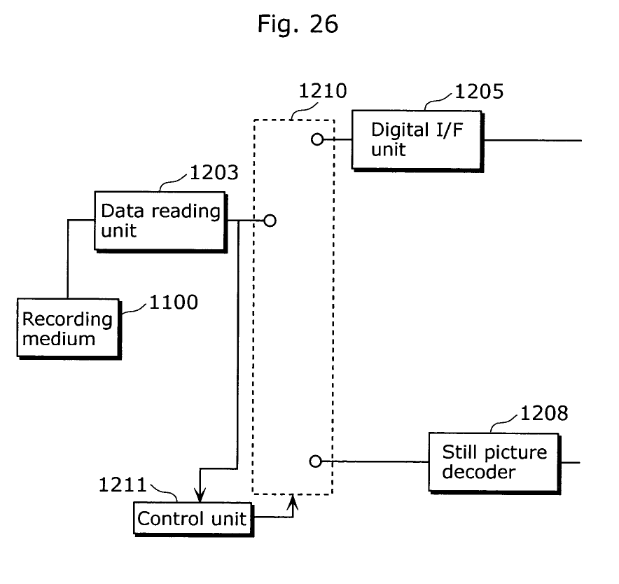

As shown in FIG. 26, a DSC includes a data reading unit 1203 for reading out data from a recording medium 1100, a still picture decoder 1208 for decoding still picture data, a digital interface 1205 for outputting read-out data in digital form, a switch 1210 for switching data input between the still picture decoder 1208 and the digital I/F unit 1205, and a control unit 211 for controlling each unit in the DSC.

Note that the data reading unit 1203 includes an ECC processing unit for making error correction of the read-out data, a track buffer for storing the error-corrected data temporarily, and others, if necessary.

Data recorded on the recording medium 1100 is reproduced by the data reading unit 1203, inputted into the still picture decoder 1208, and decoded and outputted. The data read out by the data reading unit 1203 is supplied to the outside via the digital I/F unit 1205. Therefore, still picture data can be copied or moved to a hard disk on a PC or a DVD disc on a DVD recorder.

(5. Basic Operation of a Recording Function)

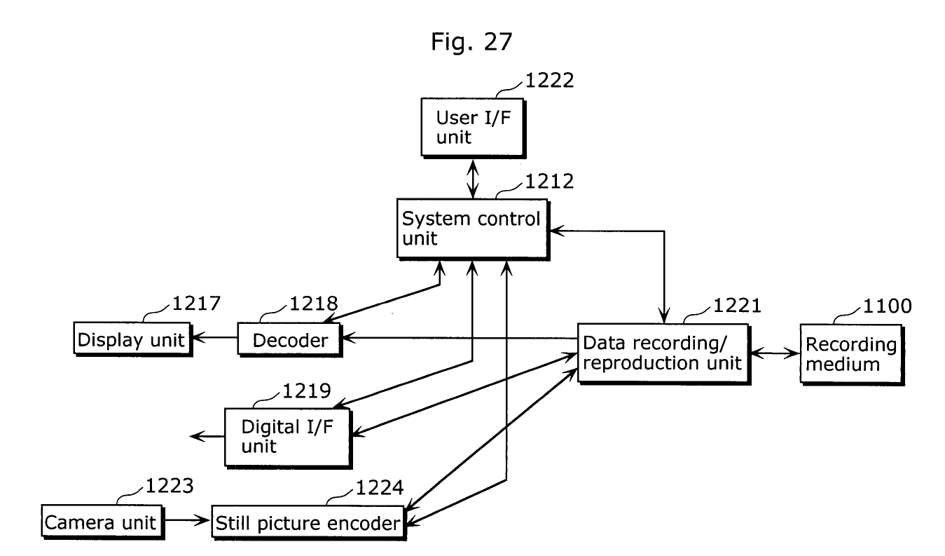

Next, a structure and an operation of a DSC which records data onto and reproduces data on a recording medium will be explained with reference to FIG. 27.

As shown in FIG. 27, a DSC includes a user I/F unit 1222 for displaying for a user and accepting a request from a user, a system control unit 1212 for managing and controlling the entire DSC, a display unit 1217 such as a liquid crystal monitor and a speaker, and a decoder 1218 for decoding still picture data. It further includes a still picture encoder 1224 for encoding an AV signal sent from the camera unit 1223 which receives video into a JPEG stream.

The data recording /reproduction unit 1221 records data onto and reproduces data on the recording medium 1100. The digital I/F unit 1219 is an interface for outputting data to an external device via a communication means such as an IEEE1394 bus and a USB.

In the DSC structured as above, the user I/F unit 1222 first accepts the user's request. The, user I/F unit 1222 conveys the user's request to the system control unit 1212, and the system control unit 1212 analyzes the user's request and requests each module for processing. There are two types of recording (shooting): a self-encoding for self-encoding digital data; and an outside encoding for recording digital data encoded by another device on a disc without self-encoding.

(5.1 Still Picture Recording Operation by Self-Encoding)

An operation of JPEG encoding AV data of still pictures sent from the camera unit 1223 and recording it will be explained in detail.

The system control unit 1212 requests the camera unit 1223 to output AV data and the still picture encoder 1224 to encode it. The still picture encoder 1224 JPEG encodes the AV data sent from the camera unit 1223 and sends it to the data recording/reproduction unit 1221. The data recording/reproduction unit 1221 records the data on the recording medium 1100 under the instruction of the system control unit 1212.

At this time, the system control unit 1212 creates, if necessary, a DCF image root directory or a DCF directory based on information of a file system, names a still picture file so as to avoid overlap between the file name and that of the DCF object which has been already recorded, and records the still picture file on the recording medium 1100.

Once one still picture file is recorded, shooting is completed. Or, when a user gives an instruction of serial shooting, shooting is stopped upon receipt of the user's stop request, or completed after a predetermined number of still picture files are recorded. The user's shooting stop request is delivered to the system control unit 1212 via the user I/F unit 1222, and the system control unit 1212 sends a stop request to the camera unit 1223 and the still picture encoder 1224.

(5.2 Still Picture Recording Operation by Outside Encoding)

An operation for receiving a still picture file from the digital I/F unit 1219 and recording it will be explained in detail.

The DCF object sent from the digital I/F unit 1219 is inputted into the data recording/reproduction unit 1221. The data recording/reproduction unit 1221 records the data on the recording medium 1100 under the instruction of the system control unit 1212. At this time, the system control unit 1212 creates, if necessary, a DCF image root directory or a DCF directory based on information of a file system, names a still picture file so as to avoid overlap between the file name and that of the DCF object which has been already recorded, and records the still picture file on the recording medium 1100.

When a DSC is connected to a PC via SCSI, ATAPI or the like and a still picture is sent from the PC to the DSC, the PC may implement the operation for file system information on the recording medium 1100 (such as creation of a DCF directory and setting of a DCF object name).

Once one still picture file is recorded, recording is completed. Or, when a user gives an instruction of serial shooting, shooting is stopped upon receipt of the user's stop request, or completed after a predetermined number of still picture files are recorded. The user's recording stop request is delivered to the system control unit 1212 via the user I/F unit 1222, and the system control unit 1212 sends a stop request to the digital I/F unit 1219.

In addition, against the background of downsizing of image input means using a CCD or the like and price reduction of semiconductor memory cards, a camera has been integrated into various devices. For example, a camera has been integrated into a mobile phone, a PDA and a laptop PC for video shooting and storage. Such video data is stored in a built-in semiconductor memory or HDD, an external semiconductor memory card, or the like.

Furthermore, recently developed electronic equipment is characterized by that it has increasingly had a function of connecting to a network such as the Internet. For example, a mobile phone, a PDA, a laptop PC, a DSC and the like may have the Internet connection function. These devices exchange still picture data and moving picture data using a transmission means such as e-mail via the connection with the network.

Next, a data management system in a first embodiment will be explained.

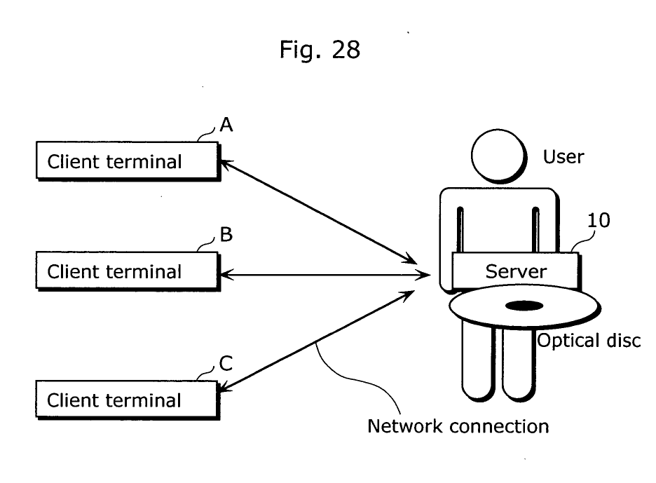

FIG. 28 is a diagram showing the structure of the data management system in the first embodiment. As shown in FIG. 28, the data management system according to the present invention includes a server (data management apparatus) 10 which records and reproduces digital data, and a plurality of client terminals A, B and C. The server 10 and the client terminals A, B and C are connected via a network, and the network allows two-way digital data communication between them.

Here, the communication channel of the network connecting the server 10 and respective client terminals A, B and C is, for example, a wireless channel such as IEEE802.11, Bluetooth (which is a trademark of The Bluetooth SIG Inc.) and UWB, or a cable channel such as IEEE1394, USB, a bus-type cable LAN and an optical fiber.

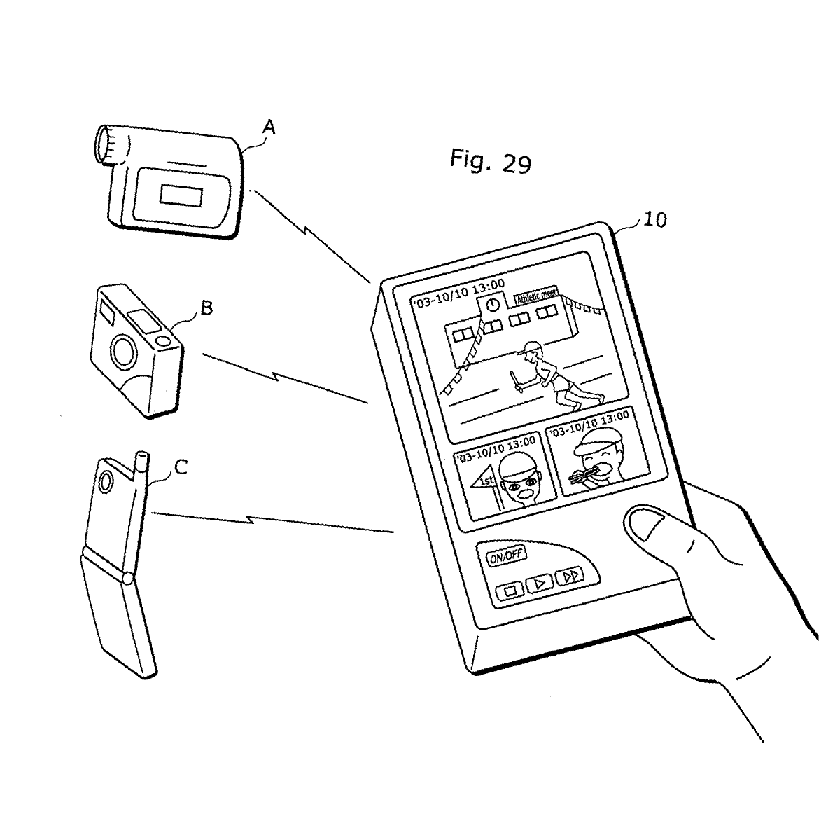

FIG. 29 is a structural diagram showing an example of a specific structure of the data management system in the present embodiment.

For example, the client terminal A is a video camera having a camcorder function for shooting moving pictures, the client terminal B is a digital still camera (DSC) for shooting still pictures, and the client terminal C is a mobile phone capable of shooting still pictures. As shown in FIG. 29, the server 10 is in a portable and hand-held shape, and on the surface of the server 10, a liquid crystal display panel for displaying data obtained by the client terminals A, B and C is mounted.

There are two types of digital data communicated between the server and respective client terminals A, B and C: continuous media data such as video and audio data; and discrete data such as text data and still picture data. A plurality of client terminals A, B and C are various types of electronic equipment having different functions used by a user.

For example, if the client terminals A, B and C have a camcorder function, video data encoded according to the MPEG2 standard is sent from the client terminals A, B and C to the server 10. Also, when the client terminals A, B and C have a DSC function, still picture data encoded according to the JPEG standard is sent from the client terminals A, B and C to the server 10.

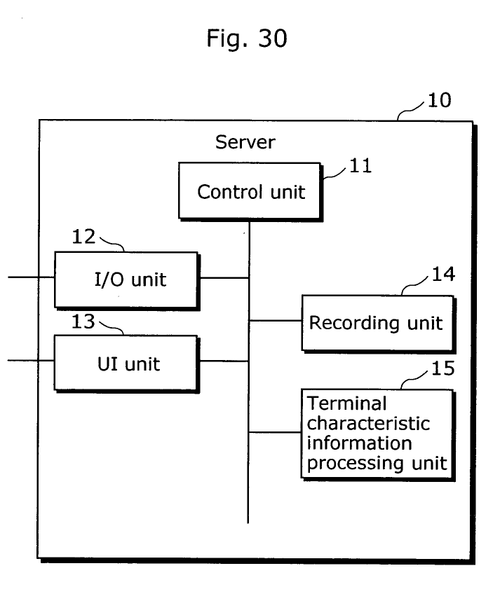

FIG. 30 is a diagram showing the structure of the server 10 in the data management system as shown in FIG. 28.

The server 10 includes a control unit 11, an I/O unit 12, a UI unit 13, a recording unit 14 and a terminal characteristic information processing unit 15.

The control unit 11 controls the overall operation of the server 10. The I/O unit 12 receives data from and outputs data to the outside of the server 10. For example, the I/O unit 12 is comprised of a USB, an IEEE1394 bus, a bus-type cable LAN, a wireless LAN such as IEEE802.11 or a combination of them.

The UI unit 13 delivers user's operations to the server 10 and delivers the output from the server 10 to the user via the operations using buttons and sticks and a user interface (GUI) using images displayed on a liquid crystal screen.

The recording unit 14 permanently records data created by the control unit 11 based on data received from the client terminals A, B and C via the I/O unit 12 and instructions inputted by a user via the UI unit 13. The recording unit 14 also outputs the recorded data to the outside via the I/O unit 12 or sends the data to the control unit 11 for processing. The recording unit 14 may further store data temporarily when the control unit 11 performs various types of processing.

Also, the recording unit 14 is comprised of a hard disk, an optical disc, a semiconductor memory card or a combination of them.

The terminal characteristic information processing unit 15 holds terminal characteristic information received from the client terminals A, B and C, and functions as a determination means for determining allocation of resources of the server 10 based on the terminal characteristic information.

The structure of the terminal characteristic information and the operation of the terminal characteristic information processing unit 15 will be explained in detail.

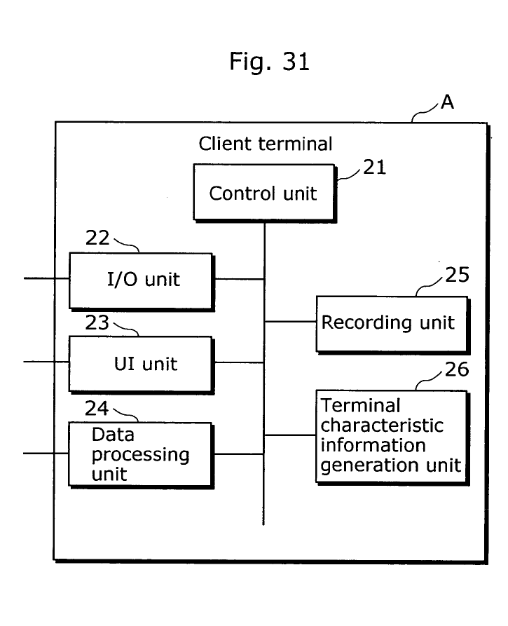

FIG. 31 is a diagram showing the structure of the client terminal A in the data management system as shown in FIG. 28.

The client terminal A includes a control unit 21, an I/O unit 22, a UI unit 23, a data processing unit 24, a recording unit 25 and a terminal characteristic information generation unit 26.

The control unit 21 controls the operation of the entire client terminal A.

The I/O unit 22 receives data from and outputs data to the outside of the client terminal 20. For example, the I/O unit 22 is comprised of a USB, an IEEE1394 bus, a bus-type cable LAN, a wireless LAN such as IEEE802.11, or a combination of them, and includes at least one interface connectable with the server 10 via a network.

The UI unit 23 plays a role in delivering user's operations to other units than the client terminal A and delivering the outputs from the other units to the user via the operations using buttons and sticks and a user interface (GUI) using images displayed on a liquid crystal screen.

The data processing unit 24 creates and reproduces data on the client terminal A. The data processing unit 24 also reproduces data read out from the recording unit 25 which will be described later, and displays it for a user via the UI unit 23. For example, if the client terminal A has a still camera function, the data processing unit 24 receives digital images via a CCD for image compression processing according to JPEG or the like. Conversely, the data processing unit 24 decodes the JPEG data read out from the recording unit.

The recording unit 25 permanently records data created by the control unit 21 and the data processing unit 24 based on data generated by the client terminal A or inputted from the outside via the I/O unit 22 or the instruction inputted by a user via the UI unit 23.

The recording unit 25 also sends the recorded data to the I/O unit 22 in order to output it outside the client terminal A, or sends the data to the data processing unit 24 in order to reproduce it.

When the control unit 21 performs various types of processing, the recording unit 25 further stores data used for the processing temporarily, if necessary.

The recording unit 25 is comprised of, for example, a hard disk device, an optical disc device, a semiconductor memory card device, or a combination of them.

The terminal characteristic information generation unit 26 holds or generates terminal characteristic information indicating the characteristics of the client terminal A itself, and sends it to an external device such as a server 10 via the I/O unit 22, if necessary.

Note that the capacity of the recording unit 25 can be smaller than the traditional one. For example, a traditional DVD camcorder includes a DVD-RAM disc of several GBs for recording video data of a large amount, but in the present embodiment, a system can be configured even if the memory capacity of the client terminal A having a camcorder function is reduced, because video data is recorded on the server 10.

The client terminals B and C respectively have the control unit 21, I/O unit 22, UI unit 23, data processing unit 24, recording unit 25 and terminal characteristic information generation unit 26, as is the case with the above-mentioned client terminal A.

As described above, since the memory capacity of the recording unit in the client terminals A, B and C of the present embodiment is smaller than the traditional terminal, they can be downsized and the battery driving time can be longer.

In addition, considering the entire system including the client terminals and the server 10 which one user carries, concentration of the memory capacity into the server 10 allows reduction of function overlap between terminals, and thus an efficient system can be configured as a whole.

Next, the data management system according to the present invention will be explained in the following order.

1. Overview of data management system

2. Structure of terminal characteristic information

3. Operation for allocating server resources

4. Recording operation

5. Reproduction operation

(1. Overview of Data Management System)

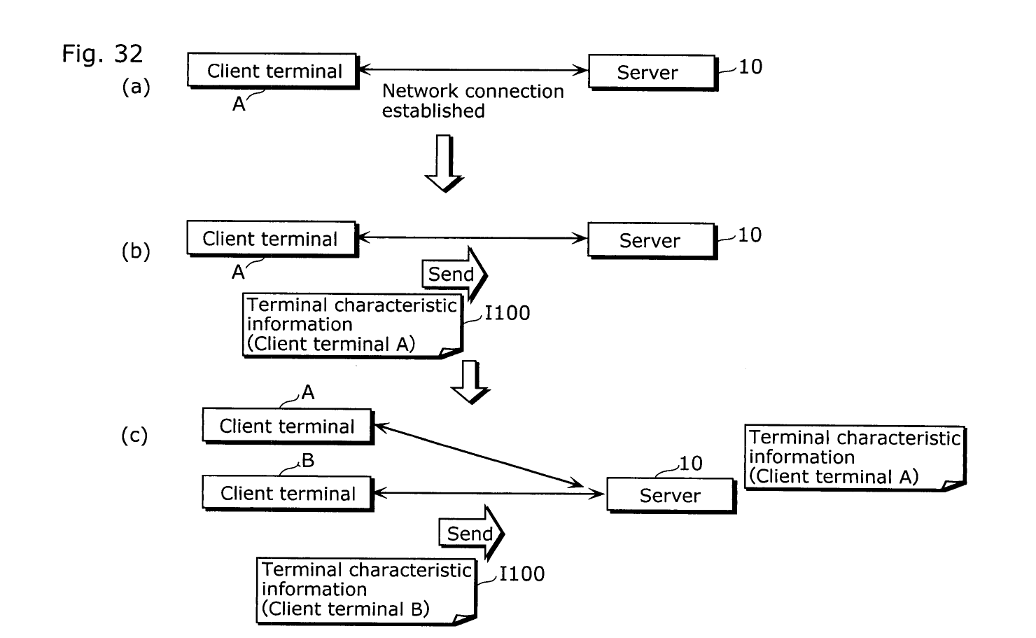

As shown in FIG. 32, in the data management system of the present invention, once the network connection is established between the client terminal A and the server 10, the client terminal A sends the terminal characteristic information to the server 10.

Once the network connection is established between the client terminal A and the server 10 as shown in (a) of FIG. 32, the client terminal A sends the terminal characteristic information I100 to the server 10, as shown in (b) in FIG. 32. The terminal characteristic information I100 is sent from the terminal characteristic information generation unit 26 as shown in FIG. 31 to the server 10 via the I/O unit 22.

The server 10 receives the terminal characteristic information I100 via the I/O unit 12 as shown in FIG. 30, and the terminal characteristic information processing unit 15 performs processing on that information. The terminal characteristic information I100 is stored in the recording unit 14, if necessary.

Next, as shown in (c) of FIG. 32, when the client terminal B is connected to the server 10, the terminal characteristic information I100 is sent to the server 10, and the server 10 holds the terminal characteristic information I100 for the client terminals A and B respectively which are connected to the server 10 itself. In this manner, upon receipt of the terminal characteristic information I100 from the client terminals A, B and C, the server 10 implements a server resources allocation operation for allocating the entire processing capability of the server 10 to the client terminals A, B and C respectively. For example, in order to supply the client terminal A with a recording function, the server 10 allocates recording transfer bands available to the client terminals A, B and C respectively. Allocation in advance of transfer bands to the client terminals A, B and C prevents the load on the entire server 10 from exceeding the maximum processing capability thereof, and thus allows reliable data transfer. The client terminals A, B and C send and receive data within the server resources allocated to them.

(2. Structure of Terminal Characteristic Information)

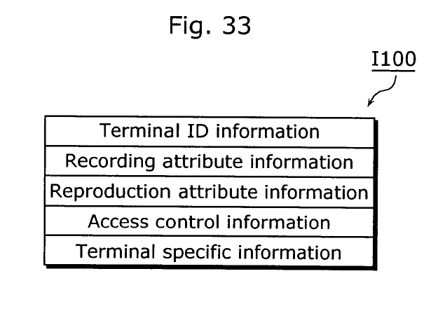

FIG. 33 is a diagram showing the data structure of the terminal characteristic information I100. In the network established between the server 10 and the client terminals of the present invention, terminal ID information includes information for identifying each of the client terminals A, B and C.

When each of the client terminals A, B and C has an I/O unit including an interface such as a bus-type cable LAN and an IEEE1394 bus, a unique ID defined under these standards may be used as the terminal ID information, or any other unique identification information to each of the client terminal A, B and C such as an IP address under TCP/IP that is a network protocol may be used.

Or, the names and descriptions of the client terminals A, B and C may be stored in the terminal ID information in an easy-to-understand form (a character string, for example) for a user.

Recording attribute information includes attribute information in a recording operation of each of the client terminals A, B and C.

Here, the recording operation means an operation for sending data from the client terminals A, B and C so that the server 10 receives the data. The server 10 records the data received from the client terminals A, B and C in the recording unit 14 thereof.

Reproduction attribute information includes attribute information in a reproduction operation of each of the client terminals A, B and C.

Here, the reproduction operation means an operation for receiving the data sent from the server 10 on the client terminals A, B and C. The client terminals A, B and C record the received data in the recording unit 25 thereof, or reproduce and display the data via the data processing unit 24 and the UI unit 23, if necessary.

Access control information includes control information for controlling access of the other client terminals and the server 10 to the resources and functions of the client terminals A, B and C or the data recorded thereon. For example, it includes access control information to the data (file or directory) in the recording unit 25 on the client terminals A, B and C, access control information to a certain function of the client terminals A, B and C, or the like.

Terminal specific information is information other than the above information, and includes attribute information specific to each of the client terminals A, B and C. For example, it includes extended information determined by manufacturers of the client terminals A, B and C.

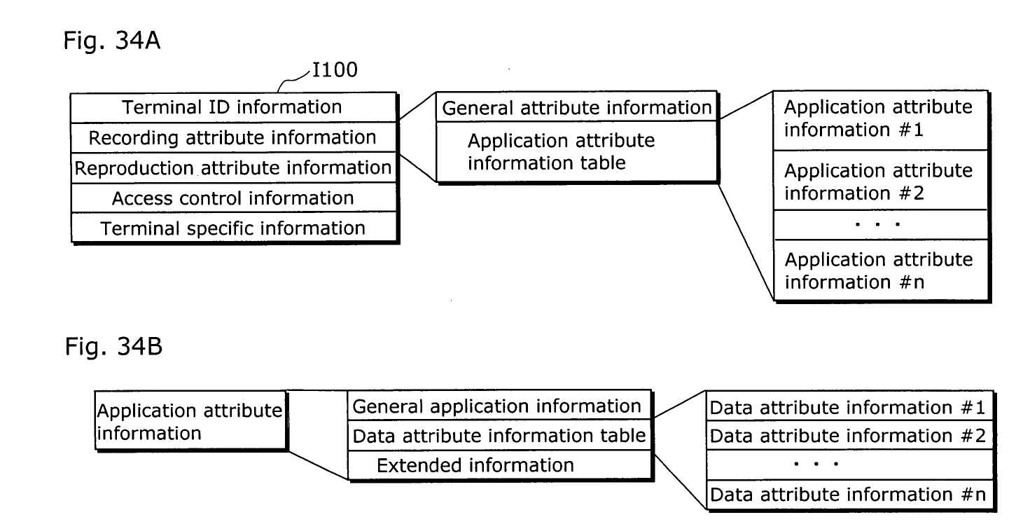

FIG. 34A and FIG. 34B are diagrams showing the data structure of the record attribute information in FIG. 33. General attribute information includes general attribute information on recording operation of the client terminals A, B and C, for example, recording buffer information on buffer memory capacity which is available when the client terminals A, B and C record data, maximum data capacity for which the client terminals A, B and C may request the server 10, priority information on the priority of the client terminals A, B and C to the allocation of server resources, and the like.

An application attribute information table is a table of attribute information on each data which the client terminals A, B and C request the server 10 to record.

As shown in FIG. 34A, the application attribute table consists of a plurality of application attribute information. The application attribute information includes attribute information of data which the client terminals A, B and C request the server 10 to record. As shown in FIG. 34B, the application attribute information includes general application information and a data attribute information table and extended information.

The general application information includes at least application identification information for identifying applications which the client terminals A, B and C request to record. Applications include, for example, the DCF standard and the DVD video recording standard.

The application identification information is accepted if only the agreement on the format thereof is shared by the client terminals A, B and C and the server 10. For example, the application identification information may be unique identification information for each application such as a character string like “DCIM” or an ID number like “0001”.

The general application information may include a format (a character string, for instance) which is easy for a user to understand the name and details of the application, or may include attribute information common to all the applications. In addition, the general application information may include priority information indicating the priority of the application to the allocation of server resources, and the like.

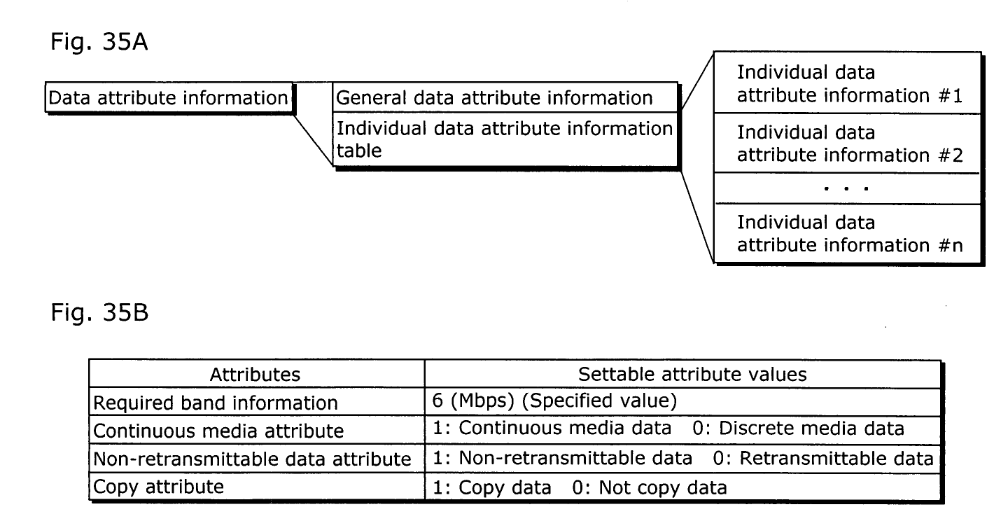

On the other hand, the data attribute information table includes data attribute information having attribute information of each data in a plurality of data formats which are managed as one application. FIG. 35A and FIG. 35B show examples of the data attribute information.

As shown in FIG. 35A, the data attribute information includes general data attribute information and an individual data attribute table.

The general data attribute information includes at least data identification information for identifying a type of data to be recorded, for example, MPEG2 and JPEG. The data identification information is accepted if only the agreement on the format thereof is shared between the client terminals A, B and C and the server 10. The data identification information may be any information which can be uniquely identified, such as a simple character string like “MPEG2”, an ID number like “0001”, an extension for recording data as a file, and MIME (Multipurpose Internet Mail Extensions) type information. The general data attribute information may include a format (a character string, for instance) which is easy for a user to understand the name and details of the data, or may include attribute information common to all the data.

The individual data attribute table is a table of individual data attribute information including individual attribute information of each data of a type, and stores individual data attribute information depending on the required individual attributes.

FIG. 35B shows an example of the individual data attribute information. For example, an individual data attribute under the attribute item “required band information” is a value of a recording transfer band which is required for the server 10 to record the target data, and numeral information such as “6” (Mbps) is stored in the required band information.

The “continuous media attribute” indicates whether the target data is continuous media data or not, and the data is continuous media data if a value “1” is set, and it is not continuous media data if “0” is set. Similarly, the “non-retransmittable data attribute” indicates whether the target data can be retransmitted or not. For example, non-retransmittable data are as follows.

When the client terminal A has a function of a camcorder and sends moving picture data which is now being shot to the server, there is no copy of the moving picture data and the data cannot be retransmitted if the server 10 fails to record it and requests the client terminal A for retransmission. Such data is non-retransmittable data.

On the contrary, when a file stored in the recording unit 25 of the client terminal A is sent to the server 10, the client terminal A can read out and send the file from the recording unit 25 again upon the retransmission request from the server 10. Such a file is not non-retransmittable data, and the “non-retransmittable data attribute” is set to “0” in the case of FIG. 35B.

“Copy attribute” indicates that the target data is copy data if the request for recording the data means a request for an operation of backing up the data in the client terminals A, B and C by copying it into the server 10.

Note that the individual data attribute information is determined depending on a data type, and is not limited to those as shown in FIG. 35B. For example, in a case of continuous media data, the individual data attribute information not shown in FIG. 35B includes information indicating whether the data is compressed at a variable transfer rate or not, or information indicating the upper limit, lower limit, average and the like of the transfer rate for compression of the data at a variable transfer rate. Or, even in a case of discrete media data like still pictures, a plurality of data are sometimes sent continuously. In this case, the individual data attribute information includes, for example, information indicating the data amount of each still picture file, the interval between file transmissions, the maximum number of files to be sent, and the like, for sending a plurality of data.

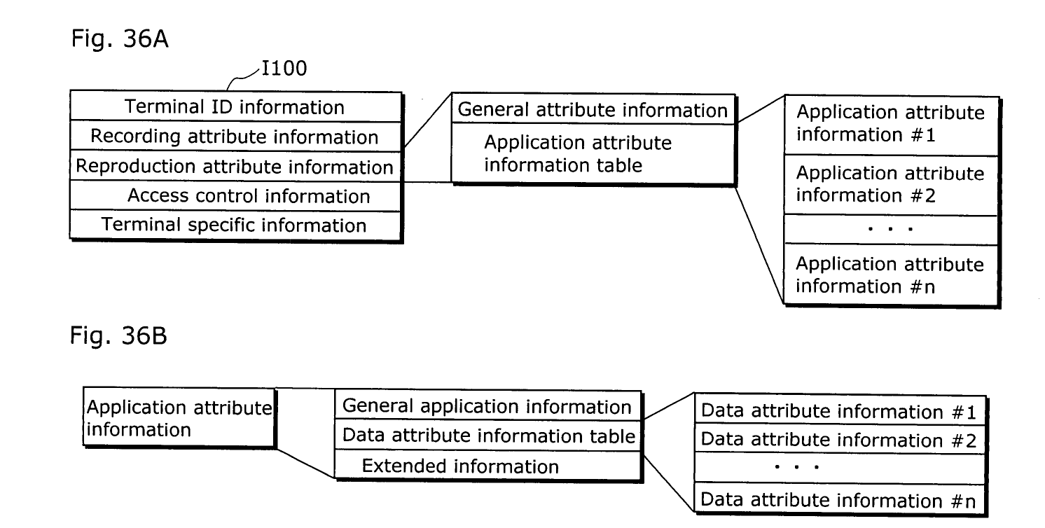

FIG. 36A and FIG. 36B are diagrams showing the data structure of the reproduction attribute information in FIG. 33. Information included in the reproduction attribute information is same as the recording attribute information, except that the information is related to the reproduction operation of the client terminals A, B and C. For example, the general attribute information has general attribute information on the reproduction operation of the client terminals A, B and C, including reproduction buffer information on buffer memory capacity available to reproduction on the client terminals A, B and C, and maximum data capacity for which the client terminals A, B and C may request the server 10. Similarly, the application attribute information table is a table of attribute information on each data which the client terminals A, B and C request to reproduce.

(3. Operation for Allocating Server Resources)

Next, an operation of the terminal characteristic information processing unit 15, that is a determination means of the server 10, for allocating limited server resources (recording transfer bands, memory areas and the like, for example) to a plurality of client terminals A, B and C.

Conventionally, according to Japanese Laid-Open Patent Application No. H10-283295, a client terminal and a server share information on allocation of transfer bands, and the client terminal requests data so as not to exceed the allocated transfer band. At this time, since the structure of each client terminal is same, the server can allocate server resources to the client terminals if only it allocates the same transfer band in sequence according to the request from the client terminals.

However, in the present embodiment, since the structure of each client terminal is different from each other and thus the types, characteristics and importance levels of the data which are requested to be recorded or reproduced by the client terminals are different, the allocation of server resources according to Japanese Laid-Open Patent Application No. H10-283295 is improper. For example, when a client terminal requests for recording moving picture data which is shot using a camcorder function and compressed according to MPEG2 into a server, the data to be recorded is continuous media data and non-retransmittable. Therefore, interruption or delay of recording is not allowed in the server, and thus sufficient recording transfer band needs to be allocated.

On the other hand, when still picture data which is compressed according to JPEG is copied from a client terminal to a server, since the data is discrete media data and retransmittable, the data can be copied even if the recording transfer band allocated to this client terminal is low.

A server has only limited server resources, so there may be a lo case where it cannot satisfy the requests for resources allocation from all the client terminals. In such a case, in the present embodiment, the terminal characteristic information processing unit 15 of the server 10 determines the optimum allocation pattern of server resources using the terminal characteristic information I100 received from the client terminals A, B and C.

To be more specific, in consideration of the attribute information of the data stored in the terminal characteristic information I100, the server 10 allocates by priority its server resources to the allocation request with a higher priority, which allows optimum allocation of server resources even in an environment where the client terminals A, B and C having various structures are connected to the server 10.

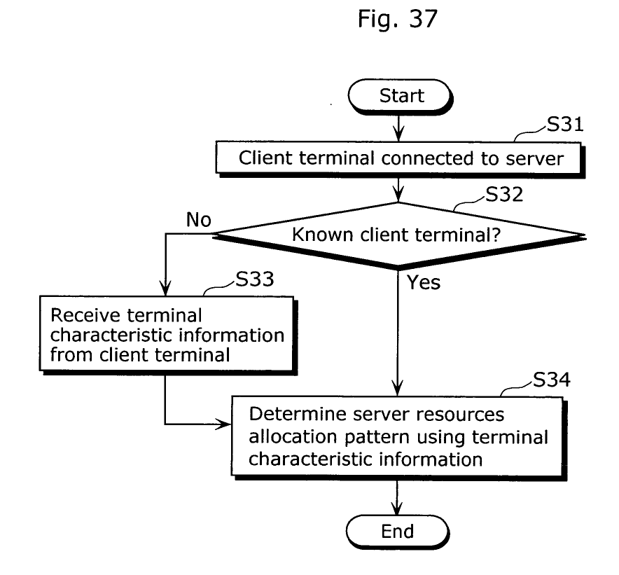

FIG. 37 is a flowchart showing an operation for allocating server resources.

When the server 10 detects connection to any of the client terminals A, B and C (S31), it examines whether the client terminal A, B or C is a known client terminal or not (S32). In other words, the server 10 examines whether or not it holds the terminal characteristic information I100 of the client terminal A, B or C. If it is not a known client terminal (No in S32), the server 10 receives the terminal characteristic information I100 from the client terminals A, B and C (S33). Then, the terminal characteristic information processing unit 15 in the server 10 determines allocation of server resources based on the terminal characteristic information I100 of its own (S34).

When allocating server resources, the server determines the priority of allocation based on attribute values in the terminal characteristic information I100. For example, the terminal characteristic information processing unit 15 in the server 10 allocates by priority its server resources to a client terminal or its application with a higher priority, with reference to the priority information on server resources allocation in the recording attribute information and the reproduction attribute information.

To be more specific, the terminal characteristic information processing unit 15 specifies priority for each of the client terminals A, B and C based on the contents of the recording attribute information and the reproduction attribute information included in the terminal characteristic information I100, and determines how to allocate server resources to each of the client terminals A, B and C or its application according to its priority.

Note that the values of the priority information included in the recording attribute information and the reproduction attribute information may be set fixedly depending on types of client terminals and applications, or may be set individually by a user.

As another method of priority determination, priority determination for server resources allocation in relation to the values of the individual data attribute information will be explained.

Here, the following five rules for priority determination are established. The terminal characteristic information processing unit 15 in the server 10 allocates server resources according to these rules (in this example, 1 is the highest priority).

1: Individual data attribute is “continuous media data” and “non-retransmittable data”.

2: Individual data attribute is “discrete media data” and “non-retransmittable data”.

3: Individual data attribute is “continuous media data”.

4: Individual data attribute is “discrete media data”.

5: Individual data attribute is “copy attribute”.

According to the above rules for priority determination, server resources within the maximum processing capability of the server 10 are allocated in order of priority from the client terminal with a higher priority, and thus server resources can be allocated appropriately even in a network environment where client terminals of various structures exist.

Next, a specific operation for server resources allocation will be explained.

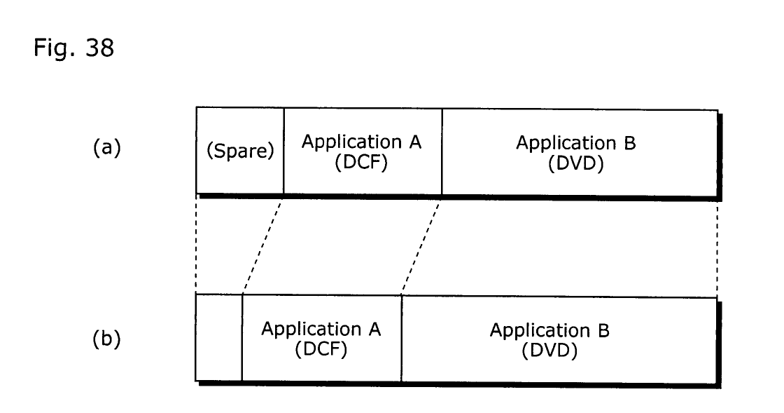

FIG. 38 is a diagram showing an operation for allocating a buffer memory included in the server 10. The server 10 as shown in FIG. 30 has a buffer memory in the recording unit 14. For example, the track buffer 103 as shown in FIG. 4 serves the same function as this buffer memory.

The server 10 of the present invention divides and allocates an area on a buffer memory to each client terminal.

In FIG. 38, a buffer memory is allocated to two applications, a DCF and a DVD. Allocation priority and allocation amount are determined based on the information stored in the terminal characteristic information I100, as mentioned above. When continuous media data is recorded on an optical disc such as a DVD according to MPEG2, for example, a required amount of a track buffer (a value corresponding to “B(t2)” in FIG. 5) and a required size of a CDA (a value corresponding to a continuous data area A1 in FIG. 5) can be determined if a writing rate onto a recording medium and a bit rate of continuous media data to be written are given, as shown in FIG. 5.

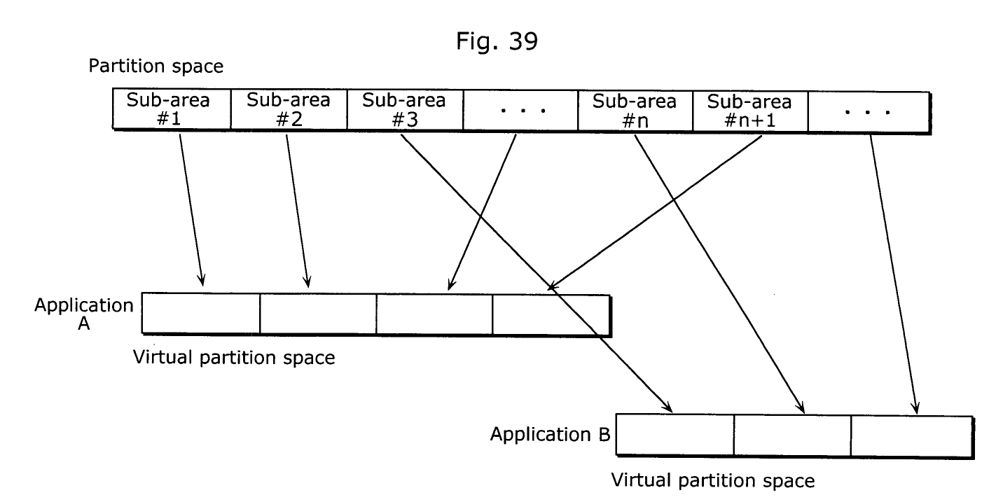

Next, FIG. 39 is a diagram showing an operation for allocating an area in the recording unit 14 in the server 10. The server 10 as shown in FIG. 30 has an HDD, an optical disc, a semiconductor memory card or the like as the recording unit 14. Particularly when the server has an HDD or an optical disc which requires a seek operation for data access, continuous media data such as video data must be located in a CDA for uninterrupted recording and reproduction, as mentioned in FIG. 5.

When a plurality of client terminals A, B and C share the recording unit 14, as is the case with the server 10 of the present embodiment, if a certain client terminal or application occupies an area in the recording unit 14, a problem occurs that other data cannot be recorded. Therefore, in the present embodiment, as shown in FIG. 39, a partition space on the recording unit 14 is further divided into sub areas, and a plurality of sub areas are allocated to each application. A set of sub areas allocated to each, application is referred to as a virtual partition space.

Note that a sub area is comprised of a logical sector, an ECC block, a plurality of continuous logical blocks or ECC blocks, or the like. Since each of the client terminals A, B and C arranges data in a virtual partition space, a memory area is not occupied by a certain application, and thus the data can be recorded therein.

Also, when continuous media data is recorded, sub areas are allocated to the data with consideration of the data size so as to reserve a CDA when allocating a virtual partition space. The allocation priority and allocation amount are determined based on the information stored in the terminal characteristic information I100, in the same manner as the operation for allocating a buffer memory. For example, each of the client terminals A, B and C may include a required memory area into general attribute information of recording attribute information, or in a case of continuous media data such as MPEG2 data for DVD, information on a CDA size may be included into the application attribute information.

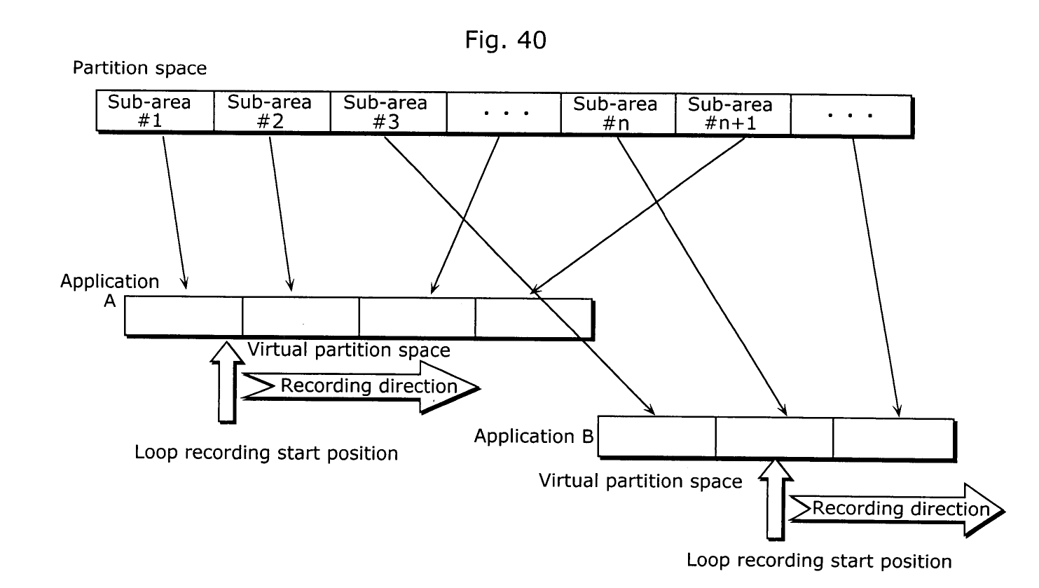

FIG. 40 is a diagram showing an operation for loop recording of data in each virtual partition space allocated in FIG. 39. A recording method called a loop recording is sometimes made for the purpose of efficient data arrangement and data access in a virtual partition space, and level-off of frequencies in using a recording area. For example, a loop recording is made as follows. In an address space in a partition space, free space is always searched and recorded from a position with the smallest address value in the direction of a position with a larger value, and once it arrives at the tail end of the partition space, it returns to the position with the smallest address value. Even if recording is interrupted, that location (which corresponds to the loop recording start position in FIG. 40) is memorized, and the next recording is started at that position.

When loop recording is made in the present embodiment, a loop recording start position is held for every partition space. Therefore, loop recording can be made even when the recording unit 14 in the server 10 is shared for use.

(4. Recording Operation)

Next, a recording operation will be explained. Here, a recording operation means an operation for sending data from the client terminals A, B and C to the server 10 and recording the data in the recording unit 14 in the server 10. When starting recording, prior to sending data, each of the client terminals A, B and C sends to the server 10, identification information of the client terminal itself and data identification information for identifying data to be sent. This data identification information includes application identification information and data identification information as mentioned in above (2. Structure of terminal characteristic information).

Also, information on directory location where the data is stored and the file name may be included in the above data identification information. As described above as for a DCF and a DVD, if a directory name or a file name is found, a data type is also found, so these information can be data identification information. After that, the client terminals A, B and C send the data to the server 10.

(5. Reproduction Operation)

Next, a reproduction operation will be explained. Here, a reproduction operation means an operation of the client terminals A, B and C for receiving data from the server 10. Before a reproduction operation, the server 10 reads out data from the recording unit 14 of its own and sends it to the client terminals A, B and C.

When starting reproduction, prior to receiving data, each of the client terminal A, B and C sends to the server 10, identification information of the client terminal itself and data identification information for identifying data to be received. This data identification information includes application identification information and data identification information as mentioned in above (2. Structure of terminal characteristic information).

The server 10 sends data with reference to the terminal characteristic information I100 of the client terminals A, B and C which are to receive the data, with consideration of buffer memory capacity available for reproduction on the client terminals A, B and C, if necessary.

Also, when the server 10 has a plurality of transmittable data, it may select and send the data suitable for the client terminals A, B and C with reference to the terminal characteristic information I100. For example, when the a plurality of transmittable data are video data of different resolutions and same contents, it may select and send the appropriate video data depending on a size of a display that is the UI unit 23 of the client terminal A and a type of a decoder (such as that in accordance with MPEG2 and MPEG4) of the client terminal A, and thus the client terminal A can obtain the video which is most suitable for viewing.

Note that the server 10 may have a drive unit only for reproduction of a memory medium such as a CD-ROM and a DVD-ROM. Such a drive unit only for reproduction also allocates a reproduction transfer band, and thus the data and the contents in the above ROM can be shared.

In the present embodiment, the client terminals A, B and C send the terminal characteristic information I100 to the server 10, but prior to the sending of the terminal characteristic information I100 from the client terminals A, B and C, the server 10 may send the characteristic information of the server itself to the client terminals A, B and C.

By doing so, the client terminals A, B and C can know in advance whether the server 10 has the server resources of their demand or not. If the client terminals A, B and C find that the server 10 does not have sufficient resources, they do not need to request allocation of server resources, and thus can avoid unnecessary processes.

Note that the structure of the terminal characteristic information I100 is not limited to that as shown in FIG. 33, and it may be a data structure having a tree structure like an XML.

As described above, in the present embodiment, sending in advance the terminal characteristic information I100 from the client terminals A, B and C to the server 10 allows the optimum allocation of server resources for recording and reproducing various data sent from the client terminals A, B and C with various capabilities and characteristics.

Also, since overlap of functions like a recording function can be avoided in the network including the client terminals and the server 10, more efficient and downsized system as a whole, longer driving time and so on can be realized.

(Second Embodiment)

Next, the data management system in the second embodiment of the present invention will be explained.

In the first embodiment, priority determination using the terminal characteristic information I100 and server resources allocation using this priority have been explained.

Since the server 10 holds limited resources, it is expected that the server resources go short if a plurality of client terminals are connected to the server 10. If a user presets appropriate priority information on server resources allocation in recording attribute information and reproduction attribute information, the server resources can be allocated according to the priority information. However, with increases in client terminals and applications, it may be difficult to preset the priority information on all the server resources allocation without contradiction.

So, in the present embodiment, the server 10 provides several patterns of recommended allocations to a user for allocating the server resources, the user selects any of the patterns, and thus the server resources allocation that satisfy the user's intention is realized.

The data management system in the present embodiment includes the server 10, the client terminals A, B and C, as is the case with the first embodiment.

The server 10 includes the control unit 11, the I/O unit 12, the UI unit 13, the recording unit 14 and the terminal characteristic information processing unit 15, and each of the client terminals A, B and C includes the control unit 21, the I/O unit 22, the UI unit 23, the data processing unit 24, the recording unit 25 and the terminal characteristic information generation unit 26.

Here, the recording unit 14 of the server 10 functions as a memory means for memorizing allocation pattern information indicating the above patterns. The I/O unit 12 of the server 10 functions as a sending means for sending the allocation pattern information memorized in the recording unit 14 to each of the client terminals A, B and C and as an obtainment means for obtaining instruction information designating a predetermined pattern based on the allocation pattern information to each of the client terminals A, B and C.

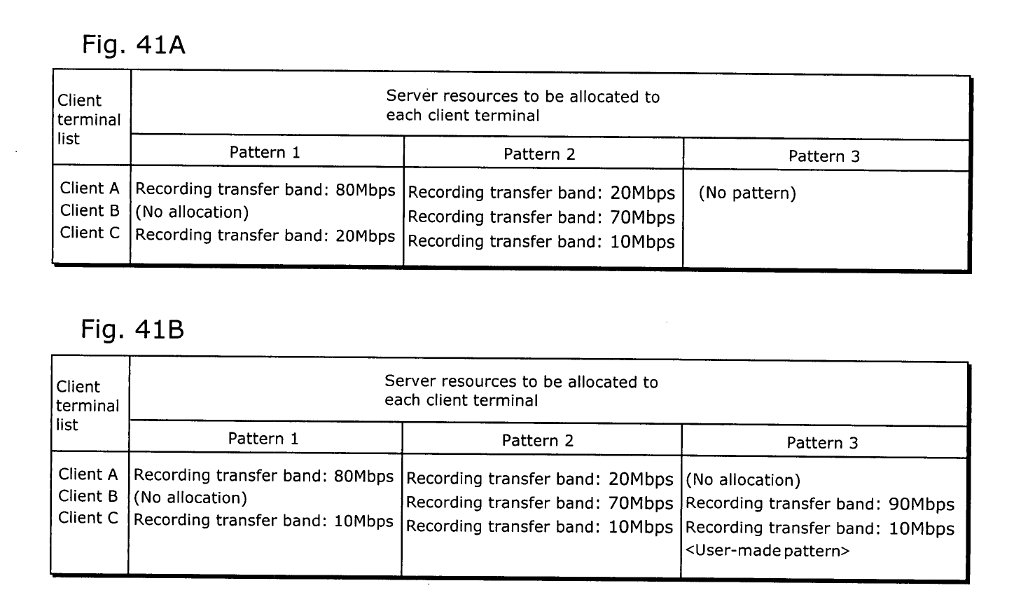

FIG. 41A and FIG. 41B are diagrams showing the contents of the allocation pattern information, particularly the case where there exist a plurality of allocation patterns of server resources for the client terminals A, B and C connected to the server 10. As shown in FIG. 41A, in Pattern 1, for example, the recording transfer band of 80 Mbps is allocated to the client terminal A, no band is allocated to the client terminal B, and the recording transfer band of 20 Mbps is allocated to the client terminal C, respectively. Such a pattern is determined by a method such that priority is specified for data with its individual data attribute of “continuous media data” and “non-retransmittable data”.

In Pattern 2, server resources are allocated in another way. The server 10 provides in some way these patterns on a display that is the UI unit 12 on the server 10 or a display that is the UI unit 23 on each of the client terminals A, B and C connected to the server 10. A user selects a pattern that satisfies his intention from among the displayed patterns and sends his selection to the server 10, and thus the server 10 can determine the server resources allocation that satisfies the user's intention.

The recording transfer bands allocated to the client terminal A are different in Pattern 1 and Pattern 2 because the client terminal A has a plurality of recording modes. For example, when the client terminal A has a camcorder function and the compression rate of AV data to be recorded on the server 10 can be changed, the server 10 may provide server resources allocation patterns suitable for respective compression rates.

The fact that each of the client terminals A, B and C has a plurality of recording modes is notified to the server 10 by including a plurality of individual data attribute information corresponding to respective recording modes into the terminal characteristic information I100.

In FIG. 41A, server resources are not allocated to the client terminal B in Pattern 1, but in Pattern 2, they can be allocated by lowering the recording transfer band for the client terminal A. A user obtains information indicating a plurality of patterns as shown in FIG. 41A and FIG. 41B, and thus can easily determine the server resources allocation pattern that satisfies his own intention.

Also, when there is no pattern that satisfies the user's intention in a plurality of patterns provided by the server 10, the user himself may change or add the patterns. For example, in FIG. 41B, Pattern 3 is a user-defined pattern. In Pattern 3, the recording transfer band can be further allocated to the client terminal B if no allocation is made to the client terminal A as the user intends, regardless of priority.

This pattern change or addition by the user is notified to the server 10, and if the pattern does not exceed the limit of all the server resources of the server 10, the server resources can be actually allocated according to the pattern. Once the server resources allocation pattern is obtained, it is stored in the server 10.

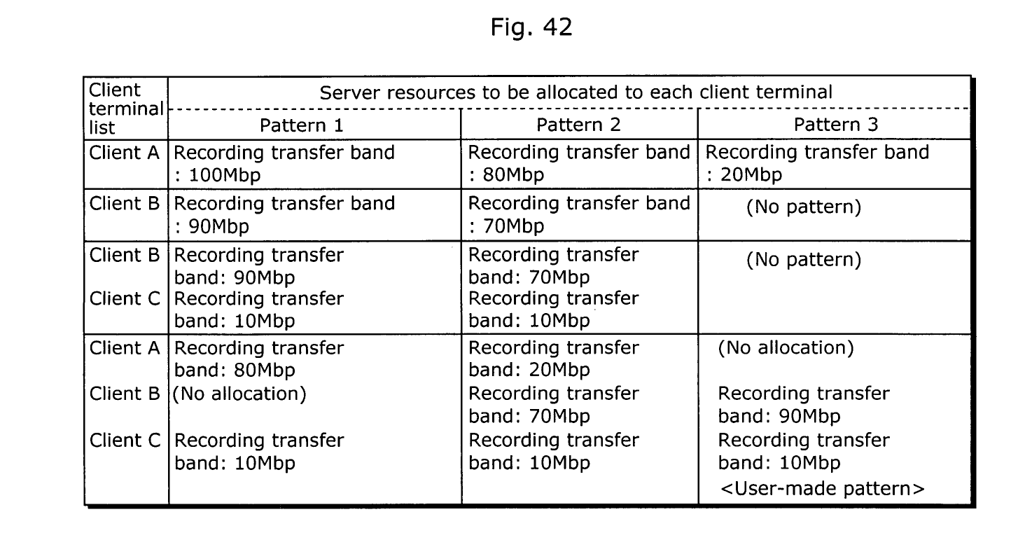

FIG. 42 is a diagram showing the contents of the allocation pattern information including a plurality of patterns depending upon client terminals connected to the server 10.

The pattern selected as mentioned above is associated with the client terminals A, B and C and stored in the server 10.

The user-defined pattern is also stored in the server 10, together with the attribute information indicating that the pattern is defined by the user.

As described above, since server resources allocation patterns are stored depending on structures of client terminals connected to the server 10, there is no need to recreate an allocation pattern every time the structure of the client terminal changes if the stored pattern is used, and thus efficient processing of the server 10 and easy operation of a user can be realized.

(Third Embodiment)

In the second embodiment, the case where the server resources allocation pattern is determined when any of the client terminals A, B and C is connected to the server 10 has been explained. In other words, the server resources are allocated depending on the status of respective client terminals.

In the present embodiment, the case where the server resources allocation is changed depending on the status of the server 10 or each of the client terminals A, B and C in the same network configuration as that of the second embodiment will be explained.

The control unit 11 of the server 10 in the present embodiment functions as a detection and changing means for detecting a change in processing environment of data to be sent and received between the server 10 and the client terminals A, B and C and changing the pattern indicated in the above instruction information.

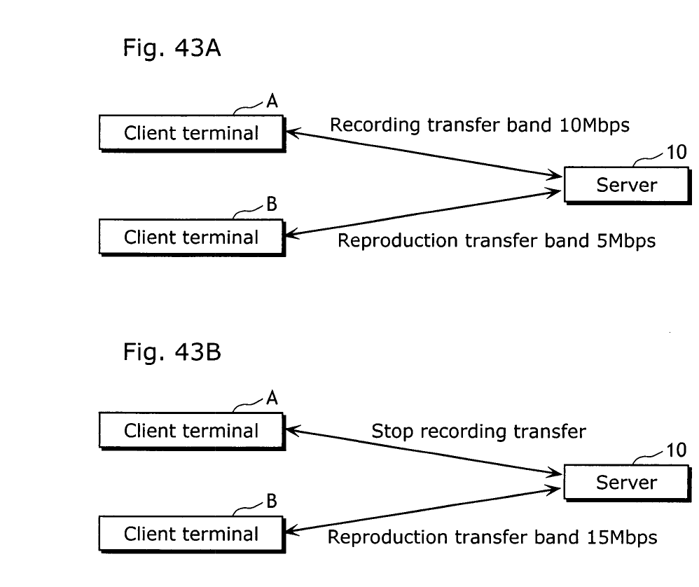

FIG. 43A and FIG. 43B are diagrams for explaining an operation for changing allocation of server resources depending on the status change of the client terminals A, B and C. As shown in FIG. 43A, the client terminals A and B are connected to the server 10, and they transfer data at the recording transfer band of 10 Mbps and at the reproduction transfer band of 5 Mbps, respectively. When the client terminal A stops data transfer, there occurs free room in the entire recording transfer band of the server 10. So, the control unit 11 of the server 10 detects the stop of data transfer, and as shown in FIG. 43B, changes the server resources allocation pattern selected by a user so as to raise the reproduction transfer band for the client terminal B to 15 Mbps. Once the server 10 receives a recording request from the client terminal A again, the control unit 11 detects the change and changes the pattern to the original one. As a result, the operation status of the present system returns to the status as shown in FIG. 43A, and the server resources are allocated to the client terminal A by priority.

In addition to the above, a pattern may be changed depending on a change in electric power status of the server 10. For example, when the server 10 is powered with a battery and there remains only a small amount of battery time, server resources are allocated by priority to the client terminal with higher priority, while no server resources is allocated or a reduced amount of server resources is allocated to the client terminal with lower priority.

Such an operation allows completion of data transfer with higher importance even when there remains only a small amount of battery time. The server 10 delivers the information that the amount of server resources allocation to a client terminal is to be reduced to the client terminal, and the client terminal changes its transfer manner so as not to exceed the newly allocated server resources, and transfers data. And when the power trouble in the server 10 has gone away because it is AC-powered or the like, the server resources are allocated to the client terminal with lower priority again.

Or, all the amount of the server resources of the server 10 may be changed depending on the power status thereof. For example, when the server 10 is powered with a battery, the performance of the recording unit 14 may be lowered (for example, the seek speed or the rotation speed of the recording medium is slowed down) in order to extend driving time.

On the other hand, there is no possibility of operation stop due to battery exhaustion when the server 10 is connected to an AC power, so the server 10 does not need to restrain its own performance. Therefore, the total amount of server resources to be allocated for battery power is different from that for AC power, and thus the server resources allocation pattern is also changed.

In the above case, the server 10 itself has a means for detecting changes in the power status of itself, and it changes the server resources allocation pattern when the power status changes. Therefore, the server resources can be appropriately allocated depending on the power status of the server 10.

Patterns may be changed depending on changes in the client terminals A, B and C. For example, when the client terminal A is battery-powered and there remains only a small amount of remaining battery time, or there remains only a small amount of buffer memory capacity of the client terminal A, the client terminal A delivers that information to the server 10, and thus the server 10 allocates a larger amount of server resources to the client terminal A.

Therefore, the server 10 allows the client terminal A with a small amount of battery time to complete the necessary data transfer, for example.

Also, allocation patterns may be changed depending on changes in data transfer speed between the client terminals A, B and C and the server 10. For example, when the client terminal A and the server 10 are connected via a wireless digital network, there may be a case where the data transfer speed between the client terminal A and the server 10 is lowered according to the radio wave status.

In such a case, if the data transfer rate is lower than the data rate which generates at the data sender, the data to be sent is lost. In order to avoid such data loss, it is effective for the data sender to have a buffer memory for temporarily holding the data which could not be sent. This buffer memory is realized by recording the data in a memory included in the I/O unit 12 or 22 as shown in FIG. 30 or 31, or the recording unit 14 or 25, and stores the data which could not be sent due to lower data transfer speed. When the data transfer speed between the client terminal A and the server 10 recovers to a predetermined speed, the data in the buffer memory is sent.

However, if the data in the buffer memory is continuous media data, there may be a case where new data is generated during sending that data and the data transfer speed is lowered again. Due to the limited capacity of the buffer memory, if the data transfer speed is lowered with no enough capacity in the buffer memory, the buffer memory cannot store data any more, and thus the data is lost. Therefore, if the data transfer speed recovers after being lowered, it is desirable to send out the data in the buffer memory on the sender side as soon as possible so as to keep the free space in the buffer memory as much as possible.

Therefore, in the present embodiment, after the data transfer speed is lowered between the client terminals A, B and C and the server 10, server resources allocation is changed temporarily.

More specifically, when the client terminal A has a function as a DVD camcorder to be a data sender, for example, the server 10 specifies higher priority regarding allocation of the data recording band that is one of the server resources or the buffer memory thereof for the client terminal A, and thus more server resources are allocated to the client terminal A. For example, as shown in (a) of FIG. 38, the server 10 keeps a spare area in reserve in addition to the buffer memory allocated to each application (an application A and an application B). And after the data transfer speed drops, the server 10 changes the server resources allocation temporarily, and additionally allocates the spare area to the application B as shown in (b) of FIG. 38.

Also, the server 10 additionally allocates the recording transfer band to the client terminal which requests data recording of the application B. The client terminal records the data on the server 10 at the data transfer rate higher than usual. As a result, the server 10 receives a lot of data temporarily, but it can receive such data because a lot of capacity is allocated to the buffer memory of the server 10 temporarily, and thus failure of recording data can be avoided.

Note that a spare area is provided in FIG. 38, but the server resources allocated to a client terminal can be reduced in order to allocate the server resources additionally to another client terminal.

(Fourth Embodiment)

In the present embodiment, a method for improving reliability of data transfer in the data management system according to the present invention will be explained.

The data management system of the present embodiment has the same structure as that of the first embodiment.

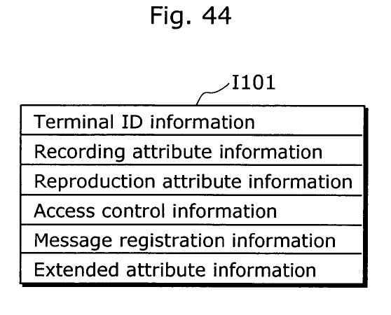

FIG. 44 is a diagram showing the data structure of the terminal characteristic information I101 which is different from the terminal characteristic information I100 in FIG. 33. The terminal ID information, the recording attribute information, the reproduction attribute information and the access control information included in the terminal characteristic information I101 have respectively the same structures of the terminal ID information, the recording attribute information, the reproduction attribute information and the access control information included in the above terminal characteristic information I100.

The message registration information has information on message information which the client terminals A, B and C having the terminal characteristic information I101 want to receive from the server 10.

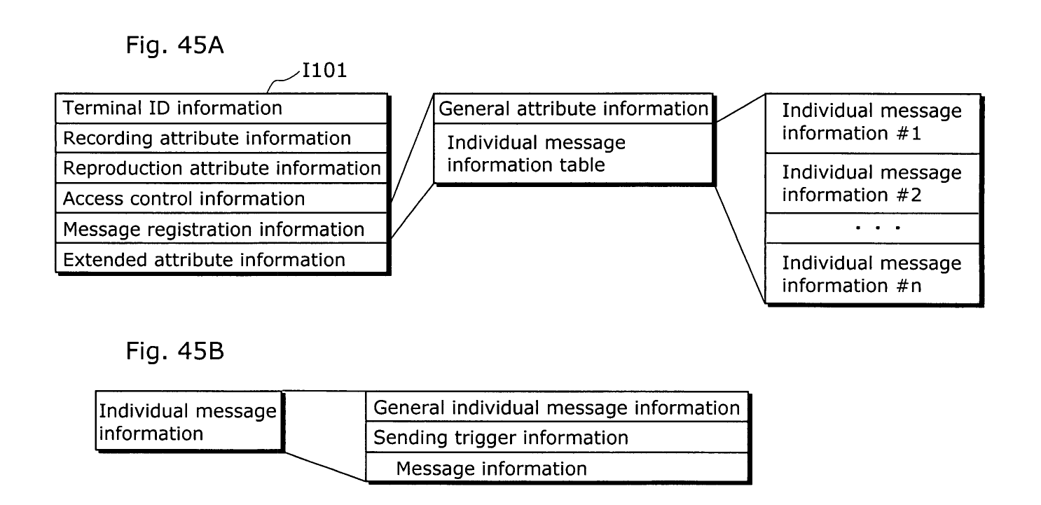

FIG. 45A and FIG. 45B are diagrams showing the data structure of the message registration information in FIG. 44. General attribute information has general attribute information on message registration information. For example, the general attribute information is ID information or the like for identifying the message registration information. An individual message information table is a table of individual message information which the client terminals A, B and C register on the server 10.

As shown in FIG. 45A, the individual message information table consists of a plurality of individual message information. The individual message information has individual message information which the client terminals A, B and C register on the server 10.

As shown in FIG. 45B, the individual message information has general individual message information, sending trigger information and message information. The general individual message information has information for identifying the individual message information which the client terminals A, B and C want to register, for example, ID numbers or the like such as “0001”. The sending trigger information includes information on the conditions set for starting sending of the message information which will be described later from the server 10 to the client terminals A, B and C. The conditions for starting sending includes, for example, a case where the power voltage of the server 10 falls below a predetermined voltage. The message information is the message information which is sent from the server 10 to the client terminals A, B and C when the conditions stored in the sending trigger information are satisfied, and includes, for example, the character strings such as “battery level of server has come down” or the messages predetermined between the server 10 and the client terminals A, B and C.

Here, the control unit 11 of the server 10 has a function as an event judgment means for judging whether a certain event such as a reduction of power voltage has occurred or not, and the I/O unit 12 obtains message registration information indicating a message associated with a certain event by obtaining the above terminal characteristic information I101 from each of the client terminals A, B and C. Furthermore, when judging that a certain event has occurred, the control unit 11 conveys the message associated with the event to the client terminal from which the terminal characteristic information I101 is obtained, based on the message registration information obtained by the I/O unit 12.

As a result, if the client terminals A, B and C register the message information on the server 10 under the condition of the power voltage of the server 10 as a condition of the sending trigger information, a user can know the reduction of the power voltage of the server 10 on a specific client terminal A, B or C as intended by the user, and thus the failure of data transfer due to the unintended halt of the server 10 or the like can be avoided.

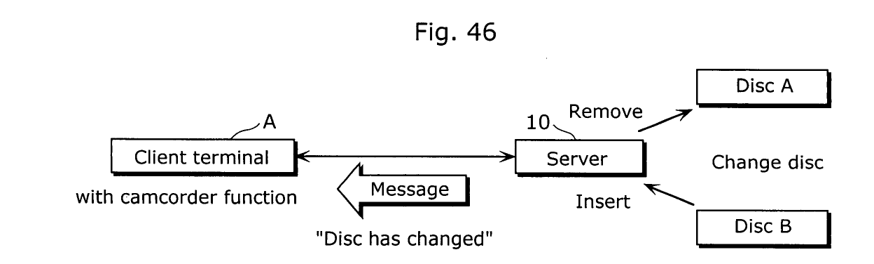

As an example of the operation of the present system in which the message information different from the above one is registered, a case where the server 10 has a commutative recording medium like a DVD as the recording unit 14 will be explained with reference to FIG. 46.

If the condition of the sending trigger information of individual message information for the client terminal A is a change of a recording medium on the server 10, and the message information is “disc has changed”, the above message information is sent to the client terminal A when the recording medium is changed on the server 10.

Therefore, recording of data on an unintended recording medium or failure of recording itself due to a user's carelessness can be avoided.

Furthermore, by including an ID or the like specific to a commutative medium in the sending trigger information, a change of the recording medium can be detected more reliably.

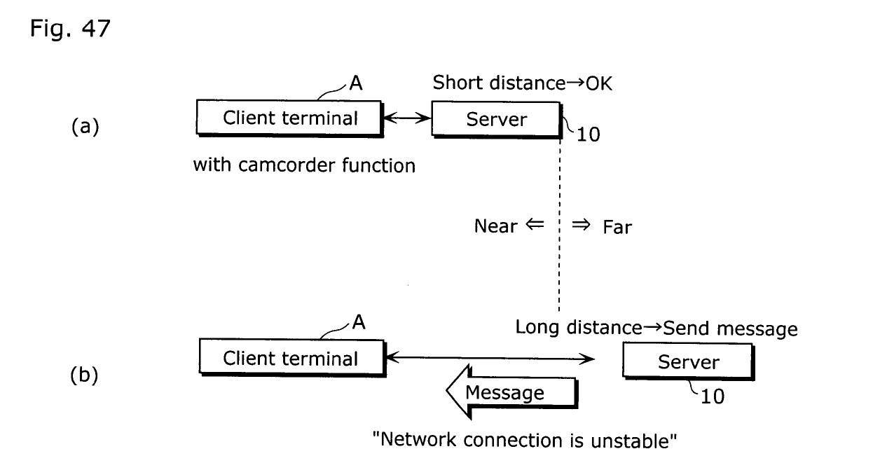

As an example of the operation of the present system in which the message information different from the above one is registered, a case of a network connection between the server 10 and the client terminal A will be explained with reference to FIG. 47.

When the server 10 and the client terminal A are connected by a wireless digital network, the network might be disconnected or the data transfer speed might be lowered due to poor radio waves. For example, in FIG. 47, when the client terminal A having a camcorder function records AV data, the AV data is “continuous media data” and “non-retransmittable data”, as described in the first embodiment. In this case, since the data cannot be retransmitted, failure of data recording due to disconnection of the network or reduction of data transfer speed causes a heavy loss to a user.

So, if the condition of the sending trigger information of the message registration information for the client terminal A is the network connection between the server 10 and the client terminal A (for example, the data transfer speed between the client terminal A and the server 10, the distance information between the client terminal A and the server 10, or the like), a user can grasp how is the network between the server 10 and the client terminal A, and thus take measures in advance, for example, make the distance between the server 10 and the client terminal A closer. As a result, loss of valuable data such as non-retransmittable data can be avoided.

Note that in addition to the above, the individual message information may include attribute information indicating a type of message information, for example, information such as “emergency”, “caution” and “reference” as warning levels. Also, in order to send a message to another client terminal than the client terminal which registers the message, the individual message information may include information for identifying the other terminal. At this time, the server 10 sends message information to the specified client terminal.

In addition, as for important messages such as a reduction of power voltage and a wireless network connection status, the server 10 may send the message information to the client terminals A, B and C automatically even if the client terminals A, B and C do not register the message information. This has the same effect as that the message information is implicitly registered in advance, and is one of the present embodiment.

(Fifth Embodiment)

In the present embodiment, the operation executed when a plurality of client terminals record data on the server according to different application formats will be explained. Here, an application format means the above-mentioned DVD standard, DCF standard or the like, for example. Also, application data means MPEG2 AV stream data in a case of the DVD standard, and a DCF object in a case of the DCF standard.

Management data means the video management information file as explained in FIG. 18A and FIG. 19A in a case of the DVD standard. There is no management data in a case of the DCF standard, but all the directory names and file names must conform to the DCF standard, so these names are managed using a function of a file system.

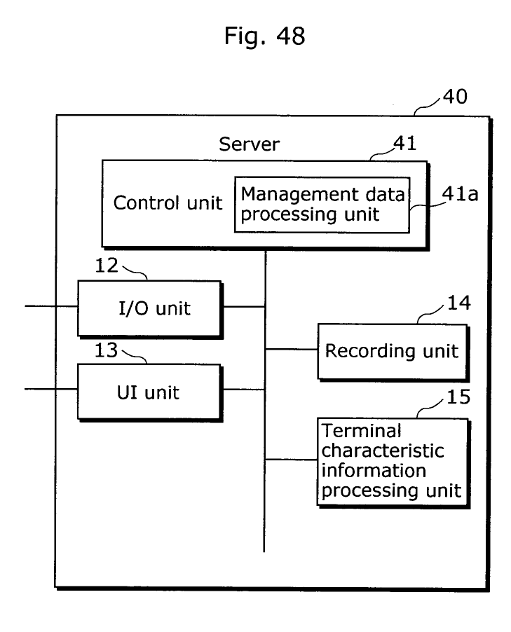

FIG. 48 is a diagram showing a structure of a server in the present embodiment. The server 40 includes the I/O unit 12, the UI unit 13, the recording unit 14 and the terminal characteristic information processing unit 15, as is the case with the above-mentioned server 10, and further includes a control unit 41. This control unit 41 is equipped with a management data processing unit 41a, and thus has a function of the management data processing unit 41a as well as a function of the control unit 11 of the server 10.

Also, the data management system of the present embodiment is comprised of the above server 40 and the client terminals A, B and C.

The management data processing unit 41a processes management data for managing application data transferred from the client terminals A, B and C. To be more specific, the management data processing unit 41a processes a video management information file in a case of the DVD standard, while it manages directory names and file names in a case of the DCF standard.

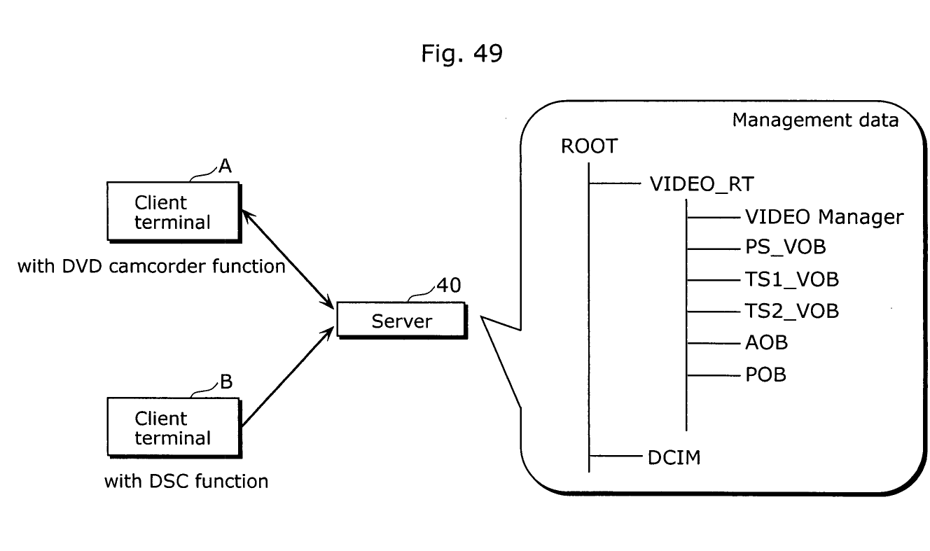

FIG. 49 is a diagram for explaining an operation between the server 40 and the client terminals A and B. In FIG. 49, the client terminal A having a function of a DVD camcorder records MPEG2 data or the like as described in FIG. 10 on the server 40. Also, the client terminal B having a function of a DSC records a DCF object or the like as described in FIG. 25 on the server 40.

As described in the above first embodiment, in order to connect to the server 40, the client terminals A and B send the terminal characteristic information I100 to the server 40, receive allocation of the server resources, and then request for data recording. As mentioned above, since the client terminals A and B try to record different application data on the server 40, the server 40 discriminates the application formats with reference to the terminal characteristic information I100 of the client terminal A and B and the data identification information sent by the client terminals A and B together with the application data. The management data processing unit 41a processes the management data according to the application formats. As a result, as shown in FIG. 49, the management data and the application data which are compliant with the DVD standard and the DCF standard are recorded in the recording unit 14 of the server 40.

In the above-mentioned manner of recording data, the data which is generated in the client terminals A and B are never stored in different recording units or recording mediums separately, and thus the number of recording units or recording mediums the user has to manage can be reduced. As a result, so much effort for data management, such as management of data type, data location and data backup, can be substantially saved.

In addition, when a DSC and a camcorder are used at the same time in one system to shoot and record the same object, a user can reproduce his shooting condition and shooting order only by reproducing the data in the recording unit 14 of the server 40 in sequence, and thus the convenience for the user is substantially improved.

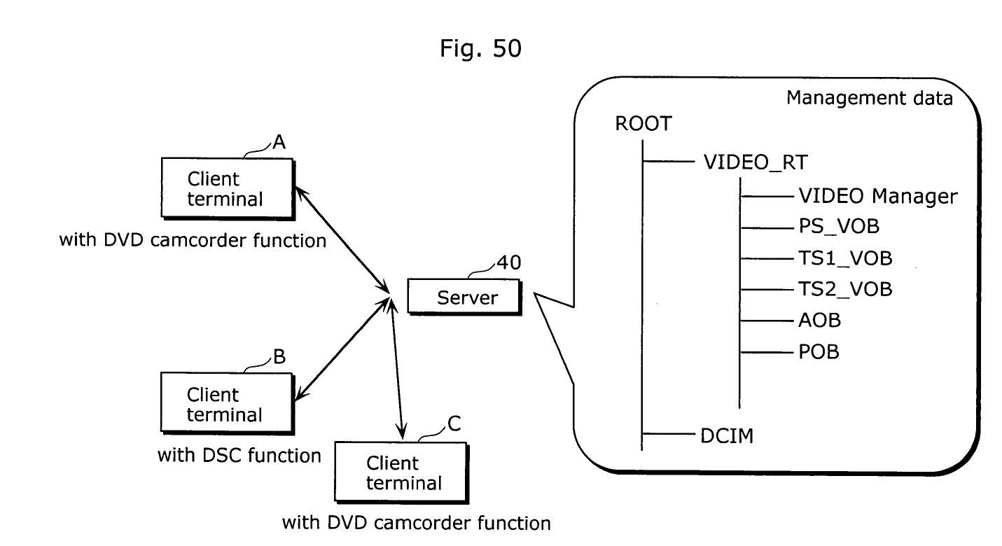

FIG. 50 is a diagram for explaining an operation executed when a client terminal C is further connected to the server 40 in is addition to the situation in FIG. 49.

The client terminal C has a camcorder function like the client terminal A. In a recording operation, two client terminals having a camcorder function are connected to the server 40. MPEG2 data transferred from the client terminals A and B are managed under one management data on the server 40. At this time, in the AV stream data recorded on the server 40, two AV stream data respectively generated in the client terminal A and the client terminal C are mixed.

The management data processing unit 41a of the server 40 stores, in the video management information, information on which client terminal generates which part of the AV stream data, as shown in FIG. 18A. As information for identifying the client terminals, terminal ID information in the terminal characteristic information I100 can be used.

As a result, when reproducing the data on the server 40, a user can know which client terminal generates the reproduced video, and thus easy data management can be realized.

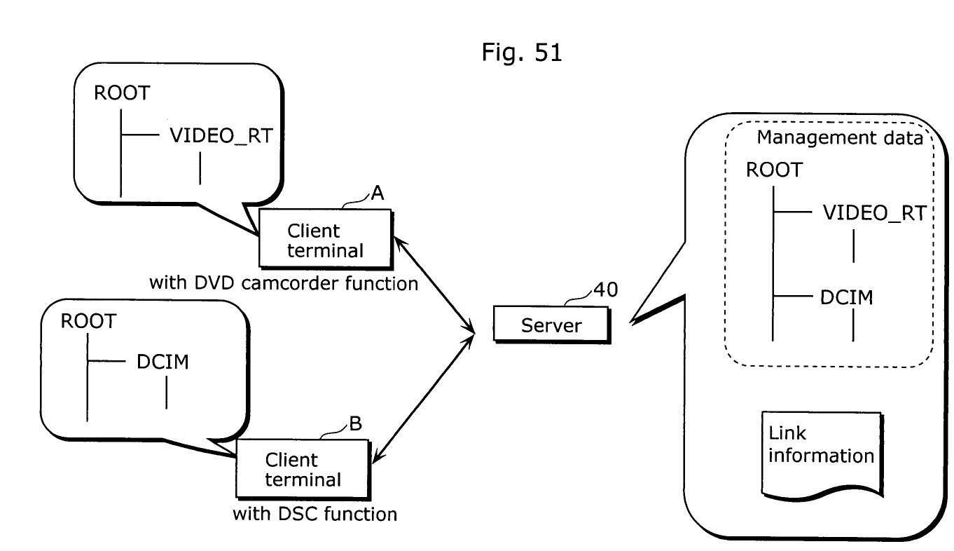

FIG. 51 is a diagram for explaining an operation in another data storage method than that in FIG. 49. In FIG. 51, it is supposed that each of the client terminals A and B does not transfer application data to the server.

Each application data is recorded in the recording unit 25 in each of the client terminals A and B. Each of the client terminals A and B sends to the server 40 link information indicating a link of each application data recorded in its own recording unit 25 and information necessary for generating management data for managing the application data. For example, in the case of the DCF standard, the link information includes path name information such as file names and directory names of DCF objects.

The server 40 generates management data based on the information received from the client terminals A and B, and records the link information to each application data.

Note that the management data may be sent at a time. For example, in the client terminal A of FIG. 51, the entire management file “VIDEO_Manager” may be sent (copied). After such recording, a user reproduces the application data with reference to the management data in the server 40. However, since there is no actual application data in the server 40, the server 40 requests the appropriate client terminal to send the application data with reference to the link information to the application data.

Upon receipt of the data sending request from the server 40, the client terminals A and B send the application data to the server 40. The server 40 receives the application data from the client terminals A and B and displays it for the user.

As a result, in FIG. 51, the user can read out the application data stored in a plurality of client terminals A, B and C with reference only to the server 40, and thus convenience for data reproduction is improved.

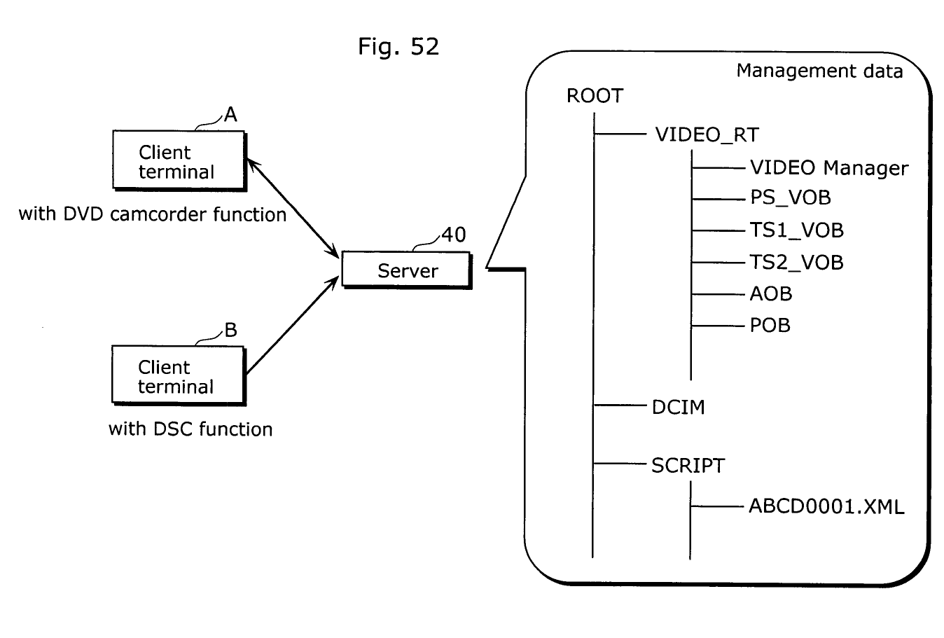

FIG. 52 is a diagram for explaining an operation in still another data storage method than that in FIG. 49. In FIG. 52, the client terminals A and B which are same as those in FIG. 49 are connected to the server 40. The server 40 in FIG. 52 records the MPEG2 data sent from the client terminal A and its management data. In the same way, it records the DCF data (DCF object) sent from the client terminal B and its management data. The server 40 in FIG. 52 further records the third management data including the generation time information of the application data sent from the client terminal A and the application data sent from the client terminal B.

In FIG. 52, this third management data is indicated as a file “ABCD0001.XML” below a directory “SCRIPT” below a ROOT directory. This third management data is referred to as a script file in the following description.

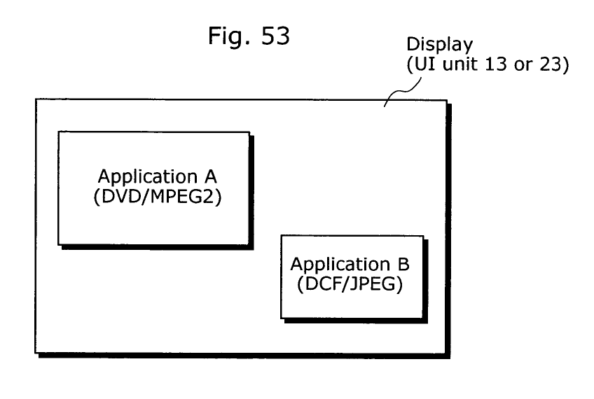

This script file is a file including information regarding the time when the application data is generated on each of the client terminals A and B and its data format, for example, a file in which the reference information to the application data is recorded in the generation order. FIG. 53 shows an example displayed when the application data is reproduced with reference to this script file. In FIG. 53, the application data A and the application data B which are shot at the same time are reproduced on one screen. This shows the direct reproduction of the status at the time when each application data is recorded, namely, the reproduction and display of each application data in synchronization with the generation time information recorded in the script file. As a result, data generated in a plurality of client terminals can be reproduced at a time, and thus convenience for using data is improved.

Note that a data format for a script file may be, for example, a format in which reference information to application data and generation time information of the data are recorded by associating with each other. Also, it may be a format like the program chain information table as shown in FIG. 19A. Furthermore, it may be a format in which a timing of reproduction synchronization between each application data is recorded. In addition, the script file may include arrangement information on a screen for reproduction of each application data and other additional information as well as the generation time information and the reproduction synchronization timing of the application data. For example, in FIG. 53, it may include information designating the position and size of the MPEG2 data of the application A displayed on a display that is the UI unit 13 or 23. Or, a script file may be structured in a format such as an XML-compliant description language according to the W3C standard, a description language like SMIL, and a Quick Time format that is a multimedia format established by Apple Computer, Inc., for example.

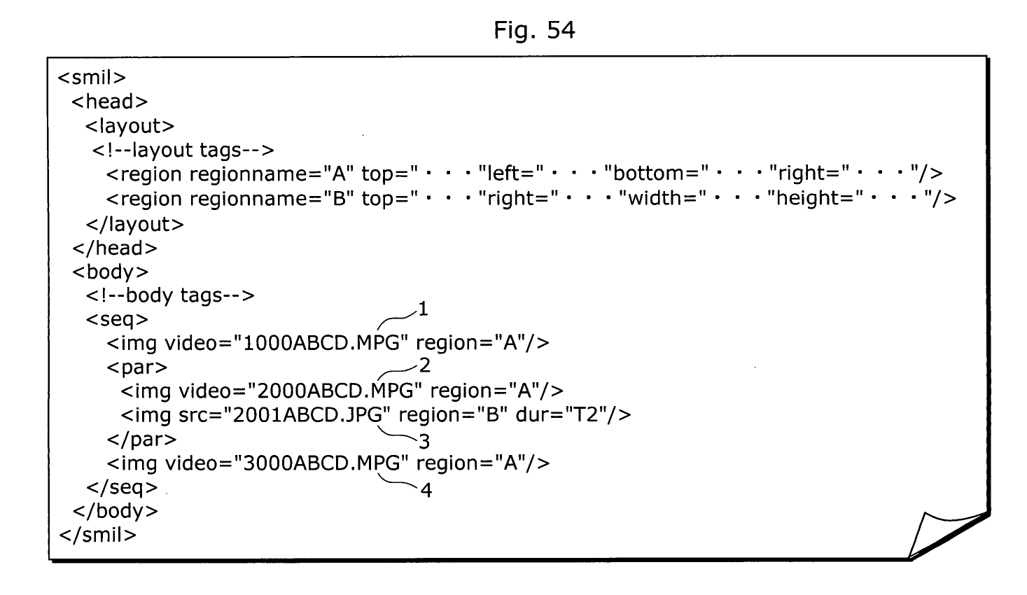

FIG. 54 is a file contents display diagram showing an example of the above script file which is structured in accordance with the SMIL standard.

For example, as shown in FIG. 54, the script file includes information indicating an image display region on a screen of the UI unit 13 of the server 40, and further includes an application data file name 1 (“1000ABCD.MPG”), a data file name 2 (“2000ABCD.MPG”), a data file name 3 (“2001ABCD.JPG”) and a data file name 4 (“3000ABCD.MPG”) which are arranged in order of generation time. The data file name 2 and the data file name 3 are arranged on the assumption that respective application data are generated at the same time.

A plurality of such script files may be recorded in the server 40 on a daily basis. By doing so, data management on a daily basis can be realized, for example.

Associations between application formats may be stored in the terminal characteristic information I100 (for example, in the general application information). To be more specific, in the client terminal A having the terminal characteristic information including the application identification information of “DCIM”, for instance, the identification information of “DVD-VR” indicating the DVD video recording standard is stored as associated application identification information relevant to the above application identification information. The server 40 which has received this terminal characteristic information from the client terminal A receives data of the DVD video recording standard from another client terminal B, and then generates a script file for the application data from the client terminal A and the application data from the client terminal B. Upon receipt of associated application identification information indicating association between different applications from still another client terminal C, the server 40 further generates a script file for the association between the applications.

As a result, script files can be generated indicating combinations of certain applications, and thus easier data management can be realized.

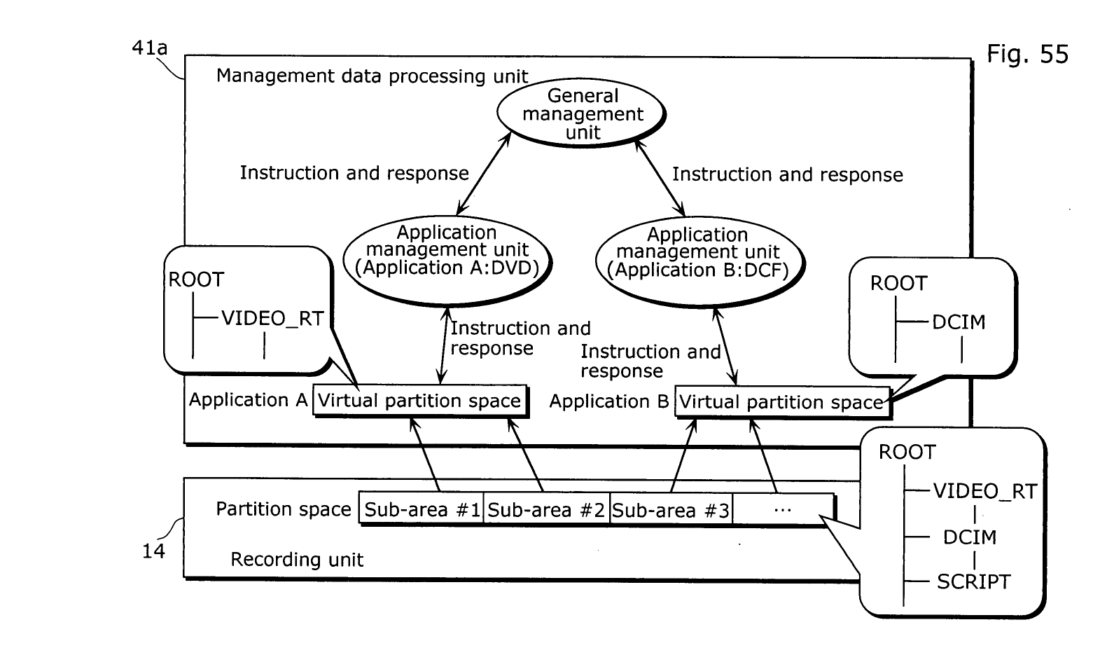

Next, a basic operation of the server 40 of the present embodiment will be explained. FIG. 55 is a diagram for explaining the basic operation of the management data processing unit 41a.

The management data processing unit 41a includes a general management unit for managing a plurality of application data as a whole, and application management units for managing management data of respective applications. Each application management unit is provided for each application. The general management unit and the application management units exchange instructions and responses via a common abstract interface independent of the details of the application standards.

Even if another application C is added in FIG. 55, this structure makes it unnecessary to change the structure of the entire system except for addition of an application management unit for the application C.

Each application management unit records and reproduces data in and from the recording unit 14 via a virtual partition space as shown in FIG. 39. Each application management unit also controls, based on address information in the virtual partition space, recording and reproduction of data which is sent and received to and from the client terminals A, B and C via the I/O unit 12.

As shown in FIG. 55, each virtual partition space is managed by the control unit 41 (management data processing unit 41a). Each virtual partition space is accessed via a predetermined interface. The interface of the present embodiment is defined so that only a directory and files of an appropriate application can be seen in each virtual partition.

The control unit 41 generates a script file and records it in the recording unit 14, as explained using FIG. 52.

Above-mentioned structure allows the application management unit to make implementations in consideration only of an application which is under the management of the application management unit itself, and thus allows easier implementations than those in consideration of mixture of a plurality of applications in one partition space.

Also, as mentioned above, an effect of an addition of a new application can be minimized.

In addition, even if a plurality of applications are mixed, the application unit does not need to consider overlap of directory names and file names. In this case, the control unit 41 manages overlap of directory names and file names in a partition space. To be more specific, the control unit 41 may make the directory names and file names in the partition space different from those in a virtual partition space and manage associations between them.

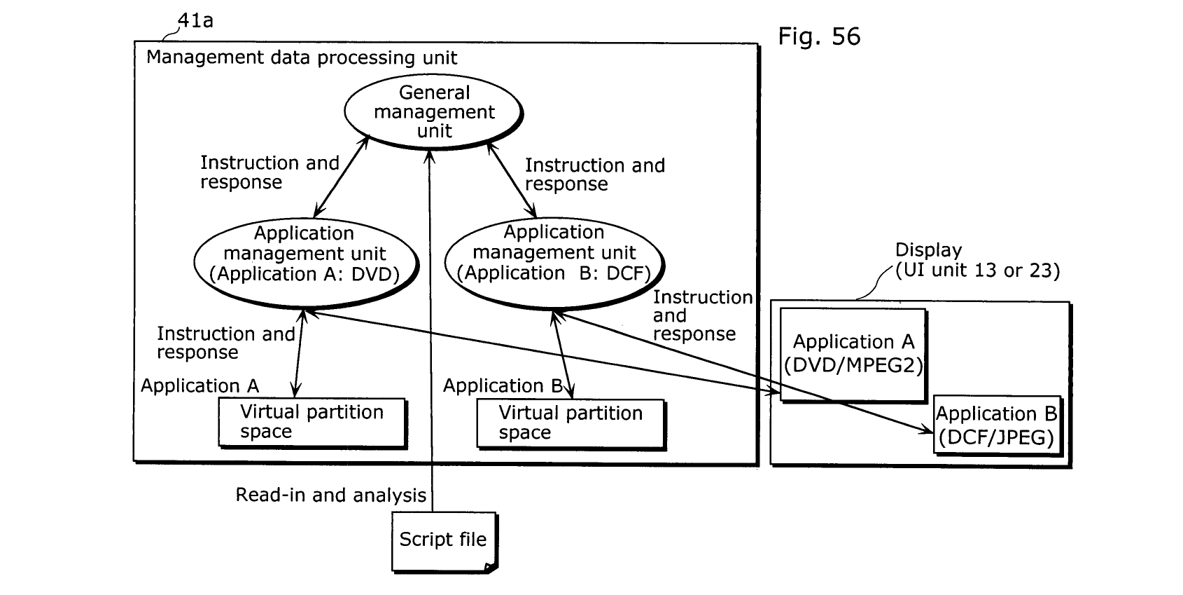

Next, a reproduction operation of the server 40 of the present embodiment will be explained. FIG. 56 is a diagram for explaining a reproduction operation of the management data processing unit 41a.

The general management unit of the control unit 41 reads out a script file from the recording unit 14 and interprets the contents thereof. Interpretation of the script file determines a reproduction timing and a display position of each application data.

The general management unit gives instructions regarding a reproduction timing and a display position to each application management unit. Upon receipt of the instructions, the application management unit gives instructions to the recording unit 14 and the UI unit 13 so as to display data at the reproduction timing and in the display position according to the instructions from the general management unit.

As a result, as shown in FIG. 53, different application data are displayed on one screen, a user does not need to reproduce data on a plurality of client terminals separately, and thus convenience is improved.

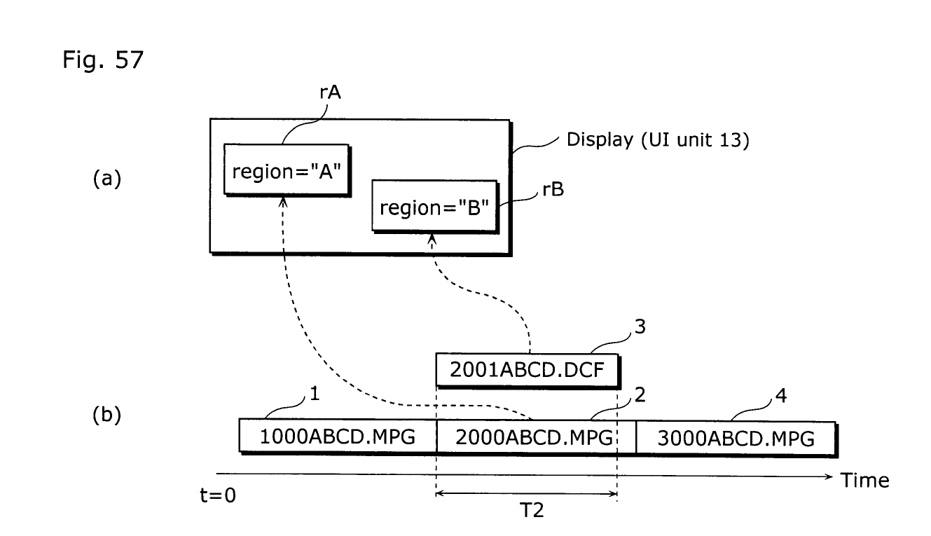

FIG. 57 is an illustration for explaining an operation of the server 10 when the script file as shown in FIG. 54 is read in by the general management unit of the management data processing unit 41a.

For example, the general management unit of the management data processing unit 41a reads in the script file as shown in FIG. 54 and interprets the contents of the script file. More specifically, as shown in (a) of FIG. 57, the general management unit specifies image display regions rA and rB on a display of the UI unit 13 based on the information indicating the display regions included in the script file, and as shown in (b) of FIG. 57, displays application files indicated with a data file name 1 (“1000ABCD.MPG”), a data file name 2 (“2000ABCD.MPG”), a data file name 3 (“2001ABCD.JPG”) and a data file name 4 (“3000ABCD.MPG”) which are included in the script file, in this order, in the above display regions rA and rB. Since the data file name 2 and the data file name 3 are arranged in the script file on the assumption that the application data indicated with these data file names are generated at the same time, these application data are reproduced at the same time during a time period of T2. To be more specific, the application data indicated by the data file name 1, the application data indicated with the data file name 2 and the application data indicated with the data file name 4 are displayed as a moving picture in the display region rA in this order, and the application data indicated with the data file name 3 is displayed as a still picture together with the application data indicated with the data file name 2 during the time period of T2.

Above-mentioned structure allows the application management unit to make implementations in consideration only of an application which is under the management of the application management unit itself, and thus allows easier implementations than those in consideration of mixture of a plurality of applications in one partition space. Also, as mentioned above, an effect of an addition of a new application can be minimized.

In the above first through fifth embodiments, a recording transfer band has been described mainly as server resources allocated to the client terminals A, B and C, but the server resources are not limited to the recording transfer band, and may be a reproduction transfer band, storage capacity of the recording unit 14 and others.

Also, a practical form of the server 10 or 40 may be a small and user-portable form, or an in-vehicle form. Or, the server 10 or 40 may be placed in a user's house by connecting it to a digital network like a mobile phone which allows long-range communication, or the data management system of the present invention may be configured in a form in which an Internet service provider (ISP) provides services to each terminal.

What is claimed is:

1. A data management apparatus that manages data which is handled by each of a plurality of terminals, comprising:
an obtainment unit operable to obtain terminal characteristic information from said each of the terminals, the terminal characteristic information indicating data processing on said each of the terminals;
a determination unit operable to determine a manner of handling the data based on the terminal characteristic information obtained by the obtainment unit; and
a data processing unit operable to send and receive the data to and from said each of the terminals and process said data, based on the handling manner determined by the determination unit.

2. The data management apparatus according to claim 1,
wherein the determination unit determines a manner of allocating server resources of the data management apparatus to said each of the terminals, the server resources being used for handling of the data, and
the data processing unit allocates the server resources to said each of the terminals based on the allocation manner determined by the determination unit.

3. The data management apparatus according to claim 2,
wherein the determination unit specifies a priority order for said each of the terminals, and determines the allocation manner depending on the priority order.

4. The data management apparatus according to claim 2, further comprising an event judgment unit operable to judge whether a predetermined event has occurred or not,
wherein the obtainment unit obtains message registration information from said each of the terminals, the message registration information indicating a message associated with the event, and
the data processing unit conveys the message associated with the event to said each of the terminals based on the message registration information obtained by the obtainment unit, when the event judgment unit judges that the predetermined event has occurred.

5. The data management apparatus according to claim 4,
wherein the event judgment unit judges whether a change in an electric power environment of the data management apparatus has occurred or not, and
the data processing unit conveys a message notifying of said change.

6. The data management apparatus according to claim 4,
wherein the event judgment unit judges whether a change of a storage medium in the data management apparatus has occurred or not, and
the data processing unit conveys a message notifying of said change.

7. The data management apparatus according to claim 4,
wherein the event judgment unit judges whether a change has occurred or not in a status of a transmission channel between the data management apparatus and said each of the terminals, and
the data processing unit conveys a message notifying of said change.

8. The data management apparatus according to claim 2, further comprising a management unit operable to specify an attribute regarding creation of the data based on said data sent from said each of the terminals to the data processing unit, and manage the data based on the specified attribute.

9. The data management apparatus according to claim 8,
wherein the management unit specifies a data format of the data based on said data sent from said each of the terminals to the data processing unit, and manages the data based on the specified data format.

10. The data management apparatus according to claim 8,
wherein the management unit specifies a creation date and time of the data based on said data sent from said each of the terminals to the data processing unit, and manages the data based on the specified creation date and time.

11. The data management apparatus according to claim 8,
wherein the management unit specifies a data format and a creation date and time of the data based on said data sent from said each of the terminals to the data processing unit, and manages the data based on the specified data format and creation date and time.

12. The data management apparatus according to claim 2, further comprising a management unit operable to obtain attribute information from said each of the terminals, the attribute information indicating an attribute regarding storage of data stored in said each of the terminals, and manage the data stored in said each of the terminals based on the attribute information.

13. The data management apparatus according to claim 12,
wherein the management unit obtains the attribute information indicating path name information for identifying a storage location of the data stored in said each of the terminals, and manages the data stored in said each of the terminals based on the path name information.

14. The data management apparatus according to claim 2, further comprising:
a date and time storage unit operable to specify a creation date and time of the data based on said data sent from said each of the terminals to the data processing unit, and stores the creation date and time; and
a synchronization unit operable to output the data sent from said each of the terminals to the data processing unit in synchronization with each other, based on the creation date and time stored in the date and time storage unit.

15. The data management apparatus according to claim 1,
wherein the obtainment unit obtains the terminal characteristic information indicating a creation date and time of the data sent from said each of the terminals to the data processing unit,
the determination unit determines output order of the data sent from said each of the terminals to the data processing unit, based on the creation date and time indicated in the terminal characteristic information, and
the data processing unit outputs the data in synchronization with each other, based on the determined output order.

16. The data management apparatus according to claim 15,
wherein the data processing unit outputs the data for display on a screen.

17. A data management apparatus that manages data which is handled by each of a plurality of terminals, comprising:
a storage unit operable to store allocation pattern information indicating a pattern of allocating server resources of the data management apparatus to said each of the terminals;
a sending unit operable to send the allocation pattern information stored in the storage unit to said each of the terminals;
an obtainment unit operable to obtain instruction information from said each of the terminals, the instruction information designating a predetermined pattern based on the allocation pattern information; and
a data processing unit operable to allocate the server resources based on the pattern designated in the instruction information obtained by the obtainment unit, send and receive the data to and from said each of the terminals, and process said data.

18. The data management apparatus according to claim 17,
wherein the allocation pattern information indicates a plurality of patterns, and
the obtainment unit obtains the instruction information selecting and designating any of the plurality of patterns indicated in said allocation pattern information.

19. The data management apparatus according to claim 18, further comprising a user interface unit operable to display the plurality of patterns indicated in the allocation pattern information stored in the storage unit, and specify a predetermined pattern according to an operation by a user,
wherein the data processing unit sends and receives the data to and from said each of the terminals and processes said data, based on the predetermined pattern specified by the user interface unit.

20. The data management apparatus according to claim 19,
wherein the user interface unit selects and specifies a pattern according to an operation by the user from among the displayed patterns.

21. The data management apparatus according to claim 20,
wherein the user interface unit selects the pattern according to the operation by the user from among the displayed patterns, and further specifies a changed version of the selected pattern according to another operation by the user.

22. The data management apparatus according to claim 21,
wherein the user interface unit updates the allocation pattern information stored in the storage unit based on the changed version of the pattern.

23. The data management apparatus according to claim 17,
wherein the obtainment unit obtains the instruction information designating a changed version of the pattern indicated in the allocation pattern information.

24. The data management apparatus according to claim 17,
wherein upon request from said each of the terminals, the sending unit reads out from the storage unit the allocation pattern information indicating the allocation pattern for said each of the terminals, and sends said allocation pattern information to said each of the terminals.

25. The data management apparatus according to claim 24,
wherein the pattern indicated in the allocation pattern information includes identification information and server resources, the identification information being assigned for identifying said each of the terminals, and the server resources being allocated to said each of the terminals identified with the identification information, and
upon request from said each of the terminals, the sending unit sends the allocation pattern information indicating the pattern including the identification information to said each of the terminals.

26. The data management apparatus according to claim 17, further comprising a detection and changing unit operable to detect a change in a processing environment of the data and change the pattern designated in the instruction information according to the detection,
wherein the data processing unit allocates the server resources based on the pattern changed by the detection and changing unit.

27. The data management apparatus according to claim 26,
wherein the detection and changing unit detects a change in the server resources of the data management apparatus as the change in the processing environment.

28. The data management apparatus according to claim 27,
wherein the detection and changing unit detects a change in an electric power environment of the data management apparatus as the change in the server resources.

29. The data management apparatus according to claim 26,
wherein the detection and changing unit detects a change in a status of a transmission channel between the data management apparatus and said each of the terminals as the change in the processing environment.

30. A terminal that communicates with a server using server resources of the server, the terminal comprising:
a sending unit operable to send terminal characteristic information to the server, the terminal characteristic information indicating data processing on the terminal; and
a data processing unit operable to send and receive data to and from the server and process said data according to a manner of allocating the server resources to the terminal, the allocation manner being determined by the server based on the terminal characteristic information sent by the sending unit.

31. The terminal according to claim 30, further comprising:
a pattern obtainment unit operable to obtain allocation pattern information from the server, the allocation pattern information indicating a plurality of patterns of allocating the server resources of the server to the terminal;
a selection unit operable to select any of the plurality of patterns indicated in the allocation pattern information obtained by the pattern obtainment unit; and
an instruction unit operable to send selection instruction information to the server, the selection instruction information instructing the server to allocate the server resources based on the pattern selected by the selection unit.

32. The terminal according to claim 31, further comprising a changing unit operable to change the pattern selected by the selection unit,
wherein the instruction unit sends change instruction information to the server, the change instruction information instructing the server to allocate the server resources based on the pattern changed by the changing unit.

33. The terminal according to claim 32, further comprising a user interface unit operable to display the plurality of patterns indicated in the allocation pattern information,
wherein the selection unit selects a pattern according to an operation by a user from among the plurality of patterns displayed by the user interface unit, and
the changing unit changes the pattern selected by the selection unit and displayed by the user interface unit, according to another operation by the user.

34. The terminal according to claim 30, further comprising:
a registration information sending unit operable to send message registration information to the server, the message registration information indicating a message associated with a predetermined event;
a message obtainment unit operable to obtain the message conveyed from the server based on the message registration information; and
a display unit operable to display the message obtained by the message obtainment unit.

35. The terminal according to claim 30, further comprising an attribute information sending unit operable to send attribute information indicating an attribute regarding storage of data stored in the terminal so as to make the server manage the data based on the attribute.

36. The terminal according to claim 35,
wherein the attribute information sending unit sends the attribute information indicating path name information for identifying a storage location of the data stored in the terminal.

37. A data management system comprising:
a plurality of terminals; and
a data management apparatus that manages data which is handled by each of the plurality of terminals,
wherein the data management apparatus includes:
an obtainment unit operable to obtain terminal characteristic information from said each of the terminals, the terminal characteristic information indicating data processing on each of the terminals;
a determination unit operable to determine a manner of allocating server resources of the data management apparatus to said each of the terminals based on the terminal characteristic information obtained by the obtainment unit; and
a data processing unit operable to send and receive the data to and from said each of the terminals and process said data, based on the allocation manner determined by the determination unit, and
said each of the terminals includes:
a terminal sending unit operable to send the terminal characteristic information; and
a terminal data processing unit operable to send and receive the data to and from said each of the terminals and process said data, based on the allocation manner of the server resources determined by the determination unit.

38. A data management method for managing data which is handled by each of a plurality of terminals in a data management system comprising said plurality of terminals and a data management apparatus, the data management method including:
a terminal sending step in which said each of the terminals sends terminal characteristic information indicating data processing on said each of the terminals to the data management apparatus;
an obtainment step in which the data management apparatus obtains the terminal characteristic information from said each of the terminals;
a determination step in which the data management apparatus determines a manner of allocating server resources of said data management apparatus to said each of the terminals, based on the terminal characteristic information obtained in the obtainment step; and
a data processing step in which the data management apparatus and said each of the terminals send and receive the data between each other and process said data, based on the allocation manner determined in the determination step.

39. A data management method in which a data management apparatus manages data which is handled by each of a plurality of terminals, the data management method comprising:
an obtainment step of obtaining terminal characteristic information from said each of the terminals, the terminal characteristic information indicating data processing on said each of the terminals;
a determination step of determining a manner of allocating server resources of the data management apparatus to said each of the terminals, based on the terminal characteristic information obtained in the obtainment step; and
a data processing step of sending and receiving the data to and from said each of the terminals and processing said data, based on the allocation manner determined in the determination step.

40. A data management method in which a terminal that communicates with a server using server resources of the server makes the server manage data which is handled by the terminal, the data management method comprising:
a sending step of sending terminal characteristic information indicating data processing on the terminal; and
a data processing step of sending and receiving the data to and from the server and processing said data according to a manner of allocating the server resources to the terminal, the allocation manner being determined by the server based on the terminal characteristic information sent in the sending step.

41. A program executed by a data management apparatus to manage data which is handled by each of a plurality of terminals, the program comprising:
an obtainment step of obtaining terminal characteristic information from said each of the terminals, the terminal characteristic information indicating data processing on said each of the terminals;
a determination step of determining a manner of allocating the server resources of the data management apparatus to said each of the terminals, based on the terminal characteristic information obtained in the obtainment step; and
a data processing step of sending and receiving the data to and from said each of the terminals and processing said data, based on the allocation manner determined in the determination step.

42. A program executed by a terminal which communicates with a server using server resources of the server to make the server manage data which is handled by the terminal, the program comprising:
a sending step of sending terminal characteristic information indicating data processing on the terminal; and
a data processing step of sending and receiving the data to and from the server and processing said data according to a manner of allocating the server resources to the terminal, the allocation manner being determined by the server based on the terminal characteristic information sent in the sending step.

43. A storage medium for storing a program executed by a data management apparatus to manage data which is handled by each of a plurality of terminals,
wherein the program comprises:
an obtainment step of obtaining terminal characteristic information from said each of the terminals, the terminal characteristic information indicating data processing on said each of the terminals;
a determination step of determining a manner of allocating server resources of the data management apparatus to said each of the terminals, based on the terminal characteristic information obtained in the obtainment step; and
a data processing step of sending and receiving the data to and from said each of the terminals and processing said data, based on the allocation manner determined in the determination step.

44. A storage medium for storing a program executed by a terminal which communicates with a server using server resources of the server to make the server manage data which is handled by the terminal,
wherein the program comprises:
a sending step of sending terminal characteristic information indicating data processing on the terminal; and
a data processing step of sending and receiving the data to and from the server and processing said data according to a manner of allocating the server resources to the terminal, the allocation manner being determined by the server based on the terminal characteristic information sent in the sending step.

45. A storage medium for storing management information used by a data management apparatus to manage data which is handled by each of a plurality of terminals,
wherein the management information indicates an attribute regarding creation of the data obtained by the data management apparatus from said each of the terminals, the attribute being specified by the data management apparatus based on said obtained data.

46. The storage medium according to claim 45,
wherein the management information indicates a data format of the data.
